(19) United States
(12) Patent Application Publication
(10) Pub. No.: US 2016/0302463 A1
(43) Pub. Date: Oct. 20, 2016

(54) FOOD AND BEVERAGE PRODUCTS COMPRISING ALLULOSE (PSICOSE)

(71) Applicant: TATE & LYLE INGREDIENTS AMERICAS LLC, Hoffman Estates, IL (US)

(72) Inventors: Ryan D. WOODYER, Hoffman Estates, IL (US); Michael D. HARRISON, Hoffman Estates, IL (US); Annah LE, Hoffman Estates, IL (US); Yuqing ZHOU, Hoffman Estates, IL (US); Adrienne Stucky POHRTE, Hoffman Estates, IL (US); David HOYDA, Hoffman Estates, IL (US); Jacob DURBIN, Hoffman Estates, IL (US); Sanjiv H. AVASHIA, Hoffman Estates, IL (US); Penny PATTON, Hoffman Estates, IL (US); Jason C. COHEN, Hoffman Estates, IL (US); Rachel A. WICKLUND, Hoffman Estates, IL (US); Valerie VANDAELE, Hoffman Estates, IL (US); Shondra COOK, Hoffman Estates, IL (US); Carol RAINFORD, Hoffman Estates, IL (US); Lisa TOUHY, Hoffman Estates, IL (US); Rosemary SIKORA, Hoffman Estates, IL (US)

(73) Assignee: Tate & Lyle Ingredients Americas LLC, Hoffman Estates, IL (US)

(21) Appl. No.: 15/038,283

(22) PCT Filed: Nov. 21, 2014
(86) PCT No.: PCT/GB2014/053456

§ 371 Date: May 20, 2016

Related U.S. Application Data
(60) Provisional application No. 61/907,415, filed on Nov. 22, 2013.
(60) Provisional application No. 61/984,444, filed on Apr. 25, 2014.
(60) Provisional application No. 62/056,138, filed on Sep. 26, 2014.

(51) Int. Cl. A23L 1/236; A23C 9/13; A21D 13/06; A23G 3/42; A23G 9/34; A23G 4/10; A23G 1/40; A23L 2/60; A21D 2/18

(52) U.S. Cl. CPC A23L 33/125; A23L 2/60; A23C 9/1307; A23L 7/126; A21D 13/062; A23G 3/42; A21D 2/181; A23L 27/33; A23G 9/34; A23G 4/10; A23G 1/40; A23V 2002/00

(57) ABSTRACT

The present invention relates to the use of high levels of allulose in food and beverage products.

### FIELD OF THE INVENTION

The present invention relates to the use of high levels of allulose in food and beverage products.

### BACKGROUND OF THE INVENTION

Many food and beverage products contain nutritive sweeteners such as sucrose (generally referred to as ‘sugar’ or ‘table sugar’), glucose, fructose, corn syrup, high fructose corn syrup and the like. Such sweeteners supply not only sweetness to the food and beverage products, but also bulk, texture and desirable functional properties such as browning, humectancy, freezing point depression and the like. They also produce a favorable sensory response, for example in terms of quality of sweetness, lack of bitterness and off taste, desirable temporal profile and desirable mouthfeel.

Although desirable in terms of taste and functional properties, excess intake of nutritive sweeteners has long been associated with diet-related health issues, such as obesity, heart disease, metabolic disorders and dental problems. Accordingly, consumers are increasingly looking for ways to decrease the amount of nutritive sweeteners in their diets. Manufacturers are responding to this demand by seeking to develop replacements for nutritive sweeteners that are better able to mimic the desirable taste and functional properties of the nutritive sweeteners.

An ideal replacement for a nutritive sweetener is a sweetener that has the same desirable taste characteristics and functional properties as the nutritive sweetener, but which also has low or no calories. Known replacements for nutritive sweeteners include both natural and synthetic sweeteners, the latter often being referred to as ‘artificial sweeteners’.

An important class of sweetener is represented by ‘high potency sweeteners’ or ‘high intensity sweeteners’. Sweeteners falling within this class have a sweetness many times that of sucrose, such that only very small amounts are needed to provide an equivalent level of sweetness to that of the nutritive sweetener being replaced. High potency sweeteners typically require the addition of a bulking agent (for example, a non-sweet saccharide polymer such as maltodextrin), and generally fail to provide the same taste and functional properties as the nutritive sweetener being replaced.

Another important class of sweetener is represented by ‘sugar alcohols’ or ‘polyols’ (for example, erythritol, xylitol, sorbitol, maltitol etc.). These sweeteners are generally able to provide a degree of calorie reduction (by way of example, sorbitol provides about 2.6 kcal/g compared to about 4 kcal/g for sucrose) while also providing bulk, but are often not able to fully mimic the desired taste characteristics (they often produce a perceived cooling sensation) or functional properties (such as browning). Furthermore, polyols are often not suitable for use at high levels due to low gastro-intestinal tolerance.

In view of the above, it would be desirable to provide a low or zero calorie sweetener that is able to replace nutritive sweeteners directly, without the need for other components such as bulking agents, temporal profile modifiers, flavor enhancers and the like. Such sweetener should be able to be used in high amounts to provide the bulk, sweetening and functional properties of the nutritive sweeteners being replaced.

It has now been found that allulose (also known as psicose) can be used in food and beverage products at high levels to provide the required bulk, sweetening and functional properties.

It would also be desirable to provide allulose in a form such that end users (such as home cooks and other consumers) can readily incorporate it into food and beverage products.

### SUMMARY OF THE INVENTION

The present invention relates to the use of high levels of allulose in food and beverage products to provide the bulk, sweetening and functional properties conventionally provided by nutritive sweeteners such as sucrose, glucose, fructose, corn syrup, high fructose corn syrup and the like.

The present invention is particularly concerned with the use of high levels of allulose as a single ingredient for the complete or partial replacement of nutritive sweeteners in food or beverage products.

According to one aspect, the present invention provides a sweet bakery product comprising allulose in an amount of from about 8% by weight to about 45% by weight relative to the total weight of the uncooked sweet bakery product. The product is preferably selected from the group consisting of rolls, cakes, pies, pastries, and cookies. In certain embodiments, the product comprises allulose in an amount of from about 15% by weight to about 35% by weight relative to the total weight of the uncooked sweet bakery product.

According to another aspect, the present invention provides a pre-made baking mix for preparing a sweet bakery product, wherein the pre-made baking mix comprises allulose in an amount sufficient to provide from about 8% by weight to about 45% by weight of allulose in the uncooked sweet bakery product. In certain embodiments, the pre-made baking mix comprises from about 13% by weight of allulose to about 75% by weight of allulose relative to the total weight of the pre-made baking mix, for example from about 25% by weight of allulose to about 58% by weight of allulose relative to the total weight of the pre-made baking mix.

According to another aspect, the present invention provides a sweet filling comprising allulose in an amount of from about 5% by weight to about 50% by weight relative to the total weight of the uncooked sweet filling. In certain embodiments, the sweet filling comprises allulose in an amount of from about 25% by weight to about 45% by weight relative to the total weight of the uncooked sweet filling. The sweet filling may be a sweet pie filling.

According to another aspect, the present invention provides a frozen dessert comprising allulose in an amount of from about 1% by weight to about 25% by weight relative to the total weight of the frozen dessert. The frozen dessert is preferably selected from the group consisting of frozen dairy desserts and frozen non-dairy desserts. In some embodiments, the dessert is selected from the group consisting of dairy ice cream, non-dairy ice cream and sorbet. In certain embodiments, the product comprises allulose in an amount of from about 5% by weight to about 9% by weight relative to the total weight of the dessert.

According to another aspect, the present invention provides a carbonated beverage comprising allulose in an amount of from about 2% by weight to about 25% by weight relative to the total weight of the beverage. The carbonated beverage is preferably a non-alcoholic carbonated beverage. In certain embodiments, the product comprises allulose in an amount of from about 2% by weight to about 7% by weight relative to the total weight of the carbonated beverage.

According to another aspect, the present invention provides a non-carbonated beverage comprising allulose in an amount of from about 1% by weight to about 25% by weight relative to the total weight of the non-carbonated beverage. The non-carbonated beverage is preferably a non-alcoholic non-carbonated beverage and is preferably selected from the group consisting of flavored waters, fruit drinks, and sweet tea or coffee based beverages. In certain embodiments, the non-carbonated beverage comprises allulose in an amount of from about 2% by weight to about 7% by weight relative to the total weight of the non-carbonated beverage.

According to another aspect, the present invention provides a yogurt comprising allulose in an amount of from about 2% by weight to about 15% by weight relative to the total weight of the yogurt. The yogurt is preferably selected from the group consisting of full fat, reduced fat and fat-free dairy yogurts, non-dairy and lactose-free yogurts, and frozen equivalents of all of these. In certain embodiments, the yogurt comprises allulose in an amount of from about 4% by weight to about 9% by weight relative to the total weight of the yogurt.

According to another aspect, the present invention provides a snack bar comprising allulose in an amount of from about 5% by weight to about 25% by weight relative to the total weight of the snack bar. The product is preferably a cereal bar. In certain embodiments, the bar comprises allulose in an amount of from about 12% by weight to about 20% by weight relative to the total weight of the snack bar.

According to another aspect, the present invention provides a bread product comprising allulose in an amount of from about 2% by weight to about 15% by weight relative to the total weight of the uncooked product. The product is preferably selected from the group consisting of leavened and unleavened breads, yeasted and unyeasted breads, breads comprising any type of wheat flour, breads comprising any type of non-wheat flour and gluten-free breads. In some embodiments, the product is a yeasted bread comprising wheat flour. In certain embodiments, the product comprises allulose in an amount of from about 8% by weight to about 11% by weight relative to the total weight of the product.

According to a further aspect, the present invention provides a pre-made bread mix for preparing a bread product, wherein the pre-made bread mix comprises allulose in an amount sufficient to provide from about 2% by weight to about 15% by weight of allulose in the uncooked bread product. In certain embodiments, the pre-made bread mix comprises allulose in an amount of from about 3% by weight to about 25% by weight relative to the total weight of the pre-made bread mix, for example in an amount of from about 13% by weight to about 18% by weight relative to the total weight of the pre-made bread mix.

According to a further aspect, the present invention provides a sauce or dressing comprising allulose in an amount of from about 2% by weight to about 80% by weight relative to the total weight of the sauce or dressing, for example in an amount of from about 5% by weight to about 40% by weight relative to the total weight of the sauce or dressing.

According to a further aspect, the present invention provides a sweet spread comprising allulose in an amount of from about 3% by weight to about 75% by weight relative to the total weight of the uncooked sweet spread. The sweet spread may be selected from the group consisting of fruit-based jellies, jams, butters, preserves and conserves. According to certain embodiments, the sweet spread comprises allulose in an amount of from about 3% by weight to about 50% by weight relative to the total weight of the uncooked sweet spread.

According to a further aspect, the present invention provides a confectionary product comprising allulose in an amount of from about 1% by weight to about 70% by weight relative to the total weight of the uncooked confectionary product. The confectionary product may be selected from the group consisting of jelly candies (gummies), soft candies, hard candies, chocolates and gums. According to certain embodiments, the confectionary product comprises allulose in an amount of from about 10% by weight to about 50% by weight relative to the total weight of the uncooked confectionary product.

According to some embodiments, the confectionary product further comprises a bulking agent. The bulking agent may be selected from the group consisting of polydextrose, soluble corn fiber (SCF), maltodextrin, a polyol and mixtures thereof. The bulking agent may be included in the confectionary product in a weight ratio to allulose of up to about 2:1 on a dry solids basis.

According to a further aspect, the present invention provides a sweetened breakfast cereal comprising from about 1% by weight to about 50% by weight of allulose based on the total weight of the sweetened breakfast cereal. The sweetened breakfast cereal may be selected from the group consisting of extruded breakfast cereals, flaked breakfast cereals and puffed breakfast cereals. According to certain embodiments, the sweetened breakfast cereal is a coated breakfast cereal comprising a breakfast cereal coated with a cereal coating composition comprising allulose.

According to a further aspect, the present invention provides a cereal coating composition comprising allulose in an amount of from about 5% by weight to about 80% by weight of allulose based on the total weight of the cereal coating composition. According to certain embodiments, the cereal coating composition comprises water allulose, and a bulking agent (which may be selected from the group consisting of soluble corn fiber (SCF), maltodextrin, polydextrose, polyols, nutritive sweeteners and mixtures thereof). In certain embodiments, the cereal coating composition comprises allulose in an amount of from about 20% by weight to about 40% by weight relative to the total weight of the cereal coating composition.

According to a further aspect, the present invention provides a food or beverage product selected from the group consisting of the sweet bakery product, the pre-made baking mix, the sweet filling, the frozen dessert, the carbonated beverage, the non-carbonated beverage, the yogurt, the snack bar, the bread product, the pre-made bread mix, the sauce or dressing, the sweet spread, the confectionary product, the sweetened breakfast cereal, and the cereal coating composition according to the above aspects.

In some embodiments, the food or beverage product does not contain any other sweetener other than allulose and, optionally, one or more nutritive sweetener.

In certain embodiments, the food or beverage product does not comprise a nutritive sweetener.

In other embodiments, the food or beverage product comprises one or more nutritive sweetener. In these embodiments, the nutritive sweetener may be selected from the group consisting of sucrose, glucose, glucose syrup, isoglucose, fructose, glucose-fructose syrup, maltose, lactose, corn syrup, high fructose corn syrup, invert sugar, molasses, honey, agave and mixtures thereof.

In certain preferred embodiments, the food or beverage product does not comprise any bulking agents selected from the group consisting of maltodextrin, polydextrose, xanthan gum, guar gum, soluble corn fiber (SCF), polyols, and mixtures thereof.

In certain embodiments, the food or beverage product does not contain any high intensity sweetener and/or does not contain any sugar alcohol.

According to some embodiments, the food or beverage product comprises one or more co-sweetener. In these embodiments, the one or more co-sweetener may be selected from the group consisting of high intensity sweeteners and sugar alcohols. For example, the one or more co-sweetener may be selected from the group consisting of monk fruit extracts and stevia extracts and/or from the group consisting of sucralose, aspartame and acesulfame potassium and/or from the group consisting of maltitol, xylitol and erythritol.

According to another aspect, the present invention provides a scoop-for-scoop sweetener comprising allulose, wherein the scoop-for-scoop sweetener has substantially the same sweetness per unit volume as sucrose. According to an embodiment, the scoop-for-scoop sweetener comprises allulose, at least one bulking agent, and at least one high intensity sweetener.

According to an embodiment, the scoop-for-scoop sweetener comprises allulose in an amount of from about 5% by weight to about 95% by weight relative to the total weight of the scoop-for-scoop sweetener. According to another embodiment, the scoop-for-scoop sweetener comprises allulose in an amount of from about 25% to about 90% by weight relative to the total weight of the scoop-for-scoop sweetener.

According to an embodiment, the at least one high intensity sweetener of the scoop-for-scoop sweetener is selected from the group consisting of monk fruit extracts, sucralose, aspartame, and mixtures thereof. According to an embodiment, the at least one bulking agent of the scoop-for-scoop sweetener is selected from the group consisting of maltodextrin, polydextrose, gums, soluble corn fiber (SCF), starches, polyols, and mixtures thereof. According to an embodiment, the at least one bulking agent comprises a nutritive sweetener, for example sucrose, fructose and/or dextrose.

According to another aspect, the present invention provides the use of the scoop-for-scoop sweetener of the present invention to replace sucrose on a 1:1 volume basis.

According to another aspect, the present invention provides a table-top sweetener comprising allulose and at least one other natural or synthetic sweetener.

According to an embodiment, the table-top sweetener is a dry table-top sweetener. For example, the dry table-top sweetener may take the form of tablets, granules or a powder.

According to an embodiment of the dry table-top sweetener, the at least one other natural or synthetic sweetener includes at least one natural and/or synthetic high intensity sweetener. The at least one natural and/or synthetic high intensity sweetener may comprise sucralose.

According to an embodiment of the dry table-top sweetener, the table-top sweetener comprises allulose in an amount of from about 97.5% to about 99.8% by weight relative to the total weight of allulose and at least one other natural or synthetic sweetener in the table-top sweetener.

According to an embodiment of the dry table-top sweetener, the table-top sweetener comprises allulose in an amount of from about 99.25% to about 99.75% and sucralose in an amount of from about 0.25% to about 0.75% by weight based on the total weight of allulose and sucralose in the table-top sweetener.

According to an embodiment of the dry table-top sweetener, the table-top sweetener comprises one or more nutritive sweetener. The nutritive sweetener may be selected from the group consisting of sucrose, glucose, glucose syrup, isoglucose, fructose, glucose-fructose syrup, maltose, lactose, corn syrup, high fructose corn syrup, invert sugar, molasses, honey, agave, and mixtures thereof. In an embodiment, the nutritive sweetener comprises sucrose.

According to an embodiment, the table-top sweetener is a liquid table-top sweetener, for example an aqueous solution.

According to an embodiment, the liquid table-top sweetener comprises a preservative. The preservative may be potassium sorbate.

According to an embodiment, the at least one other natural or synthetic sweetener of the liquid table-top sweetener is at least one natural or synthetic high intensity sweetener. The at least one natural or synthetic high intensity sweetener may comprise sucralose.

According to an embodiment, the liquid table-top sweetener comprises allulose in an amount of from about 2.5% to about 5% by weight, high intensity sweetener in an amount of from about 9% to about 10% by weight, preservative in an amount of from about 0.05% to about 0.15% by weight, and water in an amount of from about 84.85% to about 88.45% by weight, relative to the total weight of the table-top sweetener. The high intensity sweetener is preferably sucralose and the preservative is preferably potassium sorbate.

According to an embodiment, the liquid table-top sweetener comprises allulose in an amount of from about 45% to about 50% by weight, high intensity sweetener in an amount of from about 9% to about 10% by weight, preservative in an amount of from about 0.05% to about 0.15% by weight, and water in an amount of from about 39.85% to about 45.95% by weight, relative to the total weight of the table-top sweetener. The high intensity sweetener is preferably sucralose and the preservative is preferably potassium sorbate.

According to an embodiment, the liquid table-top sweetener comprises allulose in an amount of from about 2.5% to about 5% by weight, high intensity sweetener in an amount of from about 0.1% to about 0.15% by weight, preservative in an amount of from about 0.05% to about 0.15% by weight, and water in an amount of from about 94.7% to about 97.35% by weight, relative to the total weight of the table-top sweetener. The high intensity sweetener is preferably sucralose and the preservative is preferably potassium sorbate.

According to an embodiment, the liquid table-top sweetener comprises allulose in an amount of from about 70% to about 80% by weight, high intensity sweetener in an amount of from about 0.04% to about 0.07% by weight, preservative in an amount of from about 0.05% to about 0.15% by weight, and water in an amount of from about 19.78% to about 29.91% by weight, relative to the total weight of the table-top sweetener. The high intensity sweetener is preferably sucralose and the preservative is preferably potassium sorbate.

According to another aspect, the present invention provides a sweetener system comprising allulose, at least one bulking agent, and preferably at least one high intensity sweetener.

According to an embodiment, the sweetener system comprises allulose in an amount of from about 5% by weight to about 95% by weight relative to the total weight of the sweetener system, for example in an amount of from about 20% to about 50% by weight relative to the total weight of the sweetener system.

According to an embodiment, the at least one high intensity sweetener of the sweetener system is selected from the group consisting of stevia extracts, monk fruit extracts, a combination of stevia and monk fruit extracts, and sucralose.

According to an embodiment, the at least one bulking agent of the sweetener system is selected from the group consisting of maltodextrin, polydextrose, gums (such as xanthan gum or guar gum), soluble corn fiber (SCF), starches, polyols, and mixtures thereof. For example, the at least one bulking agent may be selected from the group consisting of maltodextrin, polydextrose, SCF, and mixtures thereof. In an embodiment, the at least one bulking agent comprises SCF.

According to an embodiment, the sweetener system comprises the at least one bulking agent in an amount of from about 5% by weight to about 95% by weight relative to the total weight of the sweetener system, for example in an amount of from about 50% to about 80% by weight relative to the total weight of the sweetener system.

According to an embodiment, the sweetener system further comprises one or more nutritive sweetener.

According to an embodiment, the sweetener system is provided in solid form. According to another embodiment, the sweetener system is provided in liquid form, preferably as a syrup.

According to an embodiment, the sweetener system is for use in frozen desserts, and comprises allulose in an amount of from about 20% to about 50% by weight relative to the total weight of the sweetener system; SCF in an amount of from about 50% to about 80% by weight relative to the total weight of the sweetener system; stevia extract in an amount of from about 0.10% to about 0.20% by weight relative to the total weight of the sweetener system; and monk fruit extract in an amount of from about 0.02% to about 0.09% by weight relative to the total weight of the sweetener system. According to an embodiment, this sweetener system further comprises fructose in an amount of from about 1% to about 2% by weight relative to the total weight of the sweetener system. This sweetener system may be provided as a syrup.

The sweetener system of the present invention is particularly suitable for use in a frozen dessert according to the present invention. Thus, according to an embodiment, the food or beverage product of the present invention is a frozen dessert and comprises the sweetener system of the present invention. The food or beverage product according to this embodiment may be an ice cream.

When the food or beverage product is a frozen dessert comprising the sweetener system of the present invention, the bulking agent may be present in an amount of from about 9% to about 13% by weight relative to the total weight of the frozen dessert.

When the food or beverage product is a frozen dessert comprising the sweetener system of the present invention, the sweetener system may be the sweetener system described above for use in frozen desserts.

According to an embodiment, the frozen dessert comprises allulose in an amount of from about 3% to about 8% by weight relative to the total weight of the frozen dessert; a bulking agent in an amount of from about 9% to about 13% by weight relative to the total weight of the frozen dessert; and one or more high intensity sweetener. The one or more high intensity sweetener may be a combination of a stevia extract and a monk fruit extract. The stevia extract may be present in an amount of from about 0.018% to about 0.035% by weight relative to the total weight of the frozen dessert and the monk fruit extract may be present in an amount of from about 0.009% to about 0.017% by weight relative to the total weight of the frozen dessert.

### BRIEF DESCRIPTION OF THE DRAWINGS

FIG. 1 shows the firmness of bread comprising allulose (according to Example 9) compared to that of bread without allulose (According to Comparative Example 9).

FIG. 2 shows informal sensory data comparing a granola bar comprising allulose (according to Example 15) and a granola bar without allulose (according to Comparative Example 15).

FIGS. 3A and 3B show texture profile data for gummies with varying allulose content and comparative gummies without allulose, according to Example 17.

FIG. 4 shows further texture profile data for gummies with varying allulose content and comparative gummies without allulose, according to Example 17.

### DETAILED DESCRIPTION

The present invention relates to the use of high levels of allulose in food and beverage products to provide the bulk, sweetening and functional properties conventionally provided by nutritive sweeteners such as sucrose, glucose, fructose, corn syrup, high fructose corn syrup and the like.

The term “allulose” (or “D-allulose”) as used herein refers to a monosaccharide sugar of the structure shown in Formula I. It is also known as “D-psicose”, and is a C3 epimer of D-fructose. Its structure is shown as a Fischer projection in below Formula I:

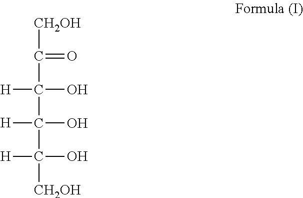 [SMILES: O=C(CO)C(O)C(O)C(O)CO]

Allulose is known as a “rare sugar”, since it occurs in nature in only very small amounts. It provides around 70% of the sweetness of sucrose, but only around 5% of the calories (approximately 0.2 kcal/g). It may therefore essentially be considered to be a ‘zero calorie’ sweetener.

In view of its scarcity in nature, production of allulose relies on the epimerization of readily available fructose. Ketose-3-epimerases can interconvert fructose and allulose, and various ketose-3-epimerases are known for carrying out this conversion.

U.S. Pat. No. 8,030,035 and PCT publication no. WO2011/040708 disclose that D-psicose (an alternative name for allulose) can be produced by reacting D-fructose with a protein derived from Agrobacterium tumefaciens, and having psicose 3-epimerase activity.

US patent publication no. 2011/0275138 discloses a ketose 3-epimerase derived from a microorganism of the Rhizobium genus. This protein shows a high specificity to D- or L-ketopentose and D- or L-ketohexose, and especially to D-fructose and D-psicose. This document also discloses a process for producing ketoses by using the protein.

Korean patent no. 100832339 discloses a Sinorhizobium YB-58 strain which is capable of converting fructose into psicose (i.e. allulose), and a method of producing psicose using a fungus body of the Sinorhizobium YB-58 strain.

Korean patent application no. 1020090098938 discloses a method of producing psicose using E. coli wherein the E. coli expresses a polynucleotide encoding a psicose 3-epimerase.

Unless the context dictates otherwise, the term “sweetener” as used herein relates to a substance having a sweetness equivalent (by weight) of 50% of that of sucrose or greater, and the term “low-calorie sweetener” as used herein relates to a sweetener supplying 50% or less of the calories of a sweet-equivalent amount of sucrose, preferably 30% or less of the calories of a sweet-equivalent amount of sucrose, preferably 20% or less of the calories of a sweet-equivalent amount of sucrose, preferably 10% or less of the calories of a sweet-equivalent amount of sucrose.

Unlike many known replacements for nutritive sweeteners (such as natural and artificial high intensity sweeteners, sugar alcohols and the like), it has been found that allulose is able to be used at high levels to effectively mimic the desirable taste characteristics and functional properties of nutritive sweeteners, without the need for other components such as bulking agents, temporal profile modifiers, flavor enhancers and the like. In particular, it has been found that high levels of allulose are able to provide bulking and texture, desirable functional properties such as browning, humectancy, freezing point depression and the like, and a favorable sensory response, for example in terms of quality of sweetness, lack of bitterness and off taste, desirable temporal profile and desirable mouthfeel. It has also been found that allulose is able to offer certain processing benefits, for example as an aeration modifier, stabilizer, extrusion aid, melt control agent, fermentation performance enhancer, selective culture nutrient source, modifier of starch gelatinization temperature, osmotic pressure modifier, water activity depressant, freezing point depressant, rheology modifier, foam stabilizer, recrystallization control agent, fat crystal control agent, color development aid, compression aid and the like.

The present invention is particularly concerned with the use of high levels of allulose as a single ingredient for the complete or partial replacement of nutritive sweeteners in food or beverage products.

The amount of allulose which will constitute a ‘high level’ will vary according to the food or beverage product under consideration. However, in general terms, ‘high level’ may be taken to mean an amount up to and including the amount required to fully replace the nutritive sweetener in the corresponding conventional food or beverage product, in particular in terms of providing equivalent sweetness. Thus, if replacing sucrose, a ‘high level’ of allulose may be taken to mean up to and including around 1.43 times the amount (by weight) of the weight of sucrose being replaced (based on a relative sweetness for allulose of around 70% that of sucrose).

In general terms, the present invention contemplates that food and beverage products may include allulose in an amount of up to about 80% by weight relative to the total weight of the food or beverage product, for example in an amount of from around 1% by weight to around 80% by weight relative to the total weight of the food or beverage product. All intermediate amounts (i.e. 2%, 3%, 4% . . . 77%, 78%, 79% by weight relative to the total weight of the food or beverage product) are contemplated, as are all intermediate ranges based on these amounts.

Food or beverage products which may be contemplated in the context of the present invention include baked goods; sweet bakery products (including, but not limited to, rolls, cakes, pies, pastries, and cookies); pre-made sweet bakery mixes for preparing sweet bakery products; pie fillings and other sweet fillings (including, but not limited to, fruit pie fillings and nut pie fillings such as pecan pie filling, as well as fillings for cookies, cakes, pastries, confectionary products and the like, such as fat-based cream fillings); desserts, gelatins and puddings; frozen desserts (including, but not limited to, frozen dairy desserts such as ice cream—including regular ice cream, soft serve ice cream and all other types of ice cream—and frozen non-dairy desserts such as non-dairy ice cream, sorbet and the like); carbonated beverages (including, but not limited to, soft carbonated beverages); non-carbonated beverages (including, but not limited to, soft non-carbonated beverages such as flavored waters and sweet tea or coffee based beverages); beverage concentrates (including, but not limited to, liquid concentrates and syrups as well as non-liquid ‘concentrates’, such as freeze-dried and/or powder preparations); yogurts (including, but not limited to, full fat, reduced fat and fat-free dairy yogurts, as well non-dairy and lactose-free yogurts and frozen equivalents of all of these); snack bars (including, but not limited to, cereal, nut, seed and/or fruit bars); bread products (including, but not limited to, leavened and unleavened breads, yeasted and unyeasted breads such as soda breads, breads comprising any type of wheat flour, breads comprising any type of non-wheat flour (such as potato, rice and rye flours), gluten-free breads); pre-made bread mixes for preparing bread products; sauces, syrups and dressings; sweet spreads (including, but not limited to, jellies, jams, butters, nut spreads and other spreadable preserves, conserves and the like); confectionary products (including, but not limited to, jelly candies, soft candies, hard candies, chocolates and gums); sweetened breakfast cereals (including, but not limited to, extruded (kix type) breakfast cereals, flaked breakfast cereals and puffed breakfast cereals); and cereal coating compositions for use in preparing sweetened breakfast cereals. Other types of food and beverage product not mentioned here but which conventionally include one or more nutritive sweetener may also be contemplated in the context of the present invention. In particular, animal foods (such as pet foods) are explicitly contemplated.

As a consequence of the complete or partial replacement of nutritive sweeteners in the food or beverage products of the present invention, the food or beverage products of the present invention may be useful as low calorie or dietetic products, medical foods/products (including pills and tablets), and sports nutrition products.

In view of its lower sweetening value (SEV) compared to sucrose, allulose may be particularly suitable for use in food or beverage products requiring a lower sweetness at a given soluble solids level.

Allulose may typically be provided in crystalline form (i.e. pure allulose) or in the form of a syrup comprising allulose. Syrups comprising allulose may contain allulose in varying amounts on a dry solids (ds or DS) basis (typically from about 70 to about 90% by weight). Unless otherwise stated, all amounts herein are quoted on a dry solids basis, i.e. they relate to the amount of pure allulose to be used. Thus, where it is intended to provide allulose in the form of a syrup, the amount of syrup used should be adjusted to supply the required amount of allulose on a dry solids basis.

The source of allulose used in the preparation of the food and beverage products described herein may comprise, consist essentially of, or consist of allulose. For example, the allulose source used to formulate foods and beverages in accordance with the present invention may have a purity (expressed as weight % allulose, based on the total weight of the allulose source) of at least 50%, at least 60%, at least 70%, at least 80%, at least 90%, at least 95%, at least 96%, at least 97%, at least 98%, at least 99%, at least 99.5% or at least 99.9%. The allulose source may, in one embodiment, be 100% pure allulose. In certain embodiments, the allulose source may be an admixture of allulose and one or more other sugars, such as fructose, glucose, sucrose, allose, tagatose or the like. If employed in solid form, the allulose may have any crystal morphology, particle size, crystal shape or other physical characteristics that may be suitable in view of the intended food or beverage use.

Where content amounts are described herein by reference to numerical ranges, all intermediate amounts encompassed by said ranges are expressly disclosed herein, as are all intermediate ranges based on said intermediate amounts.

Unless otherwise stated, all content amounts are stated with reference to food or beverage products in their uncooked states, i.e. prior to any moisture loss which may occur during cooking.

According to one aspect, the present invention provides a sweet bakery product comprising allulose in an amount of from about 8% by weight to about 45% by weight relative to the total weight of the uncooked product (e.g. uncooked dough or batter). Sweet bakery products which may be contemplated include, but are not limited to, rolls, cakes, pies, pastries, and cookies.

In addition to allulose, the sweet bakery product according to the present invention typically comprises one or more starchy ingredients, including all suitable types of flours (including bleached, unbleached and self-raising flours) and starches (including native and modified starches). The starchy ingredient may be derived from any suitable source including, but not limited to, wheat, rice, maize (corn), oat, rye, barley, tapioca, sago, amaranth, arrowroot, sorghum, pea, banana, potato and sweet potato. The source may be waxy or non-waxy.

The sweet bakery product according to the present invention may include one or more ingredients selected from the group consisting of leavening agents (such as yeast, bicarbonate of soda, baking soda, cream of tartar and the like), eggs or egg-derived products, fats, oils, water, milk and/or other dairy products, alcohol, gums, natural and/or artificial colors, natural and/or artificial flavors (such as vanilla), salt, chocolate and/or cocoa, coconut and coconut-derived products, spices, fruits and fruit-derived products, vegetables and vegetable-derived products, legumes and legume-derived products, nuts and nut-derived products, preservatives, stabilizers, antioxidants, emulsifiers, proteins, amino acids, vitamins, minerals, and any other ingredients suitable for inclusion in a sweet bakery product.

By way of example, sweet bakery products according to the present invention may comprise allulose in an amount of from about 8% by weight to about 45% by weight relative to the total weight of the uncooked product, for example in an amount of from about 10% to about 40% by weight relative to the total weight of the uncooked product, for example in an amount of from about 15% by weight to about 35% by weight relative to the total weight of the uncooked product, for example in an amount of about 8%, 9%, 10%, 15%, 20%, 25%, 30%, 35%, 40% or 45% by weight relative to the total weight of the uncooked product.

In order to optimize certain physical properties of the sweet bakery products according to the present invention, it may be desirable to make certain other adjustments to the conventional recipes, besides the complete or partial replacement of nutritive sweeteners (such as sucrose, high fructose corn syrup and the like) by allulose. Physical properties which it may be desired to optimize include crumb structure (e.g. of cookies, pie crusts and the like), spread (e.g. in the case of cookies), surface appearance, softness (e.g. in the case of cookies), degree of rise (e.g. in the case of cakes), level of browning, moisture retention (humectancy), and the like.

In the case of partial replacement of nutritive sweetener, one possibility for influencing one or more of the above physical properties is to adjust the amount of the nutritive sweetener replaced by allulose. In the case of cookies, for example, such adjustment can help to optimize both texture and browning. Thus, according to a preferred embodiment, the sweet bakery product of the present invention is a cookie and comprises allulose (e.g. in an amount of from about 25% to about 37% by weight, for example about 29% to about 33% by weight, based on the total weight of the cookie dough) and sucrose (e.g. in an amount of from about 4% to about 10% by weight, for example about 6% to about 8% by weight, based on the total weight of the cookie dough).

A further possibility for influencing one or more of the above physical properties is to include texture modifiers and/or moisture retaining agents. Examples of such texture modifiers and/or moisture retaining agents are specialist bakery starches. Such specialist bakery starches include starches which are one or more of cold-water-swelling, granular, pre-gelatinized and instant. Thus, according to certain embodiments, the sweet bakery product according to the present invention includes a specialist bakery starch.

Egg whites may also be used to influence one or more of the above physical properties, especially in the case of risen products such as cakes, muffins and the like, particularly when higher amounts of allulose are used.

According to one embodiment, the sweet bakery product of the present invention is a cookie and comprises a specialist bakery starch, preferably a cold-water-swelling, granular, instant starch. Such specialist bakery starch may be included in the cookie in an amount of up to around 1% by weight, for example up to around 0.5% by weight, up to around 0.3% by weight, or around 0.24% by weight, based on the total weight of the cookie dough.

According to another embodiment, the sweet bakery product of the present invention is a cake and comprises a specialist bakery starch, preferably a granular instant starch. Such specialist bakery starch may be included in the cake in an amount of up to around 3% by weight, for example up to around 2% by weight, up to around 1.5% by weight, or around 1% by weight, based on the total weight of the cake batter.

Careful control of baking conditions may also be used to influence the physical properties of the sweet bakery product according to the present invention.

It has surprisingly been found that sweet bakery products according to the present invention have better storage characteristics than conventional sweet bakery products. It appears that allulose retards the degradation of sweet bakery products. In other words, the inclusion of allulose in sweet bakery products has an anti-staling effect on the products and prolongs their life.

According to another aspect, the present invention provides a pre-made baking mix for preparing a sweet bakery product, wherein the pre-made baking mix comprises allulose in an amount sufficient to provide from about 8% by weight to about 45% by weight of allulose in the uncooked sweet bakery product (i.e. uncooked dough or batter). For example, the pre-made baking mix may comprise from about 13% by weight of allulose to about 75% by weight of allulose relative to the total weight of the pre-made baking mix.

The pre-made baking mix for preparing a sweet bakery product is a pre-made mix for use in preparing a sweet bakery product according to the present invention. Accordingly, the pre-made mix may comprise any combination of the ingredients discussed above with respect to the sweet bakery product. The description relating to the sweet bakery product of the present invention therefore applies mutatis mutandis.

Generally, the pre-made baking mix will comprise only the ‘dry’ ingredients required for preparing the sweet bakery product. Thus, the pre-made baking mix will typically not contain ‘wet’ ingredients such as eggs or egg-derived products, fats, oils, water, milk and/or other dairy products, or other ‘wet’ ingredients. Dried forms of such ingredients (e.g. dried egg or milk products) may be included, and oils and/or fats may also be included according to some embodiments. Anti-caking agents may also be advantageously incorporated in the pre-made baking mixes of the present invention.

By way of example, the pre-made baking mixes according to the present invention may comprise allulose in an amount of from about 13% by weight to about 75% by weight relative to the total weight of the pre-made baking mix, for example in an amount of from about 16% to about 67% by weight relative to the total weight of the pre-made baking mix, for example in an amount of from about 25% by weight to about 58% by weight relative to the total weight of the pre-made baking mix, for example in an amount of about 13%, 14%, 15%, 20%, 25%, 30%, 35%, 40%, 50%, 60%, 70% or 75% by weight relative to the total weight of the pre-made baking mix.

By way of example, a pre-made baking mix according to the present invention may comprise the following ingredients:

| INGREDIENT | Amount, wt % (as is) |
|---|---|
| Flour | 20-60 |
| Sugar | 0-40 |
| Allulose | 13-75 |
| Leavening agent | 0-4 |
| Starch | 0-10 |
| Salt | 0-2 |
| Xanthan gum | 0-0.5 |
| Sucralose | 0-0.05 |
| TOTAL | 100 |

In the case where the sweet bakery product according to the present invention has a sweet filling, such as a pie filling or a filling for cookies, cakes, pastries, confectionary products and the like, such as a fat-based cream filling, the sweet filing may suitably comprise allulose in an amount of from about 5% by weight to about 50% by weight relative to the total weight of the uncooked sweet filling. Such sweet fillings may also comprise at least one plant-derived component (such as a fruit, vegetable, legume, nut or coconut component, for example). Such plant-derived component may be present in an amount of from around 1% by weight to about 60% by weight relative to the total weight of the uncooked sweet filling. The plant product may be in any suitable form, for example in whole form, in pieces, minced, crushed, as a paste or puree, as juice, as a concentrate, as a sauce or as an extract.

Sweet fillings according to the present invention may also include a texturizer. Suitable texturizers can be derived from either animal or plant sources and include, but are not limited to starches, polysaccharides, gelatin, pectin and the like. Generally, a texturizer may be included in an amount of from about 0.1% by weight to about 20% by weight based on the total weight of the uncooked sweet filling.

The sweet fillings according to the present invention may include one or more ingredients selected from the group consisting of eggs or egg-derived products, fats, oils, water, milk and/or other dairy products, alcohol, gums, natural and/or artificial colors, natural and/or artificial flavors (such as vanilla), salt, chocolate and/or cocoa, coconut and coconut-derived products, spices, fruits and fruit-derived products, vegetables and vegetable-derived products, legumes and legume-derived products, nuts and nut-derived products, preservatives, stabilizers, antioxidants, emulsifiers, proteins, amino acids, vitamins, minerals, and any other ingredients suitable for inclusion in a sweet filling.

By way of example, the sweet fillings according to the present invention may comprise allulose in an amount of from about 5% by weight to about 50% by weight relative to the total weight of the uncooked sweet filling, for example in an amount of from about 10% to about 45% by weight relative to the total weight of the uncooked sweet filling, for example in an amount of from about 25% by weight to about 45% by weight relative to the total weight of the uncooked sweet filling, for example in an amount of about 5%, 10%, 15%, 20%, 25%, 30%, 35%, 40% or 50% by weight relative to the total weight of the uncooked sweet filling.

By way of example, a sweet cherry filling according to the present invention may comprise the following ingredients (uncooked state):

| INGREDIENT | Amount, wt % (as is) |
|---|---|
| Water | 10-30 |
| Individually quick frozen (IQF) cherries | 15-40 |
| Low DE corn syrup | 0-15 |
| Sucrose, granulated | 0-8 |
| Modified starch | 1-10 |
| Salt | 0-1 |
| HFCS 55 77DS | 0-20 |
| Allulose, 77DS | 1-50 |
| SPLENDA ® Sucralose, 25% liquid | 0-0.2 |
| Total | 100 |

According to another aspect, the present invention provides a frozen dessert comprising allulose in an amount of from about 1% by weight to about 25% by weight relative to the total weight of the dessert. Frozen desserts which may be contemplated include, but are not limited to, frozen dairy desserts such as ice cream (including regular ice cream, soft serve ice cream and all other types of ice cream) and frozen non-dairy desserts such as non-dairy ice cream, sorbet and the like.

The frozen dessert of the present invention may comprise one or more milk products (in the case of ice-creams, for example). Said milk products may be derived from the milk of any animal (including but not limited to cow, goat, sheep, water buffalo and camel), or may be a plant-derived ‘milk’ such as soy milk, nut milks such as almond milk, or coconut milk. Said milk products include creams, butters, milk solids, as well as dry powders, such as milk powder. According to some embodiments, some or all of the milk products used have reduced or zero fat content.

The frozen dessert according to the present invention may include one or more ingredients selected from the group consisting of eggs or egg-derived products, fats, oils, water, dairy products, alcohol, gums, natural and/or artificial colors, natural and/or artificial flavors (such as vanilla), salt, chocolate and/or cocoa, coconut and coconut-derived products, spices, fruits and fruit-derived products, vegetables and vegetable-derived products, legumes and legume-derived products, nuts and nut-derived products, acidulants, preservatives, stabilizers (for example mixtures comprising one or more of: Gums such as a cellulose gum; starches such as modified waxy-maize starches; dextrose; carrageenan; mono- and/or di-glycerides and disodium phosphate), antioxidants, proteins, amino acids, vitamins, minerals, and any other ingredients suitable for inclusion in a frozen dessert.

By way of example, frozen desserts according to the present invention may comprise allulose in an amount of from about 1% by weight to about 25% by weight relative to the total weight of the dessert, for example in an amount of from about 2% by weight to about 15% by weight relative to the total weight of the dessert, for example in an amount of from about 5% by weight to about 9% by weight relative to the total weight of the dessert, for example in an amount of about 1%, 2%, 5%, 9%, 10%, 15%, 20% or 25% by weight relative to the total weight of the dessert.

An example of a frozen dessert according to the present invention is an ice cream comprising one or more milk product in an amount of from about 2 to about 90% by weight, allulose in an amount of from about 1% to about 9% by weight and a stabilizer in an amount of from about 0.01% to about 5% by weight. In the case of partial replacement of nutritive sweetener by allulose, the ice cream may further comprise an amount of nutritive sweetener, for example from about 1% to about 25% by weight.

Although it has been found that allulose can be used as a single ingredient to replace some or all of the nutritive sweetener in conventional frozen desserts (e.g. ice creams) with excellent results, it may sometimes be advantageous to also include other ingredients. Other ingredients which may be contemplated in this regard include bulking agents and/or high intensity sweeteners. Suitable bulking agents and high intensity sweeteners include those described in connection with the sweetener system of the present invention, and the description of the sweetener system of the present invention applies mutatis mutandis.

Any of the ingredients of the sweetener system of the present invention may be included in the frozen desserts of the present invention, and may be added either as the sweetener system of the present invention, or as separate ingredients. It will usually be more convenient to utilize the sweetener system of the present invention. Accordingly, an embodiment provides a frozen dessert (e.g. ice cream) comprising the sweetener system of the present invention.

When the frozen desserts (e.g. ice creams) of the present invention include a bulking agent (added either as a component of the sweetener system of the present invention, or as a separate ingredient), then the amount of bulking agent in the finished frozen dessert will typically be from about 5% to about 15%, for example from about 9% to about 13%, for example about 11% by weight relative to the total weight of the frozen dessert.

An example of a frozen dessert (e.g. ice cream) comprising the sweetener system of the present invention comprises allulose in an amount of from about 2% to about 10% (for example about 3% to about 8%, for example about 5%, about 6% or about 7%) by weight relative to the total weight of the frozen dessert; a bulking agent (such as SCF) in an amount of from about 5% to about 15% (for example from about 9% to about 13%, for example about 11%) by weight relative to the total weight of the frozen dessert; and one or more high intensity sweetener. The one or more high intensity sweetener may, for example, be a combination of a stevia extract and a monk fruit extract. The stevia extract may be present in an amount of from about 0.015% to about 0.040% (for example about 0.018% to about 0.035%, for example about 0.022% or about 0.031%) by weight relative to the total weight of the frozen dessert. The monk fruit extract may be present in an amount of from about 0.006% to about 0.020% (for example about 0.009% to about 0.017%, for example about 0.011% or about 0.015%) by weight relative to the total weight of the frozen dessert.

According to another aspect, the present invention provides a carbonated beverage comprising allulose in an amount of from about 2% by weight to about 25% by weight. Any type of carbonated beverage may be contemplated, but non-alcoholic (i.e. soft) carbonated beverages are generally preferred.

In addition to allulose, the carbonated beverage according to the present invention comprises a carbonated liquid. The carbonated liquid will generally comprise water as its main ingredient.

The carbonated beverages according to the present invention may include one or more ingredients selected from the group consisting of gums, natural and/or artificial colors, natural and/or artificial flavors, acidulants, salt, electrolytes, spices, fats, oils, fruits and fruit-derived products, vegetables and vegetable-derived products, legumes and legume-derived products, nuts and nut-derived products, milk and dairy products, preservatives, stabilizers, antioxidants, vitamins, minerals, protein (including whey protein and the like), amino acids, tea and tea extracts, herbs and herbal extracts, coffee and coffee extracts, and any other ingredients suitable for inclusion in a carbonated beverage.

When an acidulant is used in the carbonated beverage product, it may be based on organic and/or inorganic acids and may be one or more selected from the group consisting of acetic acid, citric acid, phosphoric acid, lactic acid, malic acid, fumaric acid, ascorbic acid, tartaric acid and hydrochloric acid, as well as any other acidulants suitable for inclusion in a carbonated beverage. The acidulant can be added to the carbonated beverage in the form of a solid or in solution.

By way of example, carbonated beverages according to the present invention may comprise allulose in an amount of from about 2% by weight to about 25% by weight relative to the total weight of the beverage, for example in an amount of from about 2% by weight to about 20% by weight relative to the total weight of the beverage, for example in an amount of from about 2% by weight to about 15% by weight relative to the total weight of the beverage, for example in an amount of from about 2% by weight to about 7% by weight relative to the total weight of the beverage, for example in an amount of from about 4% by weight to about 6% by weight relative to the total weight of the beverage, for example in an amount of about 2%, 2.2%, 3%, 4%, 4.5%, 5%, 5.5%, 6%, 6.5%, 7%, 8%, 9%, 10%, 15%, 20% or 25% by weight relative to the total weight of the beverage.

According to certain embodiments of the present invention, the amount of allulose in the carbonated beverage is not 16.7% by weight, 16.67% by weight or 13.33% by weight relative to the total weight of the beverage.

According to certain embodiments of the present invention, the carbonated beverage is not an alcoholic or beer-flavored beverage.

As will be appreciated by those skilled in the art, carbonated beverages may be prepared by diluting a concentrate with a carbonated liquid, typically with carbonated water. Concentrates for preparing the carbonated beverages of the present invention are explicitly contemplated (including liquid concentrates and syrups as well as non-liquid ‘concentrates’, such as freeze-dried and/or powder preparations), and such concentrates may comprise any of the ingredients mentioned above with reference to carbonated beverages. The concentrates according to the present invention comprise allulose in an amount such that, following dilution with a carbonated liquid, the amount of allulose in the resulting carbonated beverage is as defined above with reference to the carbonated beverages according to the present invention.

Carbonated beverages typically have a low (i.e. acidic) pH, and it is known that sucrose can be unstable under acidic conditions. The complete or partial replacement of sucrose by allulose according to the present invention can help to address this problem in an advantageous manner.

Frozen carbonated beverage products (sometimes known as ‘slushies’) are also explicitly contemplated, and may be prepared by freezing (or partially freezing) the carbonated beverages of the present invention.

The carbonated beverage product of the present invention may be a sports nutrition drink (such as electrolyte drinks and the like).

According to another aspect, the present invention provides a non-carbonated beverage comprising allulose in an amount of from about 1% by weight to about 25% by weight relative to the total weight of the beverage. Any type of non-carbonated beverage may be contemplated, but non-alcoholic (i.e. soft) non-carbonated beverages are generally preferred.

In addition to allulose, the non-carbonated beverage according to the present invention comprises a non-carbonated liquid. The non-carbonated liquid may comprise water, milk, tea, coffee, fruit and/or vegetable and/or legume juices, purees and/or extracts, or any other non-carbonated liquid used in the preparation of non-carbonated beverages. Examples of non-carbonated beverages according to the present invention include flavored waters, fruit drinks (e.g. strawberry), sweet tea or coffee based beverages, and sports nutrition drinks (such as protein shakes, electrolyte drinks and the like). Dairy and non-dairy beverages (including coconut, almond, soy and similar ‘dairy replacement’ products) may be contemplated.

The non-carbonated beverages according to the present invention may include one or more ingredients selected from the group consisting of gums, natural and/or artificial colors, natural and/or artificial flavors, acidulants, salt, electrolytes, spices, fats, oils, fruits and fruit-derived products, vegetables and vegetable-derived products, legumes and legume-derived products, nuts and nut-derived products, milk and dairy products, preservatives, stabilizers, antioxidants, vitamins, minerals, protein (including whey protein and the like), amino acids, tea and tea extracts, herbs and herbal extracts, coffee and coffee extracts, and any other ingredients suitable for inclusion in a non-carbonated beverage.

When an acidulant is used in the non-carbonated beverage product, it may be based on organic and/or inorganic acids and may be one or more selected from the group consisting of acetic acid, citric acid, phosphoric acid, lactic acid, malic acid, fumaric acid, ascorbic acid, tartaric acid and hydrochloric acid, as well as any other acidulants suitable for inclusion in a non-carbonated beverage. The acidulant can be added to the non-carbonated beverage in the form of a solid or in solution.

By way of example, non-carbonated beverages according to the present invention may comprise allulose in an amount of from about 1% by weight to about 25% by weight relative to the total weight of the beverage, for example in an amount of from about 2% by weight to about 20% by weight relative to the total weight of the beverage, for example in an amount of from about 2% by weight to about 15% by weight relative to the total weight of the beverage, for example in an amount of from about 2% by weight to about 7% by weight relative to the total weight of the beverage, for example in an amount of from about 4% by weight to about 6% by weight relative to the total weight of the beverage, for example in an amount of about 1%, 1.5%, 2%, 2.5%, 3%, 3.5%, 4%, 4.5%, 5%, 5.5% 6%, 6.5%, 7%, 8%, 9%, 10%, 15%, 20% or 25% by weight relative to the total weight of the beverage.

According to certain embodiments of the present invention, the amount of allulose in the non-carbonated beverage is not 16.7% by weight, 16.67% by weight or 13.33% by weight relative to the total weight of the beverage.

According to certain embodiments of the present invention, the non-carbonated beverage is not an alcoholic or beer-flavored beverage.

As will be appreciated by those skilled in the art, non-carbonated beverages may be prepared by diluting a concentrate (including liquid concentrates and syrups as well as non-liquid ‘concentrates’, such as freeze-dried and/or powder preparations including ‘instant’ coffee/coffee mix, chocolate/cocoa beverage mixes, flavored and unflavored dairy and non-dairy creamers, protein shake powders and the like) with a liquid, typically with water (in the case of creamers and similar products, the liquid may typically be tea, coffee or the like). Concentrates for preparing the non-carbonated beverages of the present invention are explicitly contemplated, and such concentrates may comprise any of the ingredients mentioned above with reference to non-carbonated beverages. The concentrates according to the present invention comprise allulose in an amount such that, following dilution with a liquid, the amount of allulose in the resulting non-carbonated beverage is as defined above with reference to the non-carbonated beverages according to the present invention.

Certain types of non-carbonated beverage may have a low (i.e. acidic) pH, and it is known that sucrose can be unstable under acidic conditions. The complete or partial replacement of sucrose by allulose according to the present invention can help to address this problem in an advantageous manner.

Frozen non-carbonated beverage products (sometimes known as ‘slushies’) are also explicitly contemplated, and may be prepared by freezing (or partially freezing) the non-carbonated beverages of the present invention.

According to another aspect, the present invention provides a yogurt comprising allulose in an amount of from about 2% by weight to about 15% by weight relative to the total weight of the yogurt. Any type of yogurt may be contemplated, including full fat, reduced fat and fat-free dairy yogurts, as well non-dairy and lactose-free yogurts and frozen equivalents of all of these. Yogurt drinks, or ‘drinking yogurts’ are also contemplated. Dairy yogurts (i.e. true yogurts) are generally preferred.

In addition to allulose, the yogurt according to the present invention comprises a yogurt base. The yogurt base will generally comprise a fermented milk product. The milk product may be derived from the milk of any animal (including but not limited to cow, goat, sheep, water buffalo and camel), or may be a plant-derived ‘milk’ such as soy milk, nut milks such as almond milk, or coconut milk. The fermented milk product is produced by fermenting the milk product using a yogurt culture.

Typically, the yogurt according to the present invention may be prepared by combining the yogurt base with a flavor preparation, such as a fruit-based flavor preparation.

The yogurt according to the present invention may include one or more ingredients selected from the group consisting of gums, natural and/or artificial colors, natural and/or artificial flavors, starches, salt, spices, fruits and fruit-derived products, vegetables and vegetable-derived products, legumes and legume-derived products, nuts and nut-derived products, preservatives, stabilizers, antioxidants, vitamins, minerals and any other ingredients suitable for inclusion in a yogurt. Such ingredients may be incorporated in the yogurt base and/or in a flavor preparation.

In the production of yogurt according to the present invention, allulose may be added to the milk product prior to and/or during fermentation, added to the fermented milk product, and/or added to a flavor preparation. It will often be preferred to add the allulose to the flavor preparation when a flavor preparation is used. In the case of certain yogurt drinks, it will often be preferred to add the allulose to the milk product during fermentation.

By way of example, yogurts according to the present invention may comprise allulose in an amount of from about 2% by weight to about 15% by weight relative to the total weight of the yogurt, for example in an amount of from about 2% by weight to about 15% by weight relative to the total weight of the yogurt, for example in an amount of from about 3% by weight to about 10% by weight relative to the total weight of the yogurt, for example in an amount of from about 4% by weight to about 9% by weight relative to the total weight of the yogurt, for example in an amount of about 2%, 5%, 7%, 10% or 15% by weight relative to the total weight of the yogurt.

According to one embodiment of the present invention, the amount of allulose in the yogurt is not 10% by weight relative to the total weight of the yogurt. According to certain embodiments, the yogurt does not contain fiber sol 2 in an amount of 3.0% by weight relative to the total weight of the yogurt. According to certain embodiments, the yogurt does not contain defatted milk powder in an amount of 9.0% by weight relative to the total weight of the yogurt.

According to another aspect, the present invention provides a snack bar comprising allulose in an amount of from about 5% by weight to about 25% by weight relative to the total weight of the bar. Any type of snack bar may be contemplated, but snack bars comprising cereals, nuts, seeds and/or fruits are preferred, i.e. any bar comprising one or more type of cereal and/or one or more type of nut and/or one or more type of seed and/or one or more type of fruit, particularly dried fruit. Cereal bars are preferred, that is bars comprising one or more type of cereal, optionally in combination with one or more type of nut and/or one or more type of seed and/or one or more type of fruit, or any other ingredient. Sports nutrition bars are also contemplated, including energy bars, recovery bars and the like.

The snack bars according to the present invention typically comprise solid components (food particulates) bound together by a binding syrup comprising allulose. Typically, the solid components may account for up to about 80% by weight of the bar, preferably up to about 70% or about 60% by weight of the bar, with the balance being binding syrup in each case (i.e. the binding syrup may account for up to about 20% by weight of the bar, or up to about 30% by weight of the bar, or up to about 40% by weight of the bar).

The solid components preferably comprise one or more type of cereal and/or one or more type of nut and/or one or more type of seed and/or one or more type of fruit, particularly dried fruit. Examples of cereals which may be contemplated are oats and rice (for example puffed rice).

The snack bar according to the present invention may include one or more ingredients selected from the group consisting of fats, oils, water, dairy products, gums, natural and/or artificial colors, natural and/or artificial flavors (such as vanilla), salt, chocolate and/or cocoa, coconut and coconut-derived products, spices, fruits and fruit-derived products, vegetables and vegetable-derived products, legumes and legume-derived products, nuts and nut-derived products, one or more starchy ingredients (such as described with reference to the sweet bakery products according to the present invention), acidulants, preservatives, stabilizers, antioxidants, proteins (including whey protein and the like), amino acids, vitamins, minerals, and any other ingredients suitable for inclusion in a snack bar.

In order to optimize certain physical properties of the snack bars according to the present invention, it may be desirable to make certain other adjustments to the conventional recipes, besides the complete or partial replacement of nutritive sweeteners (such as sucrose, high fructose corn syrup and the like) by allulose. For example, one or more cohesion promoters may be included in the snack bars according to the present invention, such as starches, dextrins, gums and/or maltodextrin. An example is tapioca dextrin. Where such cohesion promoters are included, they are preferably present in an amount of from about 0.5 to about 5% by weight relative to the total weight of the snack bar, for example about 0.5 to about 2% by weight relative to the total weight of the snack bar.

In the case of partial replacement of nutritive sweetener, the nutritive sweetener may be included in the binding syrup.

It has surprisingly been found that the incorporation of allulose in a snack bar retards hardening and can therefore extend the life of snack bars. In other words, it has surprisingly been found that allulose exhibits an anti-staling effect when used in snack bars.

By way of example snack bars (particularly cereal, nut, seed and/or fruit bars) according to the present invention may comprise allulose in an amount of from about 5% by weight to about 25% by weight relative to the total weight of the bar, for example in an amount of from about 10% by weight to about 22% by weight relative to the total weight of the bar, for example in an amount of from about 12% by weight to about 20% by weight relative to the total weight of the bar, for example in an amount of about 5%, 10%, 15%, 20% or 25% by weight relative to the total weight of the bar.

According to another aspect, the present invention provides a bread product comprising allulose in an amount of from about 2% by weight to about 15% by weight relative to the total weight of the uncooked product (e.g. uncooked bread dough). Any type of bread product may be contemplated, including leavened and unleavened breads, yeasted and unyeasted breads (such as soda breads), breads comprising any type of wheat flour, breads comprising any type of non-wheat flour (such as potato, rice and rye flours), gluten-free breads, and any other types of bread.

In addition to allulose, the bread product according to the present invention typically comprises one or more starchy ingredients, including all suitable types of flours (including bleached, unbleached and self-raising flours) and starches (including native and modified starches). The starchy ingredient may be derived from any suitable source including, but not limited to, wheat, rice, maize (corn), oat, rye, barley, tapioca, sago, amaranth, arrowroot, sorghum, pea, banana, potato and sweet potato. The source may be waxy or non-waxy.

The bread product according to the present invention may include one or more ingredients selected from the group consisting of leavening agents (such as yeast, bicarbonate of soda, baking soda, cream of tartar and the like), eggs or egg-derived products, fats, oils, water, milk and/or other dairy products, alcohol, gums, natural and/or artificial colors, natural and/or artificial flavors (such as vanilla), salt, chocolate and/or cocoa, coconut and coconut-derived products, spices, fruits and fruit-derived products, vegetables and vegetable-derived products, legumes and legume-derived products, nuts and nut-derived products, preservatives, stabilizers, antioxidants, emulsifiers, proteins, amino acids, vitamins, minerals, and any other ingredients suitable for inclusion in a bread product.

By way of example, bread products according to the present invention may comprise allulose in an amount of from about 2% by weight to about 15% by weight relative to the total weight of the uncooked product, for example in an amount of from about 5% by weight to about 12% by weight relative to the total weight of the uncooked product, for example in an amount of from about 8% by weight to about 11% by weight relative to the total weight of the uncooked product, for example in an amount of about 2%, 5%, 7%, 10% 12%, or 15%, by weight relative to the total weight of the uncooked product.

In order to optimize certain physical properties of the bread products according to the present invention, it may be desirable to make certain other adjustments to the conventional recipes, besides the complete or partial replacement of nutritive sweeteners (such as sucrose, high fructose corn syrup and the like) by allulose. Physical properties which it may be desired to optimize include crumb structure, level of browning, moisture retention (humectancy), and the like.

It has been found that the above physical properties can be effectively controlled by adjusting the relative amounts of ingredients, and especially the ratio of leavening agent, water, salt, oil and/or fats, flour and/or other starchy ingredients and emulsifier. Careful control of baking conditions may also be used to influence the physical properties of the bread product according to the present invention.

It has surprisingly been found that bread products according to the present invention have better storage characteristics than conventional bread products, and particularly compared to conventional bread products comprising high fructose corn syrup. It appears that allulose retards the degradation of bread products. In other words, the inclusion of allulose in bread products has an anti-staling effect on the products and prolongs their life.

According to another aspect, the present invention provides a pre-made bread mix for preparing a bread product, wherein the pre-made bread mix comprises allulose in an amount sufficient to provide from about 2% by weight to about 15% by weight of allulose in the uncooked bread product. For example, the pre-made bread mix may comprise allulose in an amount of from about 3% by weight to about 25% by weight relative to the total weight of the pre-made bread mix.

The pre-made bread mix for preparing a bread product is a pre-made mix for use in preparing a bread product according to the present invention. Accordingly, the pre-made bread mix may comprise any combination of the ingredients discussed above with respect to the bread product. The description relating to the bread product of the present invention therefore applies mutatis mutandis.

Generally, the pre-made bread mix will comprise only the ‘dry’ ingredients required for preparing the bread product. Thus, the pre-made mix will typically not contain ‘wet’ ingredients such as eggs or egg-derived products, fats, oils, water, milk and/or other dairy products, or other ‘wet’ ingredients. Dried forms of such ingredients (e.g. dried egg or milk products) may be included, and oils and/or fats may also be included according to some embodiments. Anti-caking agents may also be advantageously incorporated in the pre-made bread mixes of the present invention.

By way of example, pre-made bread mixes according to the present invention may comprise allulose in an amount of from about 3% by weight to about 25% by weight relative to the total weight of the pre-made bread mix, for example in an amount of from about 8% by weight to about 20% by weight relative to the total weight of the pre-made bread mix, for example in an amount of from about 13% by weight to about 18% by weight relative to the total weight of the pre-made bread mix, for example in an amount of about 3%, 5%, 7%, 10% 12%, 15%, 20% or 25% by weight relative to the total weight of the pre-made bread mix.

According to another aspect, the present invention provides a sauce or dressing comprising allulose in an amount of from about 2% by weight to about 80% by weight relative to the total weight of the sauce or dressing.

In addition to allulose, the sauce or dressing according to the present invention preferably comprises at least one acidic ingredient, especially in the case of a dressing. The sauce or dressing preferably also comprises water, preferably in an amount of from about 5% by weight of the sauce or dressing to about 80% by weight of the sauce or dressing. The water can be added as pure water or as a fruit and/or vegetable juice, for example.

The acidic ingredient may be based on organic and/or inorganic acids and may be one or more selected from the group consisting of acetic acid, citric acid, phosphoric acid, lactic acid, malic acid, fumaric acid, ascorbic acid, tartaric acid and hydrochloric acid, as well as any other acidic ingredients suitable for inclusion in a sauce or dressing. The acidic ingredient can be added to the sauce or dressing in the form of a solid and/or in solution. In certain embodiments, the acidic ingredient is provided in the form of vinegar, fruit (whole, in pieces, minced, crushed, as a paste or puree, as juice, as a concentrate, as a sauce, as an extract, or in any other suitable form) and/or vegetables (whole, in pieces, minced, crushed, as a paste or puree, as juice, as a concentrate, as a sauce, as an extract, or in any other suitable form).

The sauce or dressing according to the present invention may include one or more ingredients selected from the group consisting of eggs or egg-derived products, fats, oils, water, milk and/or other dairy products, alcohol, gums, natural and/or artificial colors, natural and/or artificial flavors, salt, spices, fruits and fruit-derived products, vegetables and vegetable-derived products, legumes and legume-derived products, nuts and nut-derived products, preservatives, stabilizers, antioxidants, emulsifiers, proteins, amino acids, vitamins, minerals, and any other ingredients suitable for inclusion in a sauce or dressing.

By way of example, the sauce or dressing according to the present invention may comprise allulose in an amount of from about 2% by weight to about 80% by weight relative to the total weight of the sauce or dressing, for example in an amount of from about 2% by weight to about 60% by weight relative to the total weight of the sauce or dressing, for example in an amount of from about 2% by weight to about 50% by weight relative to the total weight of the sauce or dressing, for example in an amount of from about 5% by weight to about 40% by weight relative to the total weight of the sauce or dressing, for example in an amount of about 2%, 5%, 10%, 15%, 20%, 30%, 40%, 50%, 60%, 70% or 80% by weight relative to the total weight of the sauce or dressing.

An advantage of the sauce or dressing according to the present invention is that sucrose can be unstable under acidic conditions. Complete or partial replacement of sucrose by allulose helps to address this issue.

By way of example, a dressing according to the present invention may comprise the following ingredients:

| INGREDIENT | Amount, wt % (as is) |
|---|---|
| Water | 5-80 |
| Sucrose | 0-40 |
| Allulose, 77DS | 5-80 |
| Vinegar, 120 grain | 2-7 |
| Stabilizer | 0-10 |
| Spices | 0.1-10 |
| Citric acid, anhydrous | 0.05-0.2 |
| Sucralose, 25% liquid concentrate | 0-0.3 |
| TOTAL | 100 |

According to another aspect, the present invention provides a sweet spread comprising allulose in an amount of from about 3% by weight to about 75% by weight relative to the total weight of the uncooked sweet spread. Sweet spreads which may be contemplated include, but are not limited to, jellies, jams, butters and other spreadable preserves, conserves and the like. Fruit-based jellies, jams, butters, preserves, conserves and the like are particularly preferred. Chocolate spreads and nut-based spreads (including, but not limited to, peanut spreads) are also contemplated.

In the case of fruit-based sweet spreads, the sweet spread preferably comprises allulose and at least one fruit-based ingredient (such as fruit in whole form, in pieces, minced, crushed, as a paste or puree, as juice, as a concentrate, as a sauce, as an extract, or in any other suitable form). The fruit-based sweet spread preferably also comprises at least one texture modifying agent.

The sweet spreads according to the present invention may comprise a texture modifying agent. The texture modifying agent can thicken and/or gel the spread. In the case of fruit-based spreads, the texture modifying agent may be naturally present in the at least one fruit-based ingredient (e.g. pectin). Alternatively or additionally, a texture modifying agent may be added to the spread separately. Suitable texture modifying agents include, but are not limited to, pectin, gums, starches, and the like.

The sweet spreads according to the present invention may include one or more ingredients selected from the group consisting of eggs or egg-derived products, fats, oils, water, milk and/or other dairy products, alcohol, gums, natural and/or artificial colors, natural and/or artificial flavors, salt, spices, fruits and fruit-derived products, vegetables and vegetable-derived products, legumes and legume-derived products, nuts and nut-derived products, preservatives, stabilizers, antioxidants, emulsifiers, proteins, amino acids, vitamins, minerals, acidulants, antifoaming agents and any other ingredients suitable for inclusion in a sweet spread.

An advantage of the sweet spread according to the present invention is that sucrose can be unstable under acidic conditions. Complete or partial replacement of sucrose by allulose helps to address this issue.

By way of example, the sweet spreads according to the present invention may comprise allulose in an amount of from about 3% by weight to about 75% by weight relative to the total weight of the uncooked sweet spread, for example in an amount of from about 3% by weight to about 60% by weight relative to the total weight of the uncooked sweet spread, for example in an amount of from about 3% by weight to about 50% by weight relative to the total weight of the uncooked sweet spread, for example in an amount of about 3%, 5%, 10%, 15%, 20%, 30%, 40%, 50%, 60%, 70% or 75% by weight relative to the total weight of the uncooked sweet spread.

By way of example, a strawberry jam according to the present invention may comprise the following ingredients:

| INGREDIENT | Amount, wt % (as is) |
|---|---|
| Strawberries, puree | 35-65 |
| sugar | 0-40 |
| Allulose, 77DS | 5-60 |
| Water | 0-15 |
| Low methoxyl pectin | 0-2 |
| Sucralose, 25% | 0.01-0.5 |
| Gum | 0-0.5 |
| Flavor | 0-1 |
| Acidulant | 0-1 |
| Potassium sorbate | 0.05-0.3 |
| Color 10% solution | 0-0.5 |
| Calcium chloride | 0-0.1 |
| Total | 100 |

The present invention also provides the use of allulose in confections, glazes, toppings, frostings and icings. As may be readily appreciated by those skilled in the art, such confections, glazes, toppings, frostings and icings are essentially analogous to sweet spreads in terms of basic composition. Accordingly, references in the present application to sweet spreads apply mutatis mutandis to confections, glazes, toppings, frostings and icings.

According to another aspect, the present invention provides a confectionary product comprising allulose in an amount of from about 1% by weight to about 70% by weight relative to the total weight of the uncooked confectionary product. Confectionary products which may be contemplated include, but are not limited to, jelly candies, soft candies (such as non-chocolate candies, plain chocolate candies such as chocolate bars and chocolate coated candies), hard candies (including pressed candy mints), chocolate and gums (such as chewing gums and the like). The terms “chocolate” or “chocolates” as used herein are intended to refer to all chocolate or chocolate-like compositions that contain at least one cocoa or cocoa-like component. The terms are intended, for example, to include standardized and non-standardized chocolates, i.e., including chocolates with compositions conforming to the U.S. Standards Of Identity (SOI) and compositions not conforming to the U.S. Standards Of Identity, respectively, including dark chocolate, baking chocolate, milk chocolate, sweet chocolate, semi-sweet chocolate, buttermilk chocolate, skim-milk chocolate, mixed dairy product chocolate, low fat chocolate, white chocolate, non-standardized chocolates, compound chocolate and chocolate-like compositions, unless specifically identified otherwise.

Confectionary products according to the present invention may comprise one or more texturizers. Suitable texturizers can be derived from either animal or plant sources, and include, but are not limited to starches, polysaccharides, gelatin, pectin and the like. Generally, a texturizer may be included in an amount of from about 0.1% by weight to about 20% by weight based on the total weight of the uncooked confectionary product. In the case of jelly candies (gummies), gelatin is a particularly preferred texturizer.

It has been found that confectionary products (such as jelly candies/gummies) comprising allulose can tend to have a slightly softer texture than the equivalent conventional products comprising nutritive sweeteners such as sucrose and/or corn syrup. If desired, this can be compensated for by increasing the amount of texturizer (such as gelatin).

The confectionary products according to the present invention may include one or more ingredients selected from the group consisting of bulking agents, fats, oils, water, milk and/or other dairy products, alcohol, gums, natural and/or artificial colors, natural and/or artificial flavors, salt, spices, fruits and fruit-derived products, vegetables and vegetable-derived products, legumes and legume-derived products, nuts and nut-derived products, preservatives, stabilizers, antioxidants, emulsifiers, proteins, amino acids, vitamins, minerals, acidulants, and any other ingredients suitable for inclusion in a confectionary product.

An advantage of the confectionary products according to the present invention is that sucrose can be unstable at high temperatures and can tend to crystalize. Complete or partial replacement of sucrose by allulose helps to address this issue. Thus, the present invention is particularly beneficial in the case of confectionary products produced under high temperature conditions (jellies, hard candies and gums, and especially hard candies).

It is generally considered to be desirable for confectionary products such as jellies, hard candies and gums to have a high level of clarity. It has been found that confectionary products according to the present invention can be produced with excellent clarity.

It has also been found that certain properties of confectionary products comprising allulose can be improved by the incorporation of a bulking agent. In particular, it has been found that the incorporation of a bulking agent can improve storage properties (e.g. by preventing crystallization) as well as certain textural properties such as chewiness and sensory properties such as sweetness profile. The incorporation of a bulking agent has been found to be particularly advantageous in the case of jellies (gummies), for example gelatin-based jellies.

Suitable bulking agents for use in the confectionary products of the present invention include polydextrose, soluble corn fiber (SCF), maltodextrin, a polyol, and the like. Bulking agents may be incorporated in the confectionary products according to the present invention in a weight ratio to allulose (dry solids basis) of up to about 2:1 (i.e. two parts bulking agent to one part allulose). Preferred ratios include 1.75:1, 1.5:1, 1.25:1, 1.2:1, 1.1:1, 1:1, 0.9:1, 0.8:1, 0.75:1, 0.5:1 and 0.25:1. All intermediate ratios are also explicitly contemplated, and other ratios may be contemplated depending on the specific confectionary product.

By way of example, the confectionary products according to the present invention may comprise allulose in an amount of from about 1% by weight to about 70% by weight relative to the total weight of the uncooked confectionary product, for example in an amount of from about 10% by weight to about 50% by weight relative to the total weight of the uncooked confectionary product, for example in an amount of about 1%, 3%, 5%, 10%, 15%, 20%, 30%, 40%, 50%, 60% or 70% by weight relative to the total weight of the uncooked confectionary product.

By way of example, a jelly candy according to the present invention may comprise the following ingredients:

| INGREDIENT | Amount, wt % (as is) |
|---|---|
| HFCS 55 77DS | 0-70 |
| Crystalline fructose | 0-20 |
| Allulose, 77DS | 2-70 |
| Sucralose, 25% liquid | 0-0.4 |
| Modified starch | 0.1-20 |
| Malic acid | 0.1-2 |
| Pectin | 0-2 |
| Color | 0-2 |
| Flavor | 0.01-7 |
| Total | 100 |

A preferred embodiment of a jelly candy (gummy) according to the present invention comprises allulose, corn syrup, sucrose, water and gelatin. A preferred allulose content is 15% by weight to 25% by weight based on the total weight of the uncooked formula, preferably about 20-21% by weight based on the total weight of the uncooked formula. This incorporation amount of allulose corresponds approximately to 25% by weight on an “as consumed” basis. The preferred contents of corn syrup (ds basis) and sucrose are 25% by weight to 35% by weight (preferably about 31 or 32% by weight) and 10% by weight to 17% by weight (preferably about 13% by weight) respectively, based on the total weight of the uncooked formula. A preferred gelatin content (ds basis) is around 6-7% by weight, preferably about 6.5% by weight, based on the total weight of the uncooked formula.

The confectionary products according to the present invention, or any other confectionary product, may be coated with a coating comprising allulose. Suitable coatings and coating techniques include those described below with reference to cereals, and the present disclosure relating to cereal coatings applies mutatis mutandis to coatings for confectionary products.

According to another aspect, the present invention provides a sweetened breakfast cereal comprising from about 1% by weight to about 50% by weight of allulose based on the total weight of the sweetened breakfast cereal. Any type of breakfast cereal may be contemplated, including, but not limited to, extruded (kix type) breakfast cereals, flaked breakfast cereals and puffed breakfast cereals.

The sweetened breakfast cereal according to the present invention is preferably a coated breakfast cereal, i.e. a breakfast cereal coated with a cereal coating composition comprising allulose.

Coated cereals generally fall into one of the following categories: 1) Clear glazed; 2) Topically sweet seasoned; or 3) Frosted. Each of these categories may be contemplated in the context of the present invention. Clear glazed coated cereals and topically sweet seasoned cereals are preferred.

Clear glazed coated breakfast cereals are typically prepared by applying a sweetener solution to the cereal and drying. Topically sweet seasoned cereals are typically prepared by preparing a dry sweetener mix and then applying the dry sweetener mix to the cereal, generally with the aid of an adhesion promoter (e.g. oil).

The cereal coating compositions of the present invention comprise allulose in an amount of from about 5% by weight to about 80% by weight of allulose based on the total weight of the cereal coating composition (before coating and drying). Once coated onto the breakfast cereal and after drying, allulose may comprise up to 100% of the coating (e.g. where the coating composition consists of allulose and water).

According to an embodiment, the cereal coating composition of the present invention preferably comprises water (for example in an amount of from about 0.5% by weight to about 40% by weight based on the total weight of the cereal coating composition before coating and drying) and at least one bulking agent (for example in an amount of from about 0.1% by weight to about 80% by weight based on the total weight of the cereal coating composition before coating and drying).

The bulking agent for use in the cereal coating composition of the present invention may be soluble corn fiber (SCF), maltodextrin, polydextrose, a polyol or the like.

Other ingredients which may be included in the cereal coating composition include, but are not limited to, fats/oils, starches, salt, natural or artificial flavorings, natural or artificial colorings, fiber, spices, fruits, nuts and the like.

By way of example, the cereal coating composition according to the present invention may comprise allulose in an amount of from about 5% by weight to about 80% by weight relative to the total weight of the cereal coating composition, for example in an amount of from about 5% by weight to about 60% by weight relative to the total weight of the cereal coating composition, for example in an amount of from about 20% by weight to about 40% by weight relative to the total weight of the cereal coating composition, for example in an amount of about 5%, 10%, 15%, 20%, 30%, 40%, 50%, 60%, 70% or 80% by weight relative to the total weight of the cereal coating composition. All content amounts refer to the cereal coating composition before coating and drying.

By way of example, a cereal coating composition according to the present invention may comprise the following ingredients:

| INGREDIENT | Amount, wt. % (as is) |
|---|---|
| Sucrose | 0-75 |
| Allulose | 5-60 |
| Water | 5-40 |
| Oil | 0-5 |
| Fructose | 0-50 |
| Soluble Corn Fiber | 0-20 |
| Starch | 0-20 |
| Sucralose | 0-0.06 |
| Stevia Extract | 0-0.2 |
| Salt | 0-4 |
| TOTAL | 100 |

With specific reference to the clear glazed cereal coating compositions of the present invention, the coating composition may consist of allulose and water. Alternatively, other components (such as described above) may be included. As discussed further below, one or more nutritive sweetener and/or one or more co-sweetener may also be included.

An example of a clear glazed cereal coating composition according to the present invention comprises allulose in an amount of from 20% by weight to 40% by weight (preferably about 30% by weight), sucrose in an amount of from 30% by weight to 50% by weight (preferably about 40% by weight), corn syrup in an amount (DS basis) of from 15% by weight to 35% by weight (preferably about 25% by weight), and the balance water, relative to the total weight of the coating composition.

Advantageously, clear glazed cereal coatings of the present invention dry to a clearer and shinier finish compared to conventional coatings.

With specific reference to the topically sweet seasoned coating compositions of the present invention, the coating composition preferably comprises allulose and at least one of the bulking agents defined above (such as maltodextrin).

An example of a topically sweet seasoned coating composition according to the present invention comprises allulose in an amount of from 35% by weight to 45% by weight (preferably about 40% by weight), sucrose in an amount of from 35% by weight to 45% by weight (preferably about 40% by weight), and a bulking agent (such as maltodextrin) in an amount of from 15% by weight to 21% by weight (preferably about 18% by weight), based on the total weight of the seasoning composition. Other ingredients such as already described above (spices, salt and the like) may also be included. As discussed further below, one or more nutritive sweetener and/or one or more co-sweetener may also be included. For example, a high intensity sweetener may be included as a co-sweetener.

An adhesion promoter is typically required to aid adhesion of topically sweet seasoned coating compositions to cereals. A number of food-safe materials may be contemplated in this regard. An example of a suitable adhesion promoter is an oil, such as canola oil.

The above description in relation to the cereal coating composition of the present invention applies mutatis mutandis to the sweetened breakfast cereal, i.e. all of the ingredients mentioned with reference to the cereal coating composition may also be present in the sweetened breakfast cereal. Typical allulose contents in the coated breakfast cereals of the present invention are from 3% by weight to 15% by weight, for example from about 5% by weight to about 11% by weight, for example 3%, 4%, 5%, 6%, 7%, 8%, 9%, 10%, 11%, 12%, 13%, 14% or 15% by weight, relative to the total weight of the coated cereal.

The preferred embodiments set out below relate to the food and beverage products according to all aspects of the present invention.

According to preferred embodiments, allulose replaces all or part of the nutritive sweetener as a single ingredient. In other words, any amount of nutritive sweetener replaced in the food or beverage product is replaced by allulose alone, and no other ingredients conventionally added in combination with low or zero calorie sweeteners are added (for example, bulking agents, temporal profile modifiers, flavor enhancers and the like).

According to the above, bulking agents conventionally used with sweeteners (such as maltodextrin or other non-sweet saccharide polymers) are preferably not added to the food or beverage products in the context of replacing all or part of the nutritive sweetener present in the equivalent conventional product. According to preferred embodiments, the food or beverage product does not contain such a bulking agent, for example does not contain maltodextrin, polydextrose, xanthan gum, guar gum, soluble corn fiber (SCF), polyols, and the like.

Since allulose may be used to replace only part of the nutritive sweetener present in the equivalent conventional product, it will be appreciated that the food or beverage product may also comprise one or more nutritive sweetener (such as, for example, one or more of sucrose, glucose, glucose syrup, isoglucose, fructose, glucose-fructose syrup, maltose, lactose, corn syrup, high fructose corn syrup, invert sugar, molasses, honey and agave). However, in certain preferred embodiments, the food or beverage product does not contain a nutritive sweetener.

It is preferred that the food or beverage product does not contain any other sweetener other than allulose and, optionally, one or more nutritive sweetener. In particular, it is preferred that the food or beverage product does not contain any other low or zero calorie sweetener other than allulose. In particular, it is preferred that the food or beverage product does not contain any high intensity sweetener (either natural or artificial) and/or does not contain any sugar alcohol. However, in certain embodiments, it may be desirable to include such another sweetener. Thus, the food or beverage product may contain one or more natural or artificial co-sweeteners, for example one or more natural or artificial high intensity sweetener or one or more sugar alcohol.

One circumstance where it may be desirable or necessary to include one or more co-sweetener is where regulatory restrictions prescribe a maximum amount of allulose to be used in a particular type of food or beverage. An example of such regulatory restrictions is the GRAS (Generally Recognized as Safe) regime prescribed by the Food and Drug Administration (FDA) in the United States. Where regulatory restrictions of this type apply, allulose may be used up to its maximum allowable usage amount, and one or more co-sweetener may be used to provide any additional sweetness required.

Various natural high intensity sweeteners may be used as the one or more co-sweetener of the present invention. Specific examples include monk fruit extracts and stevia extracts, as well as any sweet compounds isolated from such extracts (including synthetic equivalents of such compounds).

Monk fruit is the fruit of the siraitia grosvenorii vine, also known as luo han guo. The sweet taste of monk fruit extracts is mainly attributed to a family of compounds known as ‘mogrosides’, examples of which include mogroside V, mogroside IV, mogroside VI, oxomogroside V, mogroside IIIE, neomogroside and siamenoside I. Monk fruit extracts, as well as sweeteners comprising any one or more mogroside, may be used as the one or more co-sweetener of the present invention. Extracts or sweeteners comprising mogroside V are particularly preferred.

Stevia, or stevia rebaudiana, contains sweet compounds in its leaves. These compounds may be extracted to provide stevia extracts. The sweet taste of stevia extracts is mainly attributed to a family of compounds known as ‘steviol glycosides’, examples of which include rebaudiosides (i.e., rebaudioside A to F, M, N and X), rubusoside, stevioside, and dulcosides. Stevia extracts, as well as sweeteners comprising any one or more steviol glycoside, may be used as the one or more co-sweetener of the present invention. Extracts or sweeteners comprising rebaudioside A (Reb A) are particularly preferred. Blends or mixtures of individual steviol glycosides which have been individually isolated, produced and/or purified may also be used to advantage.

Other suitable natural high intensity sweeteners useful as the one or more co-sweetener of the present invention include, but are not limited to, brazzein, thaumatin, monellin, monatin and its salts, and glycyrrhizic acid and its salts.

Various synthetic high potency sweeteners may also be used as the one or more co-sweetener of the present invention. Specific examples include sucralose, aspartame and acesulfame potassium (Ace K).

Various sugar alcohols may also be used as the one or more co-sweetener of the present invention. Specific examples include maltitol, xylitol and erythritol.

Other rare or synthetic sugars may also be contemplated for use as the one or more co-sweetener of the present invention. Allose, mannose, sorbose, altrose, maltose and tagatose may be mentioned in this regard.

In certain preferred embodiments, the food or beverage product does not contain an isomerized high fructose corn syrup (HFCS), i.e. a high fructose corn syrup in which at least part of the fructose has been isomerized to allulose.

When cooking at home, home cooks will often be following a recipe which calls for sugar (i.e. sucrose, or table sugar). As has already been described, allulose represents an excellent alternative to sugar in many food and beverage applications, and this applies to food and beverage products prepared as well as manufactured products.

From a practical point of view, it is convenient for a home cook to be able to replace the sugar in any given recipe with allulose without having to calculate how much allulose is required. Thus, according to a further aspect, the present invention provides a scoop-for-scoop sweetener comprising allulose, which can be used to replace sucrose on an equivalent volume basis (i.e. one scoop of the sweetener comprising allulose can be used to replace one scoop of sugar).

The scoop-for-scoop sweetener according to the present invention comprises allulose, at least one bulking agent, and at least one high intensity sweetener.

By way of example, the scoop-for-scoop sweetener according to the present invention may comprise allulose in an amount of from about 5% by weight to about 95% by weight relative to the total weight of the scoop-for-scoop sweetener, for example in an amount of from about 20% to about 95% by weight relative to the total weight of the scoop-for-scoop sweetener, for example from about 25% to about 90% by weight relative to the total weight of the scoop-for-scoop sweetener, for example about 5%, 10%, 15%, 20%, 25%, 30%, 35%, 40%, 45%, 50%, 55%, 60%, 65%, 70%, 75%, 80%, 85%, 90% or 95% by weight relative to the total weight of the scoop-for-scoop sweetener.

The at least one high intensity sweetener included in the scoop-for-scoop sweetener may be any one or more of the high intensity sweeteners already described above. The amount of high intensity sweetener should generally be the amount required to provide the scoop-for-scoop sweetener with an equivalent sweetness per unit volume to that of sucrose.

The at least one bulking agent of the scoop-for-scoop sweetener may be any suitable bulking agent known to those skilled in the art. Examples of bulking agents which may be contemplated include maltodextrin, polydextrose, gums (such as xanthan gum or guar gum), soluble corn fiber (SCF), starches and polyols. Maltodextrin, polydextrose and SCF, as well as any mixtures of these, are particularly preferred bulking agents. The amount of the at least one bulking agent will depend on the bulk density in each case, as well as the amounts of allulose and the at least one high intensity sweetener.

According to certain embodiments, a nutritive sweetener may be used as the at least one bulking agent, or as one of the at least one bulking agents. For example, sucrose, fructose and/or dextrose may be used in this regard. It will be appreciated, however, that the use of a nutritive sweetener will result in the scoop-for-scoop sweetener having a higher caloric content.

Other ingredients may be included in the scoop-for-scoop sweetener if required. Such other ingredients may be one or more selected from the group consisting of anti-caking agents, natural and/or artificial flavors, natural and/or artificial colors, acidulants, vitamins, preservatives, antioxidants and any other ingredients suitable for inclusion in a scoop-for-scoop sweetener.

A particularly convenient application of the scoop-for-scoop sweetener of the present invention is in home baking.

Although the scoop-for-scoop sweetener of the present invention has been described primarily with the home cook in mind, the scoop-for-scoop sweetener may also provide benefits in mass-catering and in food and beverage manufacture.

In addition to scoop-for-scoop products, there is also demand among end users for table-top sweeteners that can be used in place of sugar or other nutritive sweeteners. In the case of table-top products, there is no need for the sweetness to be equivalent to that of sucrose on a volume basis; instead, table-top sweeteners are simply supplied with dosage guidelines, often with reference to a teaspoon (5 mL) of sugar. The most common use for table-top products is to sweeten beverages, typically hot beverages such as tea and coffee.

With the above in mind, the present invention also provides a table-top sweetener comprising allulose.

The table-top sweetener of the present invention preferably comprises allulose and at least one other natural or synthetic sweetener. The at least one natural or synthetic sweetener may be any of the nutritive sweeteners described above and/or any of the natural and/or synthetic high intensity sweeteners described above and/or any of the sugar alcohols described above and/or any of the rare or synthetic sugars described above.

The table-top sweeteners of the present invention may optionally include one or more further ingredients selected from the group consisting of bulking agents (such as maltodextrin, polydextrose, gums—such as xanthan gum or guar gum, soluble corn fiber (SCF), starches and polyols), natural and/or artificial flavors, natural and/or artificial colors, fiber, acidulants, vitamins, antioxidants, preservatives, starch hydrolysates and the like.

According to an embodiment, the table-top sweetener is a dry table-top sweetener. For example, it may take the form of tablets, granules or a powder. Liquid table-top sweeteners may also be contemplated, and typically take the form of an aqueous solution of the components.

In the case of dry table-top sweeteners, it is generally preferred that the at least one other natural or synthetic sweetener include at least one natural and/or synthetic high intensity sweetener. Preferred examples include sucralose.

According to an embodiment, the dry table-top sweetener of the present invention comprises allulose in an amount of from about 97.5% to about 99.8% by weight relative to the total weight of allulose and at least one other natural or synthetic sweetener in the table-top sweetener, for example from about 98.5% to about 99.7% by weight relative to the total weight of allulose and at least one other natural or synthetic sweetener in the table-top sweetener, for example from about 99.0% to about 99.6% by weight relative to the total weight of allulose and at least one other natural or synthetic sweetener in the table-top sweetener.

According to another embodiment, the dry table-top sweetener of the present invention comprises allulose in an amount of from about 99.25% to about 99.75% and sucralose in an amount of from about 0.25% to about 0.75% by weight based on the total weight of allulose and sucralose in the table-top sweetener. For example, the dry table-top sweetener may comprise allulose in an amount of about 99.5% and sucralose in an amount of about 0.5%.

According to an embodiment, the dry table-top sweetener further comprises one or more nutritive sweetener. The nutritive sweetener may be selected from the group consisting of sucrose, glucose, glucose syrup, isoglucose, fructose, glucose-fructose syrup, maltose, lactose, corn syrup, high fructose corn syrup, invert sugar, molasses, honey, agave, and mixtures thereof. The nutritive sweetener is sucrose in one preferred embodiment. Where the table-top product includes a nutritive sweetener, said nutritive sweetener may be present in an amount of up to about 30% by weight based on the total weight of the table-top sweetener. For example, the nutritive sweetener may be present in an amount of about 26% by weight based on the total weight of the table-top sweetener.

Dry table-top sweeteners of the present invention are preferably packaged in a packaging that limits or prevents moisture absorption. Packaging lined with aluminium foil is a suitable choice in this regard.

In the case of liquid table-top sweeteners, the preferred composition will depend upon the intended dosage amount. Some liquid table-top sweeteners are formulated such that only a very small amount (e.g. a few drops or around 0.15 g) is required in typical applications (e.g. to sweeten a hot beverage), while other formulations are such that one or two teaspoons are required.

In the case of liquid table-top sweeteners that are formulated to be dosed in small amounts, it is generally necessary to include a relatively high concentration of natural or synthetic high intensity sweetener in the table-top composition in order to deliver the required level of sweetness per unit volume. Liquid table-top sweeteners of this type may typically comprise allulose in an amount of from about 25% to about 85% by weight (for example from about 25% to about 35%, or from about 75% to about 85% by weight) relative to the total weight of allulose and at least one other natural or synthetic sweetener in the table-top sweetener. The at least one other natural or synthetic sweetener is therefore typically present in an amount of from about 15% to about 75% by weight (for example from about 65% to about 75%, or from about 15% to about 25% by weight) relative to the total weight of allulose and at least one other natural or synthetic sweetener in the table-top sweetener. As already noted, the at least one other natural or synthetic sweetener is preferably at least one natural or synthetic high intensity sweetener. A preferred high intensity sweetener is sucralose.

In the case of liquid table-top sweeteners that are formulated to be dosed in larger amounts, a relatively lower proportion of natural or synthetic high intensity sweetener can be used. Accordingly, for liquid table-top sweeteners of this type, it is generally preferred that allulose be present in an amount of from about 85% to less than 100% by weight relative to the total weight of allulose and at least one other natural or synthetic sweetener in the table-top sweetener. For example, allulose may be present in an amount of from about 95% to less than 100% by weight, or from about 95% to about 99.95% by weight, relative to the total weight of allulose and at least one other natural or synthetic sweetener in the table-top sweetener. The at least one other natural or synthetic sweetener is therefore typically present in an amount of up to about 15% (for example up to about 5%, or from about 0.05% to about 5% by weight) relative to the total weight of allulose and at least one other natural or synthetic sweetener in the table-top sweetener. According to certain preferred embodiments, the at least one other natural or synthetic sweetener is at least one natural or synthetic high intensity sweetener. A preferred high intensity sweetener is sucralose.

The liquid table-top sweeteners of the present invention are typically provided as aqueous solutions. The amount of water present in the table-top sweeteners depends on the intended dosage amount and on the relative amounts of allulose and at least one other natural or synthetic sweetener. Effectively, the amount of water used in any given case will be the amount required to give a sweetness per unit volume that corresponds to the intended dosage amount. In general terms, the amount of water may be from about 20% by weight to about 97% by weight relative to the total weight of the liquid table-top sweetener.

In the case of liquid table-top sweeteners, it is generally preferred to include a preservative. Potassium sorbate is an example of a suitable preservative. The required amount of preservative will generally be determined based on the preservative and the manufacturer's advice. Typical amounts may be from about 0.05% to about 0.15% by weight, for example in an amount of about 0.1% by weight, relative to the total weight of the liquid table-top sweetener.

Some example compositions for liquid table-top products are provided below by way of illustration (with amounts in weight % relative to the total weight of the liquid table-top sweetener):

| | | High intensity | Preservative | |
|---|---|---|---|---|
| | | sweetener (e.g. | (e.g. potassium | |
| | Allulose | sucralose) | sorbate) | Water |
| Type | (wt %) | (wt %) | (wt %) | (wt %) |
| Low dose | 2.5 to 5 | 9 to 10 | 0.05 to 0.15 | 84.85 to 88.45 |
| (e.g. 0.15 | | | | |
| g) | | | | |
| Low dose | 3.81 | 9.42 | 0.1 | 86.67 |
| (e.g. 0.15 | | | | |
| g) | | | | |
| Low dose | 45 to 50 | 9 to 10 | 0.05 to 0.15 | 39.85 to 45.95 |
| (e.g. 0.15 | | | | |
| g) | | | | |
| Low dose | 47.73 | 9.34 | 0.1 | 42.83 |
| (e.g. 0.15 | | | | |
| g) | | | | |
| High dose | 2.5 to 5 | 0.1 to 0.15 | 0.05 to 0.15 | 94.7 to 97.35 |
| (e.g. 10 g) | | | | |
| High dose | 3.81 | 0.137 | 0.1 | 95.953 |
| (e.g. 10 g) | | | | |
| High dose | 70 to 80 | 0.04 to 0.07 | 0.05 to 0.15 | 19.78 to 29.91 |
| (e.g. 10 g) | | | | |
| High dose | 75.44 | 0.054 | 0.1 | 24.508 |
| (e.g. 10 g) | | | | |

As has already been discussed above, there are certain circumstances under which a food or beverage manufacturer may wish to supplement allulose with other ingredients when looking to replace one or more nutritive sweeteners in a food or beverage composition. One such circumstance may be where regulatory requirements do not permit replacement of the full amount of nutritive sweetener with allulose. Another circumstance may be where a manufacturer is looking to modify or further optimize certain functional properties of a food and beverage composition.

In cases where it is desired to use allulose in combination with other ingredients, it may be inconvenient for a food or beverage manufacturer to have to source and employ each ingredient separately. Thus, according to a further aspect, the present invention provides a sweetener system comprising allulose, at least one bulking agent, and preferably at least one high intensity sweetener. The sweetener system according to the present invention can be used by food and beverage manufacturers, as a single ingredient, to replace one or more nutritive sweeteners in a food or beverage composition.

In addition to the fact that it allows a food or beverage manufacturer to avoid the need to source and employ separate ingredients, the sweetener system of the present invention also has the advantage of being highly customizable. Thus, the composition of the sweetener system can easily be adapted to suit the requirements of any given manufacturer according to the target application.

In the following description of the sweetener system of the present invention, all content amounts are indicated on a dry solids basis. Thus, references to “the total weight of the sweetener system” refer to the total weight of dry solids in the sweetener system, and references to the weight of any given component refer to the dry solids weight of that component.

By way of example, the sweetener system according to the present invention may comprise allulose in an amount of from about 5% by weight to about 95% by weight relative to the total weight of the sweetener system, for example in an amount of from about 15% to about 80% by weight relative to the total weight of the sweetener system, for example from about 20% to about 50% by weight relative to the total weight of the sweetener system, for example about 5%, 10%, 15%, 20%, 25%, 30%, 35%, 40%, 45%, 50%, 55%, 60%, 65%, 70%, 75%, 80%, 85%, 90% or 95% by weight relative to the total weight of the sweetener system. An amount of allulose of from about 20% to about 50% by weight relative to the total weight of the sweetener system will often be particularly convenient, for example an amount of 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% or 50% by weight relative to the total weight of the sweetener system.

The at least one high intensity sweetener included in the sweetener system may be any one or more of the high intensity sweeteners already described above. Among those, particularly preferred high intensity sweeteners for use in the sweetener system according to the present invention include natural high intensity sweeteners (such as stevia extracts and monk fruit extracts), and sucralose. A combination of stevia and monk fruit extracts may be used as the at least one high intensity sweetener in certain preferred embodiments.

The amount of high intensity sweetener can be varied according to the target application and the potency of the high intensity sweetener used. It will often be convenient for the at least one high intensity sweetener to be provided in an amount such that the sweetener system is able to provide an equivalent sweetness per unit volume to that of the one or more nutritive sweeteners being replaced.

In embodiments where a combination of stevia and monk fruit extracts is used as the at least one high intensity sweetener, an amount of stevia extract of from about 0.05% to about 0.25% by weight relative to the total weight of the sweetener system has shown itself to be advantageous, for example an amount of from about 0.10% to about 0.20%, for example an amount of 0.10%, 0.11%, 0.12%, 0.13%, 0.14%, 0.15%, 0.16%, 0.17%, 0.18%, 0.19% or 0.20% by weight relative to the total weight of the sweetener system. This amount of stevia extract may be usefully combined with an amount of monk fruit extract of from about 0.01% to about 0.10% by weight relative to the total weight of the sweetener system, for example an amount of from about 0.02% to about 0.09%, for example an amount of 0.02%, 0.03%, 0.04%, 0.05%, 0.06%, 0.07%, 0.08% or 0.09% by weight relative to the total weight of the sweetener system.

The at least one bulking agent of the sweetener system may be any suitable bulking agent known to those skilled in the art. Examples of bulking agents which may be contemplated include maltodextrin, polydextrose, gums (such as xanthan gum or guar gum), soluble corn fiber (SCF), starches and polyols. Maltodextrin, polydextrose and SCF, as well as any mixtures of these, are particularly preferred bulking agents. SCF is an example of a particularly preferred bulking agent. A further example of a preferred bulking agent is a mixture of polydextrose and maltodextrin. The amount of the at least one bulking agent will depend primarily on the end-use application in which the sweetener system is to be used, and the functional properties required for that application. It will also depend on the bulk density of the respective bulking agent or agents employed, as well as the amounts of allulose and the at least one high intensity sweetener.

In general, the amount of bulking agent present in the sweetener system according to the present invention may be from about 5% by weight to about 95% by weight relative to the total weight of the sweetener system, for example in an amount of from about 20% to about 85% by weight relative to the total weight of the sweetener system, for example from about 50% to about 80% by weight relative to the total weight of the sweetener system, for example about 5%, 10%, 15%, 20%, 25%, 30%, 35%, 40%, 45%, 50%, 55%, 60%, 65%, 70%, 75%, 80%, 85%, 90% or 95% by weight relative to the total weight of the sweetener system. An amount of bulking agent of from about 50% to about 80% by weight relative to the total weight of the sweetener system will often be particularly convenient, for example an amount of 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79% or 80% by weight relative to the total weight of the sweetener system.

According to certain embodiments, a nutritive sweetener may be used as the at least one bulking agent, or as one of the at least one bulking agents. For example, sucrose, fructose and/or dextrose may be used in this regard. It will be appreciated, however, that the use of a nutritive sweetener will result in the sweetener system having a higher caloric content.

Other ingredients may be included in the sweetener system if required. Such other ingredients may be one or more selected from the group consisting of anti-caking agents, natural and/or artificial flavors, natural and/or artificial colors, acidulants, vitamins, preservatives, antioxidants and any other ingredients suitable for use in the relevant end-use application.

The sweetener system according to the present invention may be provided in solid (e.g. powder or crystalline) form, or in liquid form (e.g. as a syrup). According to certain embodiments, it has shown itself to be particularly convenient to provide the sweetener system of the present invention in the form of a syrup. According to these embodiments, the other ingredients of the sweetener system may be admixed into an allulose syrup, for example an allulose syrup comprising about 70% to about 90% allulose on a dry solids basis, for example a 77% ds allulose syrup.

One particular food and beverage application for which the sweetener system of the present invention has shown itself to be particularly useful is frozen desserts, for example ice creams. Accordingly, one embodiment provides a sweetener system for use in ice creams. A preferred sweetener system for use in ice creams includes allulose in an amount of from about 20% to about 50% by weight relative to the total weight of the sweetener system (for example about 31% or about 45% by weight relative to the total weight of the sweetener system); SCF in an amount of from about 50% to about 80% by weight relative to the total weight of the sweetener system (for example about 69% or about 55% by weight relative to the total weight of the sweetener system); stevia extract in an amount of from about 0.10% to about 0.20% by weight relative to the total weight of the sweetener system (for example about 0.14% or about 0.154% by weight relative to the total weight of the sweetener system); and monk fruit extract in an amount of from about 0.02% to about 0.09% by weight relative to the total weight of the sweetener system (for example about 0.07% or about 0.075% by weight relative to the total weight of the sweetener system). The sweetener system may optionally also include an amount of a nutritive sweetener, such as fructose (for example in an amount of from about 0.5% to about 10%, for example about 1% to about 2%, for example about 1.75% by weight relative to the total weight of the sweetener system). Such a sweetener system is preferably provided as a syrup comprising the above ingredients. It has been found that such a sweetener system is able to provide ice creams having significantly decreased calorie and sugar content, but with similar sweetness equivalence, freezing point, shape retention, melt rate, storage stability, and eating characteristics (e.g. mouthfeel, coldness, body and the like) to conventional ice creams prepared using nutritive sweeteners.

Other food and beverage products for which the sweetener system of the present invention is expected to be particularly useful include confectionary products (such as jelly candies, soft candies, hard candies, chocolates and gums) and snack bars (e.g. cereal bars).

### EXAMPLES

The invention will now be illustrated by means of the following examples, it being understood that these are intended to explain the invention, and in no way to limit its scope.

### Non-Carbonated Beverages

### Example 1

### Flavored Water

This example was conducted to determine how the properties of flavored water containing allulose compared with the properties of flavored water containing a rebaudioside A/erythritol mixture. The composition of the flavored water is shown in Table 1. Since allulose was added as a syrup with 89% dry solids, the amount of allulose in the flavored water of Example 1 b is 1.75%, which is the same as the amount of erythritol in Comparative Example 1.

TABLE 1

| | Comparative | | | | | |
|---|---|---|---|---|---|---|
| | Example 1 | | Example 1a | | Example 1b | |
| Sweetening agent | Reb A/Erythritol | | Allulose | | Reb A/Allulose | |
| INGREDIENT | % | GRAMS | % | GRAMS | % | GRAMS |
| Sucrose | 0.000 | 0.000 | 0.000 | 0.000 | 0.000 | 0.000 |
| Allulose, 89 DS | 0.000 | 0.000 | 14.880 | 327.355 | 1.966 | 43.258 |
| Potassium citrate | 0.027 | 1.161 | 0.027 | 0.594 | 0.027 | 0.594 |
| Citric acid, fine | 0.135 | 5.805 | 0.135 | 2.970 | 0.135 | 2.970 |
| Strawberry flavor | 0.100 | 4.300 | 0.100 | 2.200 | 0.100 | 2.200 |
| DY18135 | | | | | | |
| Reb A | 0.0215 | 0.925 | 0.000 | 0.000 | 0.0215 | 0.473 |
| Erythritol | 1.750 | 75.250 | 0.000 | 0.000 | 0.000 | 0.000 |
| Water | 97.967 | 4212.560 | 84.858 | 1866.881 | 97.7505 | 2150.978 |
| TOTAL | 100.00 | 4300.00 | 100.00 | 2200.00 | 100.00 | 2200.00 |

The components shown in Table 1 were mixed until a clear solution was achieved, and the resulting mixture was pasteurized at 185° F. for 30 seconds, followed by capping and bottle inversion. The bottled mixture was immediately cooled in an ice bath.

Paired comparison tests for sweetness and preference were conducted. The tests were conducted as complete block designs over two days with a minimum of 40 evaluations and sample presentation rotated. The solutions were served cold in soufflé cups (2 oz.). The panelists were instructed to consume at least half of each sample. There was a one minute enforced waiting period between samples. The panelists were asked to identify the solution that they preferred on one day, and which was sweeter on the second day. Water (purified by reverse osmosis), sucrose solution (2%), and unsalted crackers were available for the panelists to clear their palates before and during testing. The results are shown in the Tables 2 and 3.

TABLE 2

| | Preference (Day 1) | Sweetness (Day 2) |
|---|---|---|
| Sweetener | (No. of people) | (No. of people) |
| RebA/Erythritol | 18 | 15 |
| Allulose | 22 | 25 |

TABLE 3

| | Preference (Day 1) | Sweetness (Day 2) |
|---|---|---|
| Sweetener | (No. of people) | (No. of people) |
| RebA/Erythritol | 19 | 15 |
| RebA/Allulose | 21 | 25 |

More people preferred the allulose sweetened beverage (22 to 18) and more people found it sweeter (25 to 15). When erythritol was replaced in a RebA/erythritol blend on a one for one solids basis with allulose, more people thought the allulose blend was sweeter (25 to 15) and more people preferred the allulose version (21 to 19). This result was unexpected, as both erythritol and allulose have essentially equivalent sweetness on an equal dry weight basis, and yet the allulose was found to be much sweeter than erythritol when combined with Reb A in a flavored water.

### Example 2

### Strawberry Fruit-Flavored Beverage

A sweetened strawberry-flavored beverage was prepared using allulose as the sweetening agent. The composition of the strawberry-flavored beverage is shown in Table 4.

TABLE 4

| | Example 2 | Comparative Example 2 |
|---|---|---|
| Ingredient | Quantity (g) | Quantity (g) |
| 72% Allulose syrup | 54.2 | 0 |
| Citric acid strawberry flavor | 0.5 | 0.5 |
| Water | 185.8 | 239.36 |
| Optimized stevia blend | 0 | 0.24 |

The allulose-sweetened strawberry drink with citric acid (Example 2) was tasted by an expert panel of 8 people and compared with a strawberry flavored drink prepared with high intensity sweeteners (Comparative Example 2). The allulose-flavored version of the drink was preferred unanimously. The allulose sweetened drink was also compared to an equal sweet sugar control with multiple panels totaling 40 people. There was no preference for sugar over the allulose-sweetened drink in terms of sweetness, flavor, or mouthfeel. This is a significant and surprising result, as complete calorie reduction was achieved without altering the preference in comparison to sucrose.

### Example 3

### Sweet Iced Tea

A sweet iced tea beverage was prepared using allulose as the sweetening agent. The composition of the beverage is shown in Table 5.

TABLE 5

| Ingredient | Sweet Iced Tea (%) | Sweet Tea (g) |
|---|---|---|
| Allulose syrup (72%) | 18 | 90.0 |
| Brewed tea (4 oz.) | 41 | 205.0 |
| Ice | 41 | 205.0 |
| TOTAL | 100 | 500 |

Allulose sweetened tea was prepared and tasted by an expert panel of 8 people in comparison to the same drink prepared with high fructose corn syrup or high intensity sweeteners. The allulose-flavored version of the drink was preferred unanimously.

### Yogurts

### Example 4

### Vanilla-Flavored Yogurts

Vanilla flavored yogurts were prepared by combining commercial yogurt white mass (85%) and a flavor preparation (15%). The composition of the flavor preparations is shown in Table 6. In the flavor preparation, allulose was substituted in place of sucrose. Three values were chosen: 50%, 75%, and 100% replacement of sucrose on an equal solid level, in order to maintain a consistent viscosity. These correspond to Examples 4a, 4b and 4c, respectively. A control preparation was also made in which sucrose made up 100% of the total sugar content in the flavor preparation (Comparative Example 4).

TABLE 6

| | Comparative | | | |
|---|---|---|---|---|
| | Example 4 | Example 4a | Example 4b | Example 4c |
| Water | 37.24 | 31.03 | 27.92 | 24.82 |
| Rezista | 4 | 4 | 4 | 4 |
| Citric Acid | 0.07 | 0.07 | 0.07 | 0.07 |
| Potassium | 0.1 | 0.1 | 0.1 | 0.1 |
| Sorbate | | | | |
| Sucrose | 58 | 29 | 14.5 | 0 |
| Allulose | 0 | 35.21 | 52.82 | 70.42 |
| (82 DS) | | | | |
| Vanilla | 0.53 | 0.53 | 0.53 | 0.53 |
| Flavor YJ | | | | |
| 151-458-5¹ | | | | |
| Caramel | 0.06 | 0.06 | 0.06 | 0.06 |
| Color | | | | |
| CS30² | | | | |
| Total | 100 | 100 | 100 | 100 |

¹Givaudan Flavor Corp.
²Sethness Products

The physical properties (pH, Brix, and Bostwick viscosity) of the flavor preparations are summarized in Table 7.

TABLE 7

| | pH | Brix | Bostwick³ |
|---|---|---|---|
| Comparative Example 4 | 4.40 | 63 | 7.5 |
| Example 4a | 4.43 | 65 | 6 |
| Example 4b | 4.45 | 66 | 4.5 |
| Example 4c | 4.40 | 68 | 3.5 |

³Refrigerated temperature of 40° F.

Affective testing using 9-point hedonic and just-about-right (JAR) scales was conducted on the yogurts in a roundtable evaluation (8 panelists completed). The yogurt products were randomized and presented monadically at refrigerator temperature. The yogurt was served in soufflé cups (5 oz.) to give the panelists ample product for testing. The panelists were instructed to consume enough of the sample to answer each question. There was a two minute enforced waiting period between tests to clear the panelists' palates. Water (purified by reverse osmosis) and unsalted crackers were available for the panelists to clear their palates before and during testing.

The questions were split into five categories: 1) overall acceptability; 2) appearance acceptability (color); 3) aroma acceptability (overall aroma strength); 4) flavor acceptability (overall flavor strength, sweetness, tartness, and bitterness); and 5) texture acceptability (consistency). The results of the 9-point hedonic scale roundtable evaluation are shown in Table 8. The JAR evaluation results are shown in Table 9.

TABLE 8
Roundtable

| | Comparative | | | |
|---|---|---|---|---|
| Yogurt | Example 4 | Example 4a | Example 4b | Example 4c |
| Overall | 7.38^{a} | 7.25^{a} | 7.12^{a} | 6.12^{b} |
| acceptance | | | | |
| Appearance | 7.12^{a} | 7^{a} | 7^{a} | 7.12^{a} |
| Acceptance | | | | |
| Aroma | 7^{a} | 7.12^{a} | 7.25^{a} | 7^{a} |
| Acceptance | | | | |
| Flavor | 7.12^{a-b} | 7.5^{a} | 7^{a-b} | 6.12^{b} |
| Acceptance | | | | |
| Texture | 6.88^{a} | 6.25^{a} | 6.75^{a} | 6.62^{a} |
| Acceptance | | | | |

Level of significance for the grouping (Duncan): 5%

No significant differences in any of the acceptability attributes were observed between full sugar control (Comp. Ex. 4) and 50% (Example 4a) and 75% (Example 4b) sugar replacement with allulose in the roundtable test. However, the full sugar replacement (Example 4c) was significantly different in overall acceptability as well as flavor acceptability. It was noted by panelists that the sweetness was lower.

TABLE 9

| | | | | Too | | | Too |
|---|---|---|---|---|---|---|---|
| | | Too | JAR | much | Too little | JAR | much |
| JAR | Product | little % N | % N | % N | penalty | penalty | penalty |
| Aroma | Comp. Ex. 4 | 12.5 | 87.5 | 0 | −3.86 | 0 | 0 |
| Flavor strength | Comp. Ex. 4 | 0 | 87.5 | 12.5 | 0 | 0 | −3.86 |
| Tartness | Comp. Ex. 4 | 12.5 | 75 | 12.5 | −3.83 | 0 | 0.17 |
| Texture | Comp. Ex. 4 | 12.5 | 87.5 | 0 | −3.86 | 0 | 0 |
| Color | Comp. Ex. 4 | 0 | 100 | 0 | 0 | 0 | 0 |
| Sweet | Comp. Ex. 4 | 0 | 100 | 0 | 0 | 0 | 0 |
| Bitterness | Comp. Ex. 4 | 100 | 0 | 0 | 0 | 0 | 0 |
| Tartness | Example 4a | 12.5 | 87.5 | 0 | −1.43 | 0 | 0 |
| Texture | Example 4a | 25 | 75 | 0 | −0.33 | 0 | 0 |
| Color | Example 4a | 0 | 100 | 0 | 0 | 0 | 0 |
| Aroma | Example 4a | 0 | 100 | 0 | 0 | 0 | 0 |
| Flavor strength | Example 4a | 0 | 100 | 0 | 0 | 0 | 0 |
| Sweetness | Example 4a | 0 | 100 | 0 | 0 | 0 | 0 |
| Bitterness | Example 4a | 100 | 0 | 0 | 0 | 0 | 0 |
| Sweetness | Example 4b | 50 | 50 | 0 | −1.75 | 0 | 0 |
| Tartness | Example 4b | 12.5 | 62.5 | 25 | −1.8 | 0 | −1.8 |
| Color | Example 4b | 0 | 87.5 | 12.5 | 0 | 0 | −2.43 |
| Texture | Example 4b | 25 | 75 | 0 | −0.83 | 0 | 0 |
| Aroma | Example 4b | 0 | 100 | 0 | 0 | 0 | 0 |
| Flavor strength | Example 4b | 25 | 75 | 0 | 1.17 | 0 | 0 |
| Bitterness | Example 4b | 100 | 0 | 0 | 0 | 0 | 0 |
| Sweetness | Example 4c | 50 | 50 | 0 | −1.75 | 0 | 0 |
| Texture | Example 4c | 12.5 | 87.5 | 0 | −5.86 | 0 | 0 |
| Tartness | Example 4c | 12.5 | 50 | 37.5 | −5.75 | 0 | 0.25 |
| Flavor strength | Example 4c | 25 | 75 | 0 | −2.83 | 0 | 0 |
| Color | Example 4c | 0 | 100 | 0 | 0 | 0 | 0 |
| Aroma | Example 4c | 0 | 100 | 0 | 0 | 0 | 0 |
| Bitterness | Example 4c | 100 | 0 | 0 | 0 | 0 | 0 |

In the yogurt containing the flavor preparation of Comparative Example 4, all attributes measured had very little penalty and overlapped with each other including aroma JAR, flavor strength JAR, tartness JAR, texture JAR.

Penalty analysis shows 50% replacement (Example 4a) had 25% of panelists responding too little on texture but the penalty was very low (0.33). Both 75% (Example 4b) and 100% (Example 4c) replacement levels had 50% of panelists stating too little on sweetness (−1.75 penalties). 100% replacement had 25% of panelists stating too little flavor with a −2.83 penalty. Additionally, while only 12.5% of panelists stated too little texture and tartness on JAR, the penalty was −5.86 and −5.75 respectively.

### Sweet Bakery Products

### Example 5

### Cookies

Cookies were prepared using allulose. The composition of the cookies is shown in Table 10.

TABLE 10

| | Comparative | |
|---|---|---|
| | Example 5 | Example 5 |
| INGREDIENT | % | % |
| Isosweet 100, HFCS | 15.00000 | 0.0000 |
| Allulose, 89 DS | 0.00000 | 31.0000 |
| Butter, unsalted | 15.5000 | 15.5000 |
| Granulated sugar | 20.75000 | 7.0000 |
| Salt | 0.42000 | 0.42000 |
| Water | 1.00000 | 1.00000 |
| Eggs, whole, dried | 7.00000 | 7.00000 |
| MIRA-GEL 463 | 0.00000 | 0.25000 |
| Vanilla extract | 0.25000 | 0.25000 |
| All-purpose white flour | 32.44000 | 29.9400 |
| Baking soda | 0.64000 | 0.64000 |
| Semi-sweet chocolate chips | 7.00000 | 7.00000 |
| TOTAL | 100 | 100 |

### Example 6

### Cake

An example of lemon poppy seed cake with allulose was prepared according to Table 11.

TABLE 11

| Ingredients | Amounts (g) | % (wt) |
|---|---|---|
| Granulated sugar | 260.6 | 13.0 |
| Cake flour | 501.2 | 25.0 |
| MIRA-SPERSE ® 2000 Tate & Lyle | 20 | 1.0 |
| Baking powder, double acting | 19.8 | 1.0 |
| Salt | 12.9 | 0.6 |
| Lemon zest, finely grated | 15.2 | 0.8 |
| ALLULOSE (solids basis) | 257 | 12.8 |
| Milk, whole | 203.4 | 10.2 |
| Eggs, liquid whole | 314 | 15.7 |
| Vanilla extract | 20.8 | 1.0 |
| Lemon juice | 45 | 2.2 |
| Butter, unsalted, softened | 313.6 | 15.7 |
| Poppy seeds | 19.7 | 1.0 |

### Method

1. An oven was pre-heated to 325° F. (160-165° C.).
2. A parchment lined half sheet pan was lightly sprayed with a pan extender.
3. Granulated sugar, flour, MIRA-SPERSE® 2000, baking powder, salt and lemon zest were combined in a mixing bowl with a paddle attachment. The mixture was blended on low speed until well combined.
4. Allulose, milk, eggs and vanilla extract were mixed in a separate container and gently whisked to combine.
5. Softened butter and half of the liquid mixture was added to the mixing bowl with the dry ingredients. The mixture was mixed on low speed for one minute. The bowl was scraped and mixed for 4 minutes on a medium speed.
6. Half of the remaining liquid was added and the mixture was mixed for 2 minutes on medium speed.
7. The remaining liquid was added with the lemon juice and mixed for 2 minutes on medium speed.
8. The poppy seeds were added and the mixture was mixed until well dispersed (˜30 seconds on medium speed).
9. The batter was poured into a prepared half sheet pan and levelled with an off-set spatula. The prepared cake pan was placed into an additional half sheet pan (to offset additional browning to bottom of cake).
10. The cake was baked in an oven for 45-50 minutes (exact timing will depend on the oven—should be baked until the cake springs back after being gently pressed). The pan was rotated after 30 minutes in the oven.
11. The cake was allowed to cool in the pan for 15-20 minutes before being turned out onto a cooling rack. The cake was cooled completely before wrapping.
12. The cake was cut into 5 cm squares for service and served at room temperature.

This cake has a 50% reduction in sugar and a 16% reduction in calories as compared to a full sugar cake. It was unexpectedly found that the cake was well risen and was moist, and had a good sweet profile without no off-taste.

### Example 7

### Cake

A cake comprising allulose was prepared according to Table 12:

TABLE 12

| Ingredient: | % | grams |
|---|---|---|
| Allulose, 78DS | 12.82% | 96.2 |
| Sugar, granulated white | 16.07% | 120.5 |
| Flour, cake | 25.06% | 188.0 |
| MIRA-SPERSE 2000 | 1.00% | 7.5 |
| Baking powder, double acting | 0.99% | 7.4 |
| Salt, iodized | 0.65% | 4.8 |
| Milk, whole | 11.00% | 82.5 |
| Eggs, whole | 15.70% | 117.8 |
| Vanilla extract | 1.04% | 7.8 |
| Butter, unsalted, softened | 15.68% | 117.6 |
| | 100.00% | 750.0 |

### Method:

1. All dry ingredients (sugar, flour, MIRA-SPERSE 2000, baking powder and salt) were added to a (Hobart) mixing bowl;
2. The ingredients were mixed on low speed for 1 minute.
3. C2-279, milk, eggs and vanilla were combined and beaten gently.
4. Softened butter and half of the liquids were added to the dries in the mixing bowl.
5. The mixture was mixed for 4 minutes on medium speed.
6. The rest of the liquid was added in two separate additions.
7. Mixing was continued for 2 minutes on medium speed after each addition, scraping the bowl after each mixing step.
8. The batter was poured into a greased and parchment paper lined 8 inch (20 cm) round cake pan.
9. The batter was leveled and the pan was tapped on a flat surface several times to avoid air pockets.
10. The cake pan was placed on two half sheet pans (at room temperature) to slow bottom browning.
11. The cake was baked at 325° F. (163° C.) for 45-55 minutes.
12. The cake was allowed to cool in the pan for 30 minutes before removing from pan to cool completely on a wire rack.

The baked cake had a moisture content of 21.18% and a water activity (a_{w}) of 0.8299.

### Example 8

### Cake with High Level of Allulose

A cake comprising allulose was prepared according to Table 13:

TABLE 13

| Ingredient: | % | grams |
|---|---|---|
| Allulose, 78DS | 57.69% | 432.68 |
| Butter, unsalted, melted | 8.81% | 66.08 |
| Baking powder, double acting | 1.00% | 7.50 |
| Egg whites | 10.00% | 75.00 |
| Flour, all purpose | 20.00% | 150.00 |
| MIRA-GEL 463 | 1.00% | 7.50 |
| Vanilla extract | 1.00% | 7.50 |
| Salt, iodized | 0.50% | 3.75 |
| | 100.00% | 750.00 |

### Method:

1. Allulose syrup was added to a (Hobart) mixing bowl.
2. Melted butter was added to the syrup and mixed on low speed for 1-2 minutes.
3. Egg whites and vanilla were added and mixed for an additional 1-2 minutes on low speed.
4. Remaining ingredients were sifted together and added to the bowl in 3 separate additions.
5. The mixture was mixed on medium speed for 2 minutes after each addition and the bowl was scraped well.
6. The mixture was mixed for an additional 2-3 minutes on medium speed after all ingredients had been combined.
7. The batter was poured into a greased and parchment lined 8 inch (20 cm) round cake pan.
8. The batter was leveled and the pan was tapped on a flat surface several times to avoid air pockets.
9. The cake pan was placed on two half sheet pans (at room temperature) to slow bottom browning.
10. The cake was baked at 325° F. (163° C.) for 40-45 minutes.
11. The cake was allowed to cool in the pan for 30 minutes before removing from the pan to cool completely on a wire rack.

The baked cake had a moisture content of 22.58% and a water activity (a_{w}) of 0.7365.

It was found that the cake having a higher level of allulose displayed increased browning from bottom to top, and had a color gradient. It was also found that additional structural ingredients (egg whites and MIRA-GEL 463) were required to provide the required cake structure.

### Example 9

### Sweet Bread Buns/Rolls

### Preparation of Breads:

Breads were prepared using HFCS (Comparative Example 9) and replacing the majority of HFCS with allulose (Example 9). The compositions of the breads are shown in Table 14:

TABLE 14

| | Example 9: | | | Comparative | |
|---|---|---|---|---|---|
| | Amount | | | Example 9: | |
| INGREDIENT | per 110 | | Weight | | Weight |
| (Supplier) | g dough* | % | (g) | % | (g) |
| Bread flour (Winona) | 60.34 | 54.85 | 2084.00 | 54.85 | 2084.00 |
| Table salt (Morton) | 1.08 | 0.98 | 37.40 | 0.98 | 37.40 |
| SSL = Emulsifier | 0.16 | 0.14 | 5.50 | 0.14 | 5.50 |
| Emplex | | | | | |
| American ing. | | | | | |
| (Caravan Ingrd) | | | | | |
| Ultra Fresh | 0.03 | 0.03 | 1.00 | 0.03 | 1.00 |
| Premium 1650 | | | | | |
| (Caravan Ingrd) | | | | | |
| Calcium propionate | 0.02 | 0.02 | 0.80 | 0.02 | 0.80 |
| (Niacet) | | | | | |
| Water | 31.85 | 28.95 | 1100.00 | 28.95 | 1100.00 |
| ISOSWEET 5500, | 1.45 | 1.32 | 50.00 | 12.63 | 480.00 |
| HFCS | | | | | |
| (Tate & Lyle) | | | | | |
| Allulose Syrup, | 12.45 | 11.32 | 430.00 | 0.00 | 0.00 |
| 78% DS | | | | | |
| (Tate & Lyle) | | | | | |
| Active dry yeast, | 0.60 | 0.54 | 20.60 | 0.54 | 20.60 |
| Saf-Instant | | | | | |
| (Lesaffre) | | | | | |
| Soybean Oil (GFS) | 1.74 | 1.58 | 60.00 | 1.58 | 60.00 |
| Monoglycerides, | 0.29 | 0.26 | 10.00 | 0.26 | 10.00 |
| GMS-90 | | | | | |
| (Caravan Ingrd) | | | | | |
| TOTAL | 110 | 100 | 3799.3 | 100 | 3799.3 |

*110 g dough corresponds to 100 g cooked weight

The breads were prepared according to the following procedure:

The water was warmed to 110-114° F. (43-46° C.) and was mixed with the yeast, HFCS and allulose (if used). The yeast was activated until foamy (approx. 5 min). The oil and monoglycerides were warmed in a microwave and then the water/HFCS/(allulose)/yeast slurry and the oil/monoglycerides were mixed in a mixer fitted with a dough hook (HOBART mixer, speed #1) to incorporate.

The flour, salt, emulsifier, Ultra Fresh 1650 and calcium propionate were preblended. These dries were then incorporated into the wet mixture slowly over about 2 minutes (mix speed #1). The mixture was then mixed for 1 min 30 s (mix speed #1) and then 2 min (mix speed #2) and then up to 4 min (mix speed #3) to develop gluten (check elasticity).

The dough was bulk fermented in a covered, greased bowl for 1 hour (actual=1 h) or until doubled in size. The dough was then punched down and divided into 110 g portions. Each portion was formed into a 6 inch (15 cm) length piece and placed on a parchment paper-lined SS pan. The buns were then proved in Nu-Vu (110/5) for 11 min. and baked at 385° F. (196° C.) for 12 min 30 sec (target baked moisture of 29%). They were removed from the pan immediately to cool. The buns were flash-frozen and stored in a large plastic bag.

### Sensory Testing:

Affective testing was conducted using a 9-point hedonic scale and just-about-right (JAR) scales in a roundtable evaluation. The products were randomized and presented monadically. The bread were served in 4 ounce (100 g) soufflé cups to give the panelists ample product for testing. The panelists were instructed to consume enough of the sample to answer each question. Cups were labeled with 3-digit blinding codes. There was a two minute enforced waiting period between tests to clear the panelists' palates. RO water and unsalted crackers were available for the panelists to clear their palates before and during testing.

### Questions:

Overall acceptability
Appearance acceptability
   Crust Color
   Inside color
   Size of the cells
Aroma acceptability
   Overall aroma strength
Flavor acceptability
   Flavor strength
   Sweetness
Texture acceptability
   Moistness
   Tenderness

The results are shown below in Tables 15 and 16:

TABLE 15

| | Example 9: | Comparative Example 9: |
|---|---|---|
| OVERALL acceptance | 6.43^{a} | 6.39^{a} |
| Appearance Acceptance | 6.68^{a} | 6.18^{a} |
| Aroma Acceptance | 6.52^{a} | 6.36^{a} |
| Flavor Acceptance | 6.66^{a} | 6.14^{a} |
| Texture Acceptance | 5.8^{a} | 5.8^{a} |

Level of significance for the grouping (Friedman): 5%

TABLE 16

| | | too | | too | | too |
|---|---|---|---|---|---|---|
| | | little | JAR | much | too little | much |
| | Example | % N | % N | % N | penalty | penalty |
| Aroma | Example 9 | 15.91% | 84.09% | 0% | −0.35 | 0 |
| JAR | Comparative | 18.18% | 81.82% | 0% | −0.47 | 0 |
| | Example 9 | | | | | |
| Cells | Example 9 | 13.64% | 75% | 11.36% | 0.28 | 0.01 |
| JAR | Comparative | 20.45% | 61.36% | 18.18% | −0.85 | −1.6 |
| | Example 9 | | | | | |
| Crust | Example 9 | 18.18% | 79.55% | 2.27% | 0.25 | 0.63 |
| color | Comparative | 29.55% | 68.18% | 2.27% | −1.05 | 1.33 |
| JAR | Example 9 | | | | | |
| Flavor | Example 9 | 20.45% | 72.73% | 6.82% | −0.48 | −0.92 |
| strength | Comparative | 4.55% | 79.55% | 15.91% | −2.13 | −0.92 |
| JAR | Example 9 | | | | | |
| Inside | Example 9 | 6.82% | 93.18% | 0% | −0.11 | 0 |
| color | Comparative | 9.09% | 88.64% | 2.27% | −1.49 | 1.51 |
| JAR | Example 9 | | | | | |
| Moist | Example 9 | 31.82% | 65.91% | 2.27% | −0.69 | −1.69 |
| JAR | Comparative | 31.82% | 65.91% | 2.27% | −1.5 | 0.14 |
| | Example 9 | | | | | |
| Sweet- | Example 9 | 22.73% | 70.45% | 6.82% | −0.38 | 0.52 |
| ness | Comparative | 0% | 40.91% | 59.09% | 0 | −0.94 |
| JAR | Example 9 | | | | | |
| Tender | Example 9 | 25% | 68.18% | 6.82% | −0.3 | −0.9 |
| JAR | Comparative | 27.27% | 68.18% | 4.55% | −1 | −0.17 |
| | Example 9 | | | | | |

The results show that replacement of HFCS with allulose in bread gives parity overall acceptability in comparison to bread containing HFCS and no allulose.

### Firmness:

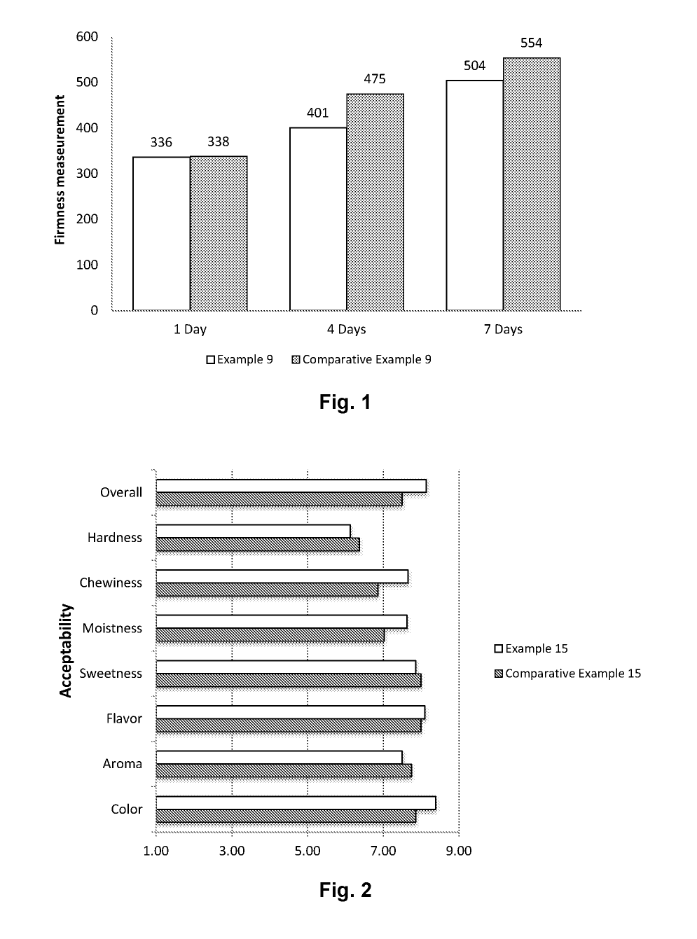

The breads were tested for firmness at 4 and 7 days. The results are shown in FIG. 1. It can be seen that bread comprising allulose (Example 9) was significantly less firm than bread without allulose (Comparative Example 9), indicating that allulose provides a surprising stabilizing effect (anti-staling effect).

### Pie Fillings

### Example 10

### Pecan Pie

Pies were prepared using either Sweetose 4425 corn syrup (Comparative Example 10) or allulose (Example 10). The composition of the prepared pie filling is shown in Table 17.

TABLE 17

| | Comparative | |
|---|---|---|
| | Example 10 | Example 10 |
| INGREDIENT | % | % |
| Sweetose 4425, corn syrup | 41.195 | 0.00 |
| Allulose, 89 DS | 0.00 | 46.195 |
| Eggs | 19.39 | 17.39 |
| Sugar | 18.68 | 16.68 |
| Butter | 3.215 | 3.215 |
| Vanilla | 0.51 | 0.51 |
| Pecans | 17.01 | 16.01 |
| TOTAL | 100 | 100 |

The pies were prepared by mixing the ingredients in Table 17 and pouring portions (60 g) into pie shells (3″). These were baked (325° F., 30 minutes) and left to cool for 2 hours.

The use of allulose resulted in a reduction in calories of approximately 30%. The pies had good browning and flavor characteristics with allulose. In repeated blind taste tests with expert tasters, no preference was observed for the control pie over allulose. This is a surprising example of replacement of sugar and corn syrup with a single calorie reducing ingredient that does not negatively affect flavor or preference.

### Bread Products

### Example 11

### Bread

Bread was prepared using allulose. The composition of the bread is shown in Table 18.

TABLE 18

| | Comparative | |
|---|---|---|
| | Example 11 | Example 11 |
| INGREDIENT | Grams | Grams |
| Allulose (77% DS dilution) | 0.0000 | 16.3360 |
| Yeast, active, dry | 0.6371 | 0.7011 |
| Water, tap, municipal | 34.0191 | 37.4366 |
| Ultra Fresh Premium 1650 | 0.0309 | 0.0340 |
| Syrup, corn, hi fructose, Iso Sweet 5500 | 14.8447 | 0.0000 |
| SSL = Emulsifier Emplex American ing. | 0.1701 | 0.1872 |
| Salt, table | 1.1567 | 1.2729 |
| Oil, soybean, salad or cooking | 1.8556 | 2.0420 |
| King wheat bread flour-updated | 64.4507 | 70.9254 |
| Emulsifier, monoglyceride, starch complex | 0.3093 | 0.3403 |
| agent, GMS-90 | | |
| Calcium Propionate | 0.0247 | 0.0272 |
| Total | 117.4989 | 129.3027 |
| Moisture Adjustment: Target | 29 | 29 |

### Frozen Desserts

### Example 12

### Ice Cream

Unflavored ice creams were prepared according to the composition shown in Table 19. The dry ingredients (ice cream stabilizer and non-fat dry milk) and liquid sweeteners (allulose, corn syrup and sucrose) were pre-blended separately. Under moderate agitation (likwifier), the liquid sweeteners were added to the fluid milk, followed by the dry ingredients, again under moderate agitation to ensure proper dispersion. The resulting mixture was pasteurized at 195° F. for 30 seconds, homogenized at 2500 psi (500 psi second stage and 2000 psi first stage), refrigerated, mixed and aged overnight. The following day, the mixture was frozen at 20° F. to 40% overrun, packaged and stored at −20° F.

TABLE 19
Ice Cream Stabilizer:

| | |
|---|---|
| CMC 7HF | 42.5 |
| Rezista | 5 |
| Staleydex 333 | 38.15 |
| Carrageenan | 5 |
| Mono/diglycerides | 4.35 |
| Disodium Phosphate | 5 |
| | 100 |

| | HFCS | Allulose | Allulose |
|---|---|---|---|
| Ice Cream: | (Comp. Ex. 12A) | (Ex. 12a) | (Ex. 12b) |
| Cream, 36% Butterfat | 33.27 | 33.27 | 33.27 |
| Milk, Skim | 37.55 | 37.55 | 37.85 |
| Non-fat dry milk powder | 5 | 5 | 4.97 |
| HFCS | 3.53 | 0 | 0 |
| Allulose, 77ds | 0 | 3.53 | 8 |
| 35DE corn syrup | 9.33 | 9.33 | 9.33 |
| Liquid Sugar, 67 Brix | 11.06 | 11.06 | 6.32 |
| Stabilizer | 0.26 | 0.26 | 0.26 |
| | 100 | 100 | 100 |
| % Solids | 39.64 | 39.64 | 39.64 |
| lbs./gal | 9.23 | 9.23 | 9.25 |
| % Butterfat | 12 | 12 | 12 |
| % MSNF | 10 | 10 | 10 |

Affective testing using 9-point hedonic and just-about-right (JAR) scales were conducted. The products were randomized and presented monadically at freezer temperature. The panelists were instructed to consume enough of the sample to answer each question. There was a two minute enforced waiting period between tests to clear the panelists' palates. Water (purified by reverse osmosis) and unsalted crackers were available for the panelists to clear their palates before and during testing.

The questions were split into five categories: 1) overall acceptability; 2) appearance acceptability (color); 3) aroma acceptability (overall aroma strength); 4) flavor acceptability (overall flavor strength, sweetness, tartness, and bitterness); and 5) texture acceptability (consistency). The results of the 9-point hedonic scale evaluation are shown in Table 20. The JAR evaluation results are shown in Table 21.

It should be noted that only the 3.53% allulose prototype (Example 12a) was tested by the panel, although the higher use level prototype still had surprisingly good ice cream texture.

TABLE 20
PostHoc Groups

| | Control (A) | Allulose |
|---|---|---|
| | Comparative | 3.53% (B) |
| | Example 12A | Example 12a |
| OVERALL acceptance | 6.75^{a} | 6.56^{a} |
| Appearance Acceptance | 6.85^{a} | 6.85^{a} |
| Flavor Acceptance | 6.48^{a} | 6.4^{a} |
| Texture Acceptance | 6.96^{a} | 6.52^{a} |

Level of significance for the grouping (Duncan): 5%

TABLE 21
Std Error of Mean table Summary

| | | Too | | Too | Too | Too |
|---|---|---|---|---|---|---|
| | | little | JAR | much | little | much |
| JAR | Product | % N | % N | % N | penalty | penalty |
| Color | Comp. | 16.67% | 83.33% | 0% | −0.6 | 0 |
| | Ex. 12A | | | | | |
| | Allulose | 18.75% | 81.25% | 0% | −2.06 | 0 |
| | 3.9% | | | | | |
| Flavor | Comp. | 29.17% | 64.58% | 6.25% | −0.92 | −0.73 |
| strength | Ex. 12A | | | | | |
| | Allulose | 20.83% | 68.75% | 10.42% | −1.03 | −2.43 |
| | 3.9% | | | | | |
| Creaminess | Comp. | 4.17% | 91.67% | 4.17% | −3.5 | −2.5 |
| | Ex. 12A | | | | | |
| | Allulose | 20.83% | 62.50% | 16.67% | −1.57 | −1.07 |
| | 3.9% | | | | | |
| Smoothness | Comp. | 6.25% | 85.42% | 8.33% | −2.33 | −1.25 |
| | Ex. 12A | | | | | |
| | Allulose | 25% | 62.50% | 12.50% | −0.89 | −1.47 |
| | 3.9% | | | | | |
| Sweetness | Comp. | 14.58% | 79.17% | 6.25% | −1.74 | −0.36 |
| | Ex. 12A | | | | | |
| | Allulose | 29.17% | 62.50% | 8.33% | −0.76 | −0.58 |
| | 3.9% | | | | | |

The allulose prototype was parity to the full calorie control for all acceptability measures. The allulose ice cream prototype at 3.9% meets the action standard of parity acceptability to control high fructose corn syrup ice cream. Based on JAR analysis, the allulose prototype did receive a higher percentage of panelists stating too low on texture and sweetness attributes relative to control, but this did not significantly impact any of the acceptability attributes.

Flavored ice creams were prepared according to the composition shown in Table 22.

TABLE 22

| | Comparative | |
|---|---|---|
| Chocolate Ice Cream Mix | Example 12B | Example 12c |
| Ingredients | % | % |
| Cream 36% BF | 27.73 | 27.73 |
| Fluid Milk, Skim | 44.45 | 43.46 |
| Lo Heat NFDM | 3.11 | 3.2 |
| Allulose, 77DS | 0 | 8 |
| Sucrose | 6.21 | 3.01 |
| HFCS | 3.9 | 0 |
| Staley 300 | 9.4 | 9.4 |
| Cocoa Powder 10/12 | 2.9 | 2.9 |
| Stabilizer | 2.3 | 2.3 |
| Total | 100 | 100 |
| Pounds/Gallon | 9.36 | 9.37 |
| Solids % | 40.20% | 40.47% |
| Butterfat | 10% | 10% |
| MSNF | 8.50% | 8.50% |

### Example 13

### Ice Creams

Sweetened ice creams were prepared in accordance with Table 23:

TABLE 23
Stablizer formulation:

| | |
|---|---|
| Aqualon CMC 7HF | 44.20 |
| Rezista | 5.00 |
| Staleydex 333 | 9.99 |
| CCCS#3 Carrageenan | 0.01 |
| Alphadim 70K | 44.20 |
| | 100 |

| | Comparative | Comparative | |
|---|---|---|---|
| | Example 13A: | Example 13B: | Example 13: |
| Cream, 36% Butterfat | 33.27 | 33.27 | 33.27 |
| Milk, skim | 42.56 | 41.44 | 41.78 |
| Non-fat dry milk powder | 4.53 | 4.63 | 4.60 |
| HFCS 42 | 0 | 3.52 | 0 |
| Allulose | 0 | 0 | 3.21 |
| Corn Syrup (36DE) | 9.38 | 9.38 | 9.38 |
| Sucrose, granulated | 10.00 | 7.50 | 7.50 |
| Stabilizer | 0.26 | 0.26 | 0.26 |
| | 100 | 100 | 100 |
| % Solids | 39.76 | 39.76 | 39.76 |
| lbs./gal | 9.54 | 9.55 | 9.55 |
| % Butterfat | 12.00 | 12.00 | 12.00 |
| % MSNF | 10.00 | 10.00 | 10.00 |

### Method:

1. The dry ingredients were pre-blended: Stabilizer, non-fat dry milk powder.
2. The liquid sweeteners were pre-blended: Allulose, corn syrup and liquid sucrose.
3. The liquid sweeteners were added to the fluid milk under moderate agitation (likwifier).
4. The dry ingredients were added to the milk under moderate agitation (likwifier) to ensure proper dispersion.
5. The mixture was pasteurized at 195° F. (91° C.) for 30 seconds.
6. The mixture was homogenized at 2500 psi (500 second stage and 2000 first stage) (approx. 17 MPa; 3.3 MPa second stage and 13.7 MPa second stage).
7. The mixture was refrigerated, mixed and aged overnight.
8. David Michael N&A Vanilla #26218 was added in an amount of 3 fl. oz. per 10 gallons ice cream mix (approx. 90 mL per 38 L).
9. The ice cream was frozen at 20° F. (−7° C.) to 70% overrun.
10. The ice cream was packaged and stored at −20° F. (−29° C.).

### Cryoscope Freezing Point Depression Analysis:

The freezing point depression of the sweetened ice cream mixes was analytically determined by cryoscopy (Advanced Instruments Inc., Cryoscope Model 4250, Norwood, Mass.). The procedure was:
The cryoscope was calibrated according to the User's Guide
A 530 m°H (degrees milli Horvet) calibration standard was run five times.
Each of the ice cream mixes was tested undiluted five times.
A 1:1 dilution of the ice cream mixes was tested five times.
A 1:2 dilution of the ice cream mixes was tested five times.
The results were recorded.

Cryoscopy testing the ice cream mixes undiluted generated a “Sample Did Not Freeze, Repeat Test” error message. The 1:1 and 1:2 ice cream mix dilutions were able to be tested without error. Given the 1:2 dilution results were closer to the calibration point of 530 m°H, those results were considered more accurate (lower standard deviations) than the 1:1 dilution results. Results were then converted from milli degrees Horvet to degrees Celsius.

The results are shown in Tables 24A and 24B:

TABLE 24A

| | Comparative | Comparative | |
|---|---|---|---|
| | Example 13A: | Example 13B: | Example 13: |
| | m° H | m° H | m° H |
| Test 1 | 578 | 632 | 628 |
| Test 2 | 576 | 630 | 628 |
| Test 3 | 574 | 635 | 630 |
| Test 4 | 575 | 631 | 631 |
| Test 5 | 576 | 631 | 626 |
| Average | 575.8 | 631.8 | 628.6 |
| Standard Deviation | 1.48 | 1.92 | 1.95 |

¹ Reported results are from the ice cream mixes diluted 1:2

TABLE 24B
Average freezing temperatures of the ice cream mixes from
Table 24A converted from m° H to ° C.¹.

| Comparative Example 13A: | Comparative Example 13B: | Example 13: |
|---|---|---|
| ° C. | ° C. | ° C. |
| −1.67 | −1.83 | −1.81 |

¹m° C. = m° H * 0.9656

### Temperature Cycling/Heat Shocking:

This test was carried out after packaging the ice cream into 3 fl. oz. (89 mL) single serve containers and placing it into a −20° F. (−29° C.) freezer for 24 hours.

In order to evaluate potential shelf life changes, the ice creams were subjected to heat shock conditions of fluctuations in storage temperatures using a programmable freezing chamber. A common set of condition parameters (On Ice Cream, Tharp & Young 2012) involves setting the freezing chamber to temperatures that fluctuate between 5° and −20° F. (−15° C. and −29° C.) twice in a 24-hour period for a total time of 72-96 hours. Samples were tempered to 0-5° F. (−18° C. to −15° C.) before being evaluated.

### Sensory Analysis:

Heat shocked and non-heat shocked sweetened ice cream samples were evaluated by a practiced dairy panel using the scoring guidelines established by the American Dairy Science Association (ADSA). The ADSA grading system evaluates various attributes of ice cream. Attributes evaluated were flavor, body and texture. The ice cream cups were labeled with 3-digit blinding codes.

Additionally, a full sensory panel (n=48) evaluated heat shocked and non-heat shocked sweetened ice cream samples. Affective testing using a 9-point hedonic scale and just-about-right (JAR) scales was conducted. The products were randomized and presented monadically at freezer temperature. The ice cream cups were labeled with 3-digit blinding codes; a two minute waiting period between tests was employed to clear the panelists' palates between samples. The large panel sensory evaluation judged the heat shocked and non-heat shocked sweetened ice creams on the following attributes:
Overall acceptability
Appearance acceptability
   Color
   Visual Iciness
Texture acceptability
   Creaminess
   Smoothness
   Iciness
Flavor acceptability
   Overall flavor strength
   Sweetness

The full panel results are shown in Table 25:

TABLE 25

| | Comparative | Comparative | Example | Example |
|---|---|---|---|---|
| | Example 13B: | Example 13B: | 13: | 13: |
| | Non-heat | Heat | Non-heat | Heat |
| | Shocked | Shocked | Shocked | Shocked |
| Overall | 6.4^{a} | 6.58^{a} | 6.79^{a} | 6.65^{a} |
| Acceptance | | | | |
| Appearance | 6.5^{a} | 6.27^{a} | 6.42^{a} | 6.52^{a} |
| Acceptance | | | | |
| Texture | 6.48^{a} | 6.42^{a} | 6.44^{a} | 6.56^{a} |
| Acceptance | | | | |
| Flavor | 6.42^{a} | 6.38^{a} | 6.46^{a} | 6.48^{a} |
| Acceptance | | | | |

¹Level of significance for the grouping (Duncan): 5%

### Discussion and Conclusions:

Sensory evaluation by the trained panel detected a texture/body difference between the heat shocked and non-heat shocked ice creams. Texture scoring was evaluated on a 5 point scale with a score of 5 representing no detectable ice crystals and a score of 1 signifying pronounced iciness. All non-heat shocked ice creams (Comparative Examples 13A and 13B and Example 13) were judged to have a texture score of 5. All heat shocked ice creams were given the texture score of 4, as slight iciness was detected. On a 10 point flavor scale, all samples, regardless of sweetener or heat shock were given a score of 8. A slight corn syrup note was detected in all the ice creams. Additionally, the ice cream of Comparative Example 13B was noted to have a slight metallic aftertaste and the ice cream of Example 13 was judged to possess a slight lingering caramel flavor.

The large untrained sensory panel found no significant differences in overall acceptability between the heat shocked and non-heat shocked ice cream samples for any of the ice creams as well as no significant differences across all codes. Additionally, there were also were no significant differences between any of the codes for all of the other acceptability scores.

In industry, temperature cycling (heat shocking) is typically done for 72-96 hours and in pint (473 mL), 1.5 L, or 1.75 L packages. For this study, the ice cream was temperature cycled for 96 hours and packaged in 3 fl. oz. (89 mL) containers. Unfavorable texture changes due to temperature cycling tend to be more pronounced and/or detected earlier in smaller size packages. The smaller volume package serves to create a harsher environment that would promote an icy texture. Given that only the trained panel detected the difference between the heat shocked and non-heat shocked ice creams and no difference between the ice cream of Example 13 and Comparative Example 13B, it has been clearly shown that allulose can replace HFCS very effectively in frozen ice cream applications.

Cryoscopic analysis of the ice cream mixes of Example 13 and Comparative Example 13B revealed nearly identical freezing point depression results (Tables 24A and 24B).

### Example 14

### Ice Creams

Ice cream was prepared according to the composition shown in Table 26 as a comparative example:

TABLE 26
Comparative Example 14:

| Ingredients | Content (weight %) | Batch Formulation (lbs) |
|---|---|---|
| 42% Cream | 23.75 | 2201.88 |
| Skim Milk | 45.72 | 4238.57 |
| Nonfat Dry Milk Powder | 4.90 | 453.83 |
| Liquid Sugar | 17.78 | 1648.02 |
| 36DE Corn Syrup | 7.50 | 695.25 |
| Stabilizer* | 0.35 | 32.45 |
| Total: | 100.00 | 9270.00 (1000 gallons) |
| Solids content: | | |
| Butterfat | 10.00 | |
| MSNF | 10.00 | |
| Sucrose | 12.00 | |
| 36DE Corn Syrup | 6.00 | |
| Stabilizer* | 0.35 | |
| Total Solids: | 38.35 | |

### Method:

1. The cream, milk, and nonfat dry milk were standardized and blended to the desired butterfat and MSNF level.
2. The sugar and corn syrup were blended with the stabilizer using moderate agitation to ensure proper dispersion.
3. The liquid sugar mixture was mixed with the milk mixture using moderate agitation to ensure proper dispersion.
4. The mixture was pasteurized at 185° F. (85° C.) for 30 seconds or the equivalent time and temperature.
5. The mixture was double stage homogenized at 2500 psi (2000 psi+500 psi, first and second stage respectively; 17.2 MPa; 13.8 MPa+3.4 MPa).
6. The product was cooled to 36° F.-40° F. (2° C.-4.4° C.) and allowed to age for a minimum of 4 hours (overnight aging is preferred).
7. The product was frozen to the desired overrun (˜90%).

Ice creams according to the invention were prepared according to the compositions shown in Tables 27-28:

TABLE 27
Example 14A:

| Ingredients | Content (weight %) | Batch Formulation (lbs) |
|---|---|---|
| 42% Cream | 23.750 | 2199.62 |
| Skim Milk | 52.376 | 4849.59 |
| Nonfat Dry Milk Powder | 4.280 | 396.39 |
| Krystar ™ 300 | 1.750 | 162.05 |
| Crystalline Fructose | | |
| Soluble corn fiber 85 | 10.967 | 1015.54 |
| Allulose, 77 ds | 6.494 | 601.34 |
| Stevia extract¹ | 0.022 | 2.04 |
| Monk fruit extract² | 0.011 | 1.02 |
| Stabilizer* | 0.350 | 32.41 |
| Total: | 100.000 | 9260.00 (1000 gallons) |
| Solids content: | | |
| Butterfat | 10.000 | |
| MSNF | 10.000 | |
| Krystar ™ 300 | 1.750 | |
| Crystalline Fructose | | |
| Soluble corn fiber 85 | 10.967 | |
| Allulose | 5.000 | |
| Stevia extract¹ | 0.022 | |
| Monk fruit extract² | 0.011 | |
| Stabilizer* | 0.350 | |
| Total Solids: | 38.100 | |

TABLE 28
Example 14B:

| Ingredients | Content (weight %) | Batch Formulation (lbs) |
|---|---|---|
| 42% Cream | 23.750 | 2201.98 |
| Skim Milk | 51.440 | 4768.31 |
| Nonfat Dry Milk Powder | 4.370 | 404.82 |
| Soluble corn fiber 85 | 10.954 | 1015.44 |
| Allulose, 77 ds | 9.090 | 842.74 |
| Stevia extract¹ | 0.031 | 2.87 |
| Monk fruit extract² | 0.015 | 1.39 |
| Stabilizer* | 0.350 | 32.45 |
| Total: | 100.000 | 9270.00 (1000 gallons) |
| Solids content: | | |
| Butterfat | 10.000 | |
| MSNF | 10.000 | |
| Soluble corn fiber 85 | 10.954 | |
| Allulose | 7.000 | |
| Stevia extract¹ | 0.031 | |
| Monk fruit extract² | 0.015 | |
| Stabilizer* | 0.350 | |
| Total Solids: | 38.350 | |

*Stabilizer: Mono & Diglycerides, Guar Gum, Calcium Sulfate, Cellulose Gum, Locust Bean Gum, Carrageenan, Standardized with Dextrose.
¹TASTEVA ™ (available from Tate & Lyle) was used as the stevia extract.
²PUREFRUIT ™ Select (available from Tate & Lyle) was used as the monk fruit extract.

### Method:

1. The cream, milk, and nonfat dry milk were standardized and blended to the desired butterfat and MSNF level.
2. The allulose syrup was blended with the stabilizer and a small amount of the above milk mixture (approximately 1:1 v/v with the syrup) was added to form a slurry.
3. The soluble corn fiber, sweeteners and fructose (if used) were added to the allulose slurry and the resulting mixture was mixed to allow all components to solubilize.
4. The remaining milk mixture was combined with the allulose mixture and mixed using moderate agitation to ensure proper dispersion.
5. The mixture was pasteurized at 185° F. (85° C.) for 30 seconds or the equivalent time and temperature.
6. The mixture was double stage homogenized at 2500 psi (2000 psi+500 psi, first and second stage respectively; 17.2 MPa; 13.8 MPa+3.4 MPa).
7. The product was cooled to 36° F.-40° F. (2° C.-4.4° C.) and allowed to age for a minimum of 4 hours (overnight aging is preferred).
8. The product was frozen to the desired overrun (˜90%).

Note: If a liquid SCF syrup is used and/or a liquid fructose is used, then these components may be added in above step 2. In this case, it may not be necessary to add any of the milk mixture in step 2 to form the slurry.

### Results:

The finished ice creams according to Comparative Example 14 and Examples 14A and 14B were found to have a similar Sweetness Equivalence, a similar freezing point and similar eating characteristics. Thus, significant sugar and calorie reduction was achieved without compromising the functional properties of ice cream.

### Snack Bars

### Example 15

### Cereal Bars

Cereal bars were prepared according to the compositions shown in Table 29.

TABLE 29

| | Comparative | |
|---|---|---|
| | Example 15 | Example 15a |
| | (%) | (%) |
| Dries Content | | |
| Viterra coated Oats 1011 | 42.80 | 42.80 |
| Crisp Rice PGP WG | 11.60 | 11.60 |
| Craisins | 8.00 | 8.00 |
| Dries Total | 62.40 | 62.40 |
| Syrup Content | | |
| Neto 7350 | 20.73 | 0.00 |
| HFCS 100 | 2.00 | 0.00 |
| Glycerine | 4.00 | 4.00 |
| ALLULOSE, 89DS | 0.00 | 19.00 |
| Sugar | 3.80 | 3.73 |
| Salt | 0.37 | 0.37 |
| Corn syrup solids, 20 DE | 3.00 | 3.00 |
| Water | 1.50 | 4.00 |
| Sunflower Oil | 3.20 | 3.20 |
| Lecithin | 0.10 | 0.10 |
| Vanilla Flavor GV Le-996-223-4 | 0.20 | 0.20 |
| Syrup Total | 37.60 | 37.60 |
| TOTAL | 100.00 | 100.00 |

The dried material was weighed out and placed into a Hobart bowl that was sprayed with a non-stick spray. The ingredients were mixed for 20 seconds. In order to make the syrup content, water and glycerine were weighed into a bowl with and heated (120° F.) over a double boiler. Pre-blended sugar, corn syrup solids and salt were then slowly added to this mixture. The mixture was then heated to 130° F. while mixing continuously. Following this, lecithin was added to oil, and the resultant oil mixture was added to the syrup mixture, followed by the addition of flavor. Next, the desired amount of syrup was weighed out into a Hobart bowl with granola, rice and fruits and mixed for 30 seconds. Bars were formed by preparing the baking sheet by spraying with non-stick spray and setting up spacer with C-clamps. The mixture was spread from the Hobart bowl evenly into pan, pressing down to smooth out and compressing with a rolling pin until product forms a smooth slab. The slab was allowed to cool for 4 hours and cut into the desired bar sizes. A 500 gram batch contains 312 grams of dries content and 188 grams of syrup content.

The resulting bars were taste tested by a round panel of expert tasters. The expert tasters agreed that the bars made with allulose were slightly sweeter and had preferred taste to the control bars.

### Example 16

### Granola Bar

Chewy granola bars were prepared according to the composition shown in Table 30:

TABLE 30

| | Comparative | |
|---|---|---|
| | Example 16 | Example 16 |
| Ingredients | % | % |
| Toasted Coated Oats, 21C Viterra 1011 | 40.00 | 41.00 |
| Cranberries, dried, finely chopped | 7.50 | 7.50 |
| Rice crisp | 11.60 | 11.60 |
| Sugar | 3.80 | 2.70 |
| STAR-DRI ® 200 corn syrup solids | 3.00 | 0.00 |
| TAPIOCA DEXTRIN 12 | 0.00 | 3.80 |
| Canola oil | 3.20 | 3.20 |
| Soy lecithin | 0.10 | 0.10 |
| NETO ® 7350 corn syrup | 20.73 | 12.03 |
| ISOSWEET 100 HFCS | 3.50 | 0.00 |
| Allulose, 78% DS (Tate & Lyle) | 0.00 | 16.00 |
| Glycerin | 4.50 | 0.00 |
| water | 1.50 | 1.50 |
| Salt | 0.37 | 0.37 |
| Vanilla flavor, Givaudan LF996-223-4 | 0.20 | 0.20 |
| Sucralose | 0.00 | 0.004 |
| Liquid sucralose (25% solution) | 0.00 | 0.016 |
| Total | 100.00 | 100.00 |

The chewy granola bars were prepared according to the following procedure:

The cranberries, oats and rice crisps were pre-blended in a mixer (Hobart) for 30 seconds on speed 1 with a paddle attachment and set aside. Separately, the water, corn syrup, allulose/sucralose/liquid sucralose (according to recipe), high fructose corn syrup and glycerin were pre-blended with a spatula in a cooking pot and heated to 140° F. (60° C.).

A pre-blended mixture of sugar, STAR-DRI® 200/TAPIOCA DEXTRIN 12 and salt was slowly added to the syrup mixture and mixed well for 5 minutes to prepare a homogeneous slurry without lumps. Heating was continued to 170° F. (77° C.). A pre-blended mixture of oil and lecithin was then added, and the mixture was blended thoroughly for 1 minute.

The syrup was added to the pre-blended mixture of oats, rice crisp and cranberries in a mixer (Hobart) bowl. The paddle attachment was lightly sprayed with cooking spray to prevent sticking, and the mixture was mixed thoroughly for 1 minute and 30 seconds on speed 1 to coat all particulates with the binder syrup.

The granola mixture was deposited on a flat sheet pan that has been lightly sprayed with cooking spray and compressed in a confined space to ¾ of an inch (2 cm) in thickness using a rolling pin until compact. The granola was then cut to the desired size and packaged.

The targeted water activity and Brix for the granola bars are shown in Table 31:

TABLE 31
Targets

| | Aw | Brix |
|---|---|---|
| Comparative | 0.4632 | 81 |
| Example 16 | | |
| Example 16 | 0.4952 | 82 |

### Nutritional Information:

A 40 g serving of a granola bar according to Example 16 was found to contain 140 calories while a 40 g serving of a granola bar according to Comparative Example 16 was found to contain 160 calories. The granola bar according to Example 16 thus provided significant calorie reduction.

### Texture Analysis:

The hardness of the bars was tested with a TA-42 Knife Probe with a 45° chisel blade. The bars were placed directly on the TA.XT2i base platform. The knife traveled downward until the TA.XT2i detected 15 grams of force, at which point the knife blade advanced 8.0 mm into the bars at a speed of 3.0 mm/second. The probe withdrew at 10.0 mm/second. The results in Table 32 are the averages of five test replicates for each bar:

TABLE 32
Standard Deviation

| | Hardness | Brittleness/ | Toughness |
|---|---|---|---|
| | g Force | Flexibility mm | g/sec |
| Comparative Ex. | 894.86 ± 228.92 | 85.85 ± 1.63 | 227.65 ± 72.09 |
| 16: Day Zero | | | |
| Ex. 16: Day Zero | 778.82 ± 226.04 | 85.73 ± 1.66 | 227.65 ± 70.01 |
| Comparative Ex. | 1067.05 ± 312.16 | 90.16 ± 0.84 | 423.24 ± 123.18 |
| 16: Month 1 | | | |
| Ex. 16: Month 1 | 1372.75 ± 176.92 | 87.92 ± 1.53 | 542.49 ± 70.27 |

### Informal Sensory Test Month 1:

An affective test was completed using a 9-point scale. The test was rated with number 1 being the lowest rating and number 9 being the highest rating. The bars were served in 4 ounce (100 g) soufflé cup to give enough product for testing. Cups were blind labeled as sample 1 (Example 16) and sample 2 (Comparative Example 16):

| Sample 1 | | Sample 2 | |
|---|---|---|---|
| Lowest | Highest | Lowest | Highest |

| | | | |
|---|---|---|---|
| 1. | Color acceptability | 1 2 3 4 5 6 7 8 9 | 1 2 3 4 5 6 7 8 9 |
| 2. | Aroma acceptability | 1 2 3 4 5 6 7 8 9 | 1 2 3 4 5 6 7 8 9 |
| 3. | Flavor acceptability | 1 2 3 4 5 6 7 8 9 | 1 2 3 4 5 6 7 8 9 |
| 4. | Sweetness acceptability | 1 2 3 4 5 6 7 8 9 | 1 2 3 4 5 6 7 8 9 |
| 5. | Texture acceptability | | |

| | | |
|---|---|---|
| Moistness | 1 2 3 4 5 6 7 8 9 | 1 2 3 4 5 6 7 8 9 |
| Chewiness | 1 2 3 4 5 6 7 8 9 | 1 2 3 4 5 6 7 8 9 |
| Hardness | 1 2 3 4 5 6 7 8 9 | 1 2 3 4 5 6 7 8 9 |

| | | | |
|---|---|---|---|
| 6. | Overall acceptability | 1 2 3 4 5 6 7 8 9 | 1 2 3 4 5 6 7 8 9 |

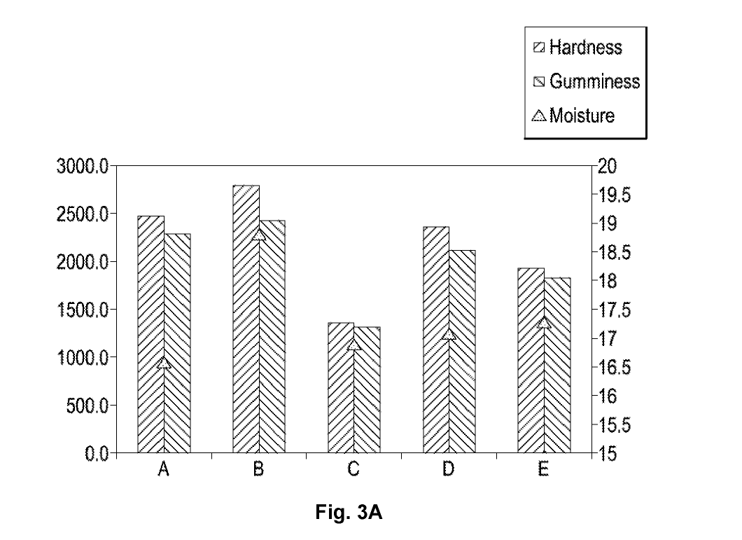

The results are shown in FIG. 2.

### Formal Sensory Test:

Affective testing using a 9-point hedonic scale and just-about-right (JAR) scales was conducted with 40 panelists. The products were randomized and presented monadically. After the 1st sample was completed, panelists returned any remaining sample prior to panelists receiving their 2nd sample. The bars were served in 4 ounce (100 g) soufflé cups to give the panelists ample product for testing. The panelists were instructed to consume enough of the sample to answer each question. Cups were labeled with 3-digit blinding codes. There was a three minute enforced waiting period between tests to clear the panelists' palates. RO water and unsalted crackers were available for the panelists to clear their palates before and during testing.

### Questions:

Overall acceptability
Appearance acceptability
   Color
Aroma acceptability
   Overall aroma strength
Flavor acceptability
   Overall flavor strength
   Granola Flavor
   Sweetness
Texture acceptability
   Moistness
   Chewiness
   Hardness

Results of the formal sensory analysis are shown in Table 33:

TABLE 33

| | Comparative Example 16 | Example 16 |
|---|---|---|
| OVERALL acceptance | 6.4^{a} | 6.15^{a} |
| Appearance Acceptance | 6.6^{a} | 6.42^{a} |
| Aroma Acceptance | 6.28^{a} | 5.92^{b} |
| Texture Acceptance | 6.47^{a} | 5.92^{b} |

Friedman's test

### Conclusions:

It has been shown that allulose can replace nutritive sweetener in a granola bar while achieving parity of sensory results. Furthermore, it has been shown that the incorporation of allulose into a granola bar can reduce the extent of hardening over time, i.e. allulose provides an anti-staling effect. Thus, allulose may be used to extend the life of granola bars.

### Carbonated Beverages

### Example 17

### Carbonated Beverages

Carbonated beverages were prepared using either full calorie syrup (Comparative Example 17) or allulose syrup (Example 17) as the sweetening agent. The composition of the prepared beverages is shown in Table 34.

TABLE 34

| | | Full Calorie | | Allulose |
|---|---|---|---|---|
| | Full | Beverage | | sweetened |
| | Calorie | (Comparative | Allulose | beverage |
| | Syrup | Example 17) | Syrup | (Example 17) |
| INGREDIENT | % | % | % | % |
| Isosweet 5500 | 72.0 | 14.4 | 0.00 | 0.00 |
| Allulose, 89DS | 0.00 | 0.00 | 98.675 | 19.735 |
| Citric acid | 0.625 | 0.13 | 0.625 | 0.13 |
| Lemon Lime Flavor | 0.30 | 0.060 | 0.450 | 0.090 |
| Sodium Citrate | 0.150 | 0.030 | 0.150 | 0.030 |
| Sodium Benzoate | 0.10 | 0.02 | 0.10 | 0.02 |
| Water | 26.83 | 85.37 | 0.00 | 80.0 |
| TOTAL | 100 | 100 | 100 | 100 |

To prepare the syrup formulas, sodium benzoate was first dissolved in water or allulose syrup using a propeller mixer. The remaining ingredients were added in accordance with the amounts listed in Table 34 and mixed until dissolved. The syrup was then combined with carbonated water in a 1:4 ratio. The solutions were then refrigerated.

These carbonated beverages were compared for preference and tasted by a panel of expert tasters. The beverages of Example 17 and Comparative Example 17 were difficult to distinguish. In particular, Example 17 did not have the defects in taste normally found in diet carbonated soft drinks containing high potency sweeteners with low calories. This is the first example of a low calorie carbonated soft drink with the sweetness quality of a full calorie carbonated soft drink.

### Confectionary Products

### Example 18

### Gelatin Jelly Confectionaries (Gummies)

### Gelatin Solution:

A gelatin solution was prepared according to Table 35:

TABLE 35
Gelatin solution:

| Ingredient name | Supplier | % (cp) | Weight |
|---|---|---|---|
| Water | City water | 33.30% | 833 g |
| Gelatin 250 bloom | WEISHARDT | 66.70% | 1668 g |
| | TOTAL | 100.00% | 2500 g |

### Syrups:

Syrups were prepared according to the following Tables 36-40:

TABLE 36
Sugar reference syrup A:

| Ingredient | | % | | % ingr | % total |
|---|---|---|---|---|---|
| name | Supplier | (cp) | Weight | (ds) | ds |
| Water | City water | 13.73% | 163 g | 0 | 0 |
| Sugar | SAINT LOUIS | 38.66% | 460 g | 38.66 | 49.90 |
| Glucose | T&L | 47.62% | 567 g | 38.81 | 50.10 |
| syrup | | | | | |
| GLUCAMYL | | | | | |
| S661 | | | | | |
| | TOTAL | 100.00% | 1190 g | 77.46 | |

TABLE 37
Sugar-free reference syrup B:

| Ingredient | | % | | % ingr | % total |
|---|---|---|---|---|---|
| name | Supplier | (cp) | Weight | (ds) | ds |
| Water | City water | 0 | 0 | 0 | 0 |
| Maltitol | ROQUETTE | 100.00% | 1300 g | 75.2 | 100 |
| Syrup | | | | | |
| Lycasin | | | | | |
| | TOTAL | 100.00% | 1300 g | 75.2 | |

TABLE 38
40% allulose syrup C:

| Ingredient | | % | | % ingr | % total |
|---|---|---|---|---|---|
| name | Supplier | (cp) | Weight | (ds) | ds |
| Water | City water | 13.48% | 150 g | 0 | 0 |
| Sugar | SAINT LOUIS | 44.92% | 500 g | 44.92 | 59.67 |
| Allulose | T&L | 41.60% | 463 g | 30.37 | 40.33 |
| | TOTAL | 100.00% | 520 g | 75.29 | |

TABLE 39
30% allulose syrup D:

| Ingredient | | % | | % ingr | % total |
|---|---|---|---|---|---|
| name | Supplier | (cp) | Weight | (ds) | ds |
| Water | City water | 15.59% | 177 g | 0 | 0 |
| Sugar | SAINT LOUIS | 52.86% | 600 g | 52.86 | 69.66 |
| Allulose | T&L | 31.54% | 358 g | 23.03 | 30.34 |
| | TOTAL | 100.00% | 1135 g | 75.89 | 100 |

TABLE 40
Allulose/polydextrose syrup E:

| Ingredient | | % | | % ingr | % total |
|---|---|---|---|---|---|
| name | Supplier | (cp) | Weight | (ds) | ds |
| Water | City water | 11.79% | 127 g | 0 | 0 |
| Sugar | SAINT LOUIS | 23.21% | 250 g | 23.21 | 33.62 |
| Allulose | T&L | 32.50% | 350 g | 23.72 | 34.36 |
| Hydrogenated | T&L | 32.50% | 350 g | 22.10 | 32.01 |
| polydextrose | | | | | |
| | TOTAL | 100.00% | 1135 g | 75.89 | 100 |

### Preparation of Jellies:

The composition of the jellies is shown in Tables 41a and 41b:

TABLE 41a
Jelly composition:

| Ingredient name | % (cp) |
|---|---|
| Cooked syrup (A, B, C, D, E) | 79.98% |
| Gelatin solution | 18.00% |
| Citric acid solution 50% | 1.80% |
| Orange flavor Silesia 1118106003 | 0.22% |
| TOTAL | 100.00% |

TABLE 41b
Coated jelly composition:

| Ingredient name | % (cp) |
|---|---|
| Demoulded jellies | 99.90% |
| Coating agent: vegetable oil, beeswax, | 0.10% |
| carnauba wax | |
| TOTAL | 100.00% |

The jellies were prepared according to the following protocol.

The tools were placed in an incubator to warm them for 15 h at 60° C. The sweeteners were also placed in an incubator to warm them for 15 h before use at 60° C. The moulding starch was placed in trays and dried. A gelatin solution was prepared by dissolving gelatin in boiled water, mixing, and letting it swell, and was then stored at 70° C. in a water bath.

The water and sweeteners were poured into the bowl of a mixer (YSTRAL) to form a slurry. Mixing was commenced and the mix was cooked on an induction plate at around 116° C. The cooking parameters for the different syrups are shown in Table 42:

TABLE 42

| | Cooking step | |
|---|---|---|
| Syrup | Temperature (° C.) | Duration |
| A | 116 | Cooking stopped |
| B | 120 | when targeted brix |
| C | 135 | (85%) was reached |
| D | 136 | |
| E | 135 | |

When the desired temperature was reached (116° C.-135° C. according to the sweetener), cooking was stopped and the syrup was allowed to cool to around 90° C. It was important to ensure that the mixture was cooled down before the gelatin solution was added to avoid denaturation of the gelatin.

The syrup was weighed and the gelatin solution was added at around 90° C. while stirring with a spoon. The mixture was allowed to stand for 10 minutes, during which any scum formed on the top of the gel was removed with a spoon.

Flavor was added and then citric acid solution at 50% (18 g/1000 g) was added for acidification. The mixture was stirred manually to get a good solution which was then poured into the starch impressions of pre-warmed (30-35° C.) depositors. The trays were placed at the same time in the climate chamber of an oven for drying at ambient temperature for 48 h. The jellies were demolded from the starch and were then oiled with pan oil gum gloss AB6901.

### Results:

The finished jellies were analyzed with respect to a number of characteristics, as detailed below.

The moisture content of the jellies is given in Table 43:

TABLE 43

| Recipe (according to syrup used) | Moisture |
|---|---|
| A | 16.6 +/− 0.7% |
| B | 18.8 +/− 0.1% |
| C | 16.9 +/− 0.3% |
| D | 17.1 +/− 0.08% |
| E | 17.3 +/− 0.4% |

The color of the jellies is given in Table 44:

TABLE 44

| Recipe (according to syrup used) | Yellowness | Whiteness |
|---|---|---|
| A | 25.67 | −52.71 |
| B | 25.06 | −43.44 |
| C | 59.93 | −163.33 |
| D | 44.08 | −117.45 |
| E | 46.82 | −126.13 |

Texture profile analysis of the jellies was carried out 15 days after production. The parameters for a first set of compression tests were as follows:
T.A. Variable No: 1: Compression
Pre-Test Speed: 1.0 mm/sec
Test Speed: 2.0 mm/sec
Post-Test Speed: 2.0 mm/sec
T.A. Variable No: 5: 0.0 g
Target Mode: Strain
Distance: 10.0 mm
Strain: 50.0%
Trigger Type: Auto (Force)
Trigger Force: 20.0 g
Probe: P/50 (50 mm DIA CYLINDER ALUMINIUM)

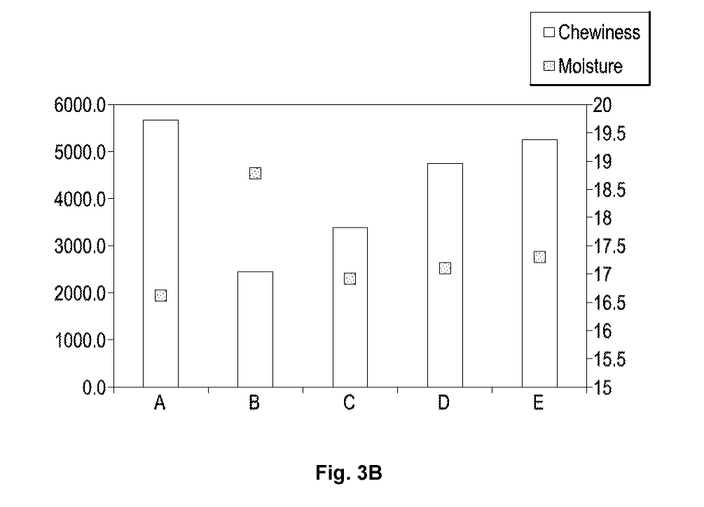

The results are shown in FIGS. 3A and 3B.

The parameters for a second set of compression tests were as follows:
Test Mode: Compression
Pre-Test Speed: 1.0 mm/sec
Test Speed: 1.0 mm/sec
Post-Test Speed: 10.0 mm/sec
T.A. Variable No: 5: 0.0 g
Target Mode: Distance
Distance: 5.0 mm
Strain: 10.0%
Trigger Type: Auto (Force)
Trigger Force: 5.0 g
Probe: P/2 (2 mm DIA CYLINDER STAINLESS)

According to these tests, “Hardness” was the peak force of the first compression of the product, or force needed to penetrate to the chosen distance (see above), and “Stickiness” was the force necessary to withdraw the probe from the gum. In order to measure the stickiness successfully, the samples were held down with a confectionery holder.

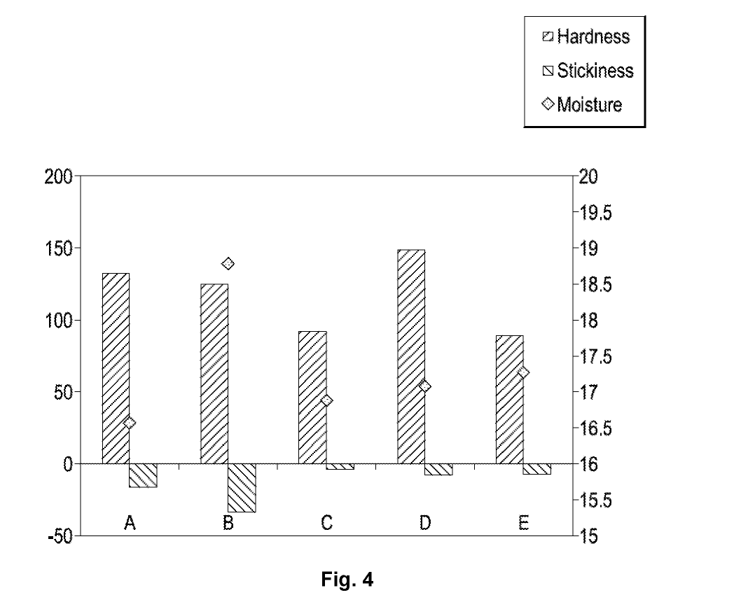

The results are shown in FIG. 4.

Informal sensory testing was also carried out with a four-person panel. The results are shown in Table 45:

TABLE 45

| Recipe (According | | | |
|---|---|---|---|
| to syrup used) | Aspect | Texture | Taste |
| A | OK | Firm & dense, | Sweet |
| | | elastic & | |
| | | chewy | |
| B | Sticky, | Soft | The least sweet |
| | hygroscopic | | among the 5 |
| | | | samples |
| C | OK | Chewy, even | Sweeter compared |
| | | more than A | to A |
| D | OK | A little bit | Sweeter than C |
| | | less | and A, sweetness |
| | | chewy than C | more quickly |
| | | | present in mouth |
| E | OK | Less chewy | Good sweetness |
| | | than C & D, | |
| | | interesting | |
| | | texture | |

In terms of storage behaviour, it was found that the recipes based on syrups C and D began to crystallize after 20 days. The reference recipes A and B, and recipe E, did not.

### Conclusions:

The use of allulose to prepare gelatin-based jellies presents no problems in terms of processing. The resulting jellies are yellower in colour than the reference jellies and display some differences in terms of texture profile and sensory data.

The results show that acceptable jellies can be produced with varying allulose content. The results also show that the incorporation of a bulking agent (such as polydextrose) in jellies sweetened with allulose improves storage characteristics (e.g. in terms of crystallization), provides a chewiness which is close to that of a sugar reference, and provides good sweetness.

### Example 19

### Gelatin Gummy Candies

Gelatin gummy candies comprising allulose were investigated. Candies including PDX (Example 19A), candies with complete sucrose replacement (Example 19B) and candies with complete corn syrup replacement (Example 19C) were prepared.

### Recipes:

Control and test candies were produced according to the formulas described in Tables 46A, 46B and 47:

TABLE 46A

| | Control | | | Example 19A | | |
|---|---|---|---|---|---|---|
| Ingredient | % | DS | Batch/g | % | DS | Batch/g |
| STALEY 1300 | 46.07 | 36.99 | 774.00 | 38.48 | 30.90 | 646.50 |
| (RTM) Corn | | | | | | |
| Syrup, 43 DE | | | | | | |
| Gelatin 250 bloom | 5.36 | 4.82 | 90.00 | 5.36 | 4.82 | 90.00 |
| Water | 10.71 | 0.00 | 180.00 | 10.71 | 0.00 | 180.00 |
| Sucrose | 28.57 | 28.57 | 480.00 | 13.25 | 13.25 | 222.60 |
| Water | 9.29 | 0.00 | 156.00 | 5.41 | 0.00 | 90.90 |
| Allulose (77 DS) | 0.00 | 0.00 | 0.00 | 22.32 | 17.19 | 375.00 |
| STA-LITE III | 0.00 | 0.00 | 0.00 | 4.46 | 4.24 | 75.00 |
| (RTM) Polydextrose | | | | | | |
| TOTAL: | 100.00 | 70.38 | 1680.00 | 100.00 | 70.40 | 1680.00 |

TABLE 46B

| | Example 19B | | | Example 19C | | |
|---|---|---|---|---|---|---|
| Ingredient | % | DS | Batch/g | % | DS | Batch/g |
| STALEY 1300 | 46.07 | 36.99 | 774.00 | 0.00 | 0.00 | 0.00 |
| (RTM) Corn | | | | | | |
| Syrup, 43 DE | | | | | | |
| Gelatin 250 bloom | 5.36 | 4.82 | 90.00 | 5.36 | 4.82 | 90.00 |
| Water | 10.71 | 0.00 | 180.00 | 10.71 | 0.00 | 180.00 |
| Sucrose | 0.00 | 0.00 | 0.00 | 28.57 | 28.57 | 480.00 |
| Water | 0.76 | 0.00 | 12.75 | 7.32 | 0.00 | 123.00 |
| Allulose (77 DS) | 37.10 | 28.56 | 623.25 | 48.04 | 36.99 | 807.00 |
| TOTAL: | 100.00 | 70.38 | 1680.00 | 100.00 | 70.38 | 1680.00 |

TABLE 47

| Minor | Control | | Ex. 19A | | Ex. 19B | | Ex. 19C | |
|---|---|---|---|---|---|---|---|---|
| Ingredients | Parts | g | Parts | g | Parts | g | Parts | g |
| Cooked slurry | 100 | 1400 | 100 | 1400 | 100 | 1400 | 100 | 1400 |
| Silesia | 0.40 | 5.60 | 0.40 | 5.60 | 0.40 | 5.60 | 0.40 | 5.60 |
| Strawberry | | | | | | | | |
| 1515 (RTM) | | | | | | | | |
| Citric Acid, | 1.50 | 21.0 | 1.50 | 21.0 | 1.50 | 21.0 | 1.50 | 21.0 |
| 50% solution | | | | | | | | |
| Red #40, 5% | 0.04 | 0.56 | 0.04 | 0.56 | 0.04 | 0.56 | 0.04 | 0.56 |
| solution | | | | | | | | |
| Liquid | 0.00 | 0.00 | 0.0560 | 0.7840 | 0.0853 | 1.19 | 0 | 0 |
| sucralose, | | | | | | | | |
| 25% solution | | | | | | | | |

### Preparation:

The candies were prepared as follows:
The gelatin was hydrated with water until clear and the slurry was maintained at 165° F. (74° C.);
The corn syrup or allulose syrup and sucrose were mixed with the remaining water and added to a mixing kettle;
The syrup mixture was heated to 160° F. (71° C.) to solubilize, and the (remaining) corn syrup was added. Mixing was continued and the temperature was raised to 175° F. (79° C.);
The gelatin slurry was added and mixing was continued;
The Brix of the mixture was checked against a target of 78-79, and the amount of water was adjusted if required;
1400 g of cooked slurry was weighed and the minor ingredients were added and mixed in very well;
The resulting slurry was deposited in starch moulds using metal funnels;
The jellies were dried at 95-100° F. (35-38° C.) for 24-48 hours until a target Brix of 81-82 was reached.

### Results:

Observations relating to the depositing and drying of the candies are set out in Table 48:

TABLE 48

| | Depositing | | Drying | Final |
|---|---|---|---|---|
| | Brix | Observations | Time/h | Brix |
| Control | 78 | Slightly thick, stringy and lumpy | 48 | 84 |
| Ex. 19A | 77.5 | Slight browning, very thin at 78 | 48 | 84 |
| | | Brix, deposited without stringing | | |
| Ex. 19B | 78 | Some browning on addition of | 52 | 84.5 |
| | | gelatin slurry, deposited without | | |
| | | problems | | |
| Ex. 19C | 78 | Some browning on addition of | 52 | 83 |
| | | gelatin slurry, deposited without | | |
| | | problems | | |

Penetration testing was carried out using a TextPlus® Texture Analyzer (Gummy penetration, needle probe). The results are shown in Table 49:

TABLE 49

| | Hardness (gram force) |
|---|---|
| Control | 69.43 |
| Ex. 19A | 46.81 |
| Ex. 19B | 49.06 |
| Ex. 19C | 39.47 |

The results of informal sensory testing are shown in Table 50:

TABLE 50

| | Observations |
|---|---|
| Control | Clear, nice red color, good firmness, good |
| | sweet taste, not too sticky when chewed |
| Ex. 19A | Darker, brighter red, good clarity, softer and |
| | less firm than control, slightly delayed sweetness |
| | and flavor, slightly sticky when chewed |
| Ex. 19B | Slightly darker reddish opaque color, interior |
| | cross-section clear, not as firm as control but |
| | firmer than Ex. 19A, slightly delayed, pleasant |
| | sweetness and acid perception, no surface |
| | stickiness, dry surface |
| Ex. 19C | Red-brown darker color with some opacity, interior |
| | cross-section clear, very soft texture, not sticky, |
| | soft and elastic, not as sweet as the other three |
| | samples |

The above results show that allulose can be successfully used to replace sucrose and/or corn syrup in gelatin gummy candies both in terms of processing (e.g. depositing and the like) and in terms of the properties of the candies. The results also show that further optimization of Brix levels, gelatin content and drying temperatures will further improve the properties of the allulose candies—see Example 20.

### Example 20

### Gelatin Gummy Candies

Further gelatin gummy candies comprising allulose were investigated taking into account the results of Example 19.

### Recipes:

Control and test candies were produced according to the formulas described in Tables 51 and 52:

TABLE 51

| | Control | | | Example 20 | | |
|---|---|---|---|---|---|---|
| Ingredient | % | DS | Batch/g | % | DS | Batch/g |
| STALEY 1300 | 46.07 | 36.99 | 774.00 | 39.46 | 31.69 | 663.00 |
| (RTM) Corn | | | | | | |
| Syrup, 43 DE | | | | | | |
| Gelatin 250 bloom | 5.71 | 5.14 | 96.00 | 5.71 | 5.14 | 96.00 |
| Water | 10.71 | 0.00 | 180.00 | 10.71 | 0.00 | 180.00 |
| Sucrose | 28.57 | 28.57 | 480.00 | 13.25 | 13.25 | 222.60 |
| Water | 8.93 | 0.00 | 150.00 | 4.07 | 0.00 | 68.40 |
| Allulose (77 DS) | 0.00 | 0.00 | 0.00 | 26.79 | 20.63 | 450.00 |
| TOTAL: | 100.00 | 70.70 | 1680.00 | 100.00 | 70.71 | 1680.00 |

TABLE 52

| | Control | | Ex. 20 | |
|---|---|---|---|---|
| Minor Ingredients | Parts | g | Parts | g |
| Cooked slurry | 100 | 1400 | 100 | 1400 |
| Silesia Strawberry 1515 | 0.40 | 5.60 | 0.40 | 5.60 |
| (RTM) | | | | |
| Citric Acid, 50% solution | 1.50 | 21.0 | 1.50 | 21.0 |
| Red #40, 5% solution | 0.04 | 0.56 | 0.04 | 0.56 |
| Steviol glycosides | 0.00 | 0.00 | 0.0200 | 0.2800 |

### Preparation:

The candies were prepared as follows:
The gelatin was hydrated with water until clear and the slurry was maintained at 165° F. (74° C.);
The corn syrup or allulose syrup and sucrose were mixed with the remaining water and added to a mixing kettle;
The syrup mixture was heated to 160° F. (71° C.) to solubilize, and the (remaining) corn syrup was added. Mixing was continued and the temperature was raised to 215° F. (102° C.) until 82 Brix was reached;
The gelatin slurry was added and mixing was continued;
The Brix of the mixture was checked against a target of 78-79, and the amount of water was adjusted if required;
1400 g of cooked slurry was weighed and the minor ingredients were added and mixed in very well;
The resulting slurry was deposited in starch moulds using metal funnels;
The jellies were dried at 85° F. (29° C.) for 48 or 54 hours until a target Brix of 81-82 was reached.

### Results:

Observations relating to the depositing and drying of the candies are set out in Table 53 for the jellies dried for 48 hours (Ex. 201(1) and the jellies dried for 54 hours Ex. 20(2)):

TABLE 53

| | Depositing | | Drying | Final |
|---|---|---|---|---|
| | Brix | Observations | Time/h | Brix |
| Control | 80 | Deposited without stringing | 48 | 82 |
| Ex. 20(1) | 78 | Slight browning, deposited thin | 48 | 82 |
| | | without stringing | | |
| Ex. 20(2) | 78 | Some browning thinner than | 54 | 83 |
| | | control at 78 Brix, deposited | | |
| | | without stringing | | |

Penetration testing was carried out using a TextPlus® Texture Analyzer (Gummy penetration, needle probe). The results are shown in Table 54:

TABLE 54

| | Hardness (gram force) |
|---|---|
| Control | 66.16 |
| Ex. 20(1) | 60.77 |
| Ex. 20(2) | 70.04 |

The candies of Example 20 deposited well without stringing and had a texture (chewiness) comparable to that of the control. They also had excellent clarity. It has therefore been shown that allulose can be used to produce reduced-calorie gummy candies very successfully.

### Sauces and Dressings

### Example 21

### Barbecue Sauce

Barbecue sauces were prepared according to Table 55:

TABLE 55

| | Comparative | | Example | | Example | | Example | |
|---|---|---|---|---|---|---|---|---|
| | Example 21: | | 21A: | | 21B: | | 21C: | |
| | % | (g) | % | (g) | % | (g) | % | (g) |
| Water | 22.9 | 458 | 22.9 | 458 | 58.75 | 1175 | 0 | 0 |
| ISOSWEET 100 | 43 | 860 | 0 | 0 | 0 | 0 | 0 | 0 |
| HFCS | | | | | | | | |
| Allulose | 0 | 0 | 43 | 860 | 5 | 100 | 80 | 1600 |
| Tomato paste, | 15 | 300 | 15 | 300 | 15 | 300 | 5 | 100 |
| 30% solids | | | | | | | | |
| Distilled vinegar, | 6.5 | 130 | 6.5 | 130 | 6.5 | 130 | 6.5 | 130 |
| 200 grain | | | | | | | | |
| Molasses | 4 | 80 | 4 | 80 | 4 | 80 | 3 | 60 |
| Salt | 3.2 | 64 | 3.2 | 64 | 3.2 | 64 | 3.2 | 64 |
| REZISTA modified | 3.1 | 62 | 3.1 | 62 | 5 | 100 | 0 | 0 |
| food starch | | | | | | | | |
| Mustard flour | 0.75 | 15 | 0.75 | 15 | 0.75 | 15 | 0.75 | 15 |
| Onion powder | 0.6 | 12 | 0.6 | 12 | 0.6 | 12 | 0.6 | 12 |
| Garlic powder | 0.5 | 10 | 0.5 | 10 | 0.5 | 10 | 0.5 | 10 |
| Liquid smoke | 0.28 | 5.6 | 0.28 | 5.6 | 0.28 | 5.6 | 0.28 | 5.6 |
| Caramel color | 0.1 | 2 | 0.1 | 2 | 0.1 | 2 | 0.1 | 2 |
| Ground celery | 0.05 | 1 | 0.05 | 1 | 0.05 | 1 | 0.05 | 1 |
| Ground black | 0.02 | 0.4 | 0.02 | 0.4 | 0.02 | 0.4 | 0.02 | 0.4 |
| pepper | | | | | | | | |
| Sucralose, 25% | 0 | 0 | 0 | 0 | 0.25 | 5 | 0 | 0 |
| liquid concentrate | | | | | | | | |
| | 100 | 2000 | 100 | 2000 | 100 | 2000 | 100 | 2000 |

### Method:

1. Salt, mustard, onion, garlic, celery and pepper were dry-blended.
2. HFCS/allulose, water, tomato paste, vinegar, molasses and liquid smoke were whisked in a sauce pan.
3. The dry blend was added and whisked until incorporated.
4. The sauce was heated to 190° F. (88° C.) and held for 5 minutes.
5. The sauce was hot-filled into jars.

### Characterization:

The sauces were analyzed in terms of viscosity, pH (when diluted 1:1 with deionized water), total titratable acidity and brix. The results are shown in Table 56:

TABLE 56

| | | Titratable | | Brookfield |
|---|---|---|---|---|
| Sample | pH | Acidity, % citric | Brix | viscosity, (cps) |
| Comparative | 3.40 | 1.63 | 47.7 | 37300 |
| Example 21: | | | | |
| Example 21A: | 3.35 | 1.65 | 50.4 | 42800 |
| Example 21C: | 3.30 | 1.19 | 71.6 | 24000 |
| Example 21B: | 3.37 | 1.67 | 19.7 | 25100 |

### Informal Sensory Analysis:

Informal tasting showed that the sauce of Comparative Example 21 and the sauce of Example 21A were preferred by an equal number of people. The sauces of Examples 21B and 21C were less preferred, but were nonetheless considered to be barbecue sauces.

### Scoop-for-Scoop Sweeteners

### Example 22

Scoop-for-scoop sweeteners were prepared according to Tables 57A and 57B:

TABLE 57A

| | Example 22A: | | Example 22B: | | Example 22C: | |
|---|---|---|---|---|---|---|
| INGREDIENT | % as is | GRAMS | % as is | GRAMS | % as is | GRAMS |
| Allulose | 5 | 3.6 | 25 | 17.8 | 50 | 35.6 |
| Maltodextrin | 0 | 0 | 24 | 17.1 | | 0 |
| Polydextrose | 94.7 | 67.3 | 40.7 | 28.9 | 16.8 | 11.9 |
| Soluble Corn | 0 | 0 | 10 | 7.1 | 10 | 7.1 |
| Fiber 85 | | | | | | |
| Sucralose | 0.35 | 0.33 | 0.33 | 0.31 | 0.23 | 0.22 |
| Sucrose | 0 | 0 | 0 | 0 | 23 | 46.3 |
| TOTAL | 100 | 71.2 | 100 | 71.2 | 100 | 101.1 |

TABLE 57B

Comparative Example 22

| INGREDIENT | % as is | GRAMS |
|---|---|---|
| Allulose | 0 | 0 |
| Maltodextrin | 0 | 0 |
| Polydextrose | 0 | 0 |
| Soluble Corn Fiber 85 | 0 | 0 |
| Sucralose | 0 | 0 |
| Sucrose | 100 | 201.5 |
| TOTAL | 100 | 201.5 |

The scoop-for-scoop sweeteners according to Examples 22A-C can be used to replace sucrose (Comparative Example 22) on a 1:1 volume basis. An example use is the following yellow cake recipe:

2 cups cake flour
2 teaspoons baking powder
½ teaspoon salt
½ cup butter, softened
1 cup sugar (or 1 cup of scoop-for-scoop sweetener according to Examples 20A-D)
3 large eggs, room temperature
2 teaspoons vanilla
¾ cup milk

### Method:

1. An oven was preheated to 350° F. (177° C.).
2. Two 9 inch (22.5 cm) cake pans were greased and floured.
3. In bowl, the flour, baking powder, and salt were combined with a wire whisk.
4. The butter and sugar were creamed until light and fluffy. The eggs were beaten in, one at a time. Vanilla was added and the mixture was mixed until completely combined. The flour was added slowly, alternately with the milk. At the end of the addition, the batter was smooth. The batter was divided between the two pans.
5. The cakes were baked for 20 to 25 minutes. They were cooled for 5 minutes in the pan, and then inverted onto a rack and cooled completely.

### Table-Top Sweeteners

### Example 23

### Dry Table-Top Sweeteners

A dry table-top sweetener was prepared with sucralose. The composition is shown in Table 58:

TABLE 58

| | | Total dry weight of |
|---|---|---|
| | | each table-top sample |
| Sample | Table top composition | in 200 mL of coffee |
| 1 | 99.5% Allulose + 0.5% Sucralose | 2.51 gram |
| | Truvia ™ (comparative) | 3.5 gram |
| | Sucrose (control) | 8.4 gram |

Each combination was dissolved in hot coffee. The total weight of each combination was designed such that the sweetness of each combination in 200 ml of coffee is similar to that of 8-10 grams of sucrose in the same amount of coffee. The coffee was made by brewing 91.9 grams of Starbucks™ Blounde Veranda Blend ground coffee with about 1600 mL of water. The calorie content of each combination was targeted to be less than 5 kcal/200 mL coffee. Five panelists were asked to compare the sweetness and taste profile of the sample against sucrose control and Truvia™ (a commercially available stevia-based sweetener) in hot coffee on a scale of 1 to 5. The results are shown in Table 59:

TABLE 59

| | Sample 1 | Truvia ™ |
|---|---|---|
| Average rating | 3 | 1.2 |

It was unexpectedly found that allulose can make low calorie table-top sweetener taste more like sugar (sucrose). It is also unexpectedly found that allulose-based low or zero calorie table top sweetener taste significantly better than an erythritol-based table top product.

### Example 24

### Liquid Table-Top Sweeteners

Liquid table-top sweeteners were prepared according to Table 60:

TABLE 60

| | | Total weight of |
|---|---|---|
| | | each table top sample |
| Sample | Composition | in 200 mL of coffee |
| 1 | 3.81% Allulose + 9.42% sucralose + | 0.15 gram |
| | 0.1% potassium sorbate + 86.67% | |
| | water | |
| 2 | 47.73% Allulose + 9.34% sucralose + | 0.15 gram |
| | 0.1% potassium sorbate + 42.83% | |
| | water | |
| 3 | 3.81% Allulose + 0.137% sucralose + | 10 gram |
| | 0.1% potassium sorbate + 95.953% | |
| | water | |
| 4 | 75.44% Allulose + 0.054% sucralose + | 10 gram |
| | 0.1% potassium sorbate + 24.508% | |
| | water | |
| | Sucrose (control) | 8.4 gram |

Five panelists were asked to compare the sweetness and taste profile of each sample against sucrose control in hot coffee on a scale of 1 to 5. The results are shown in Table 61:

TABLE 61

| | Sample 1 | Sample 2 | Sample 3 | Sample 4 | Sucrose control |
|---|---|---|---|---|---|
| Average | 1.6 | 2 | 2.8 | 2.2 | 2.4 |
| rating | | | | | |

It was unexpectedly found that allulose-based low or zero calorie liquid table top sweetener tastes very similar to that of sucrose control in coffee. It was also unexpectedly found that the higher use level of liquid table top sweetener with allulose did not impart any negative taste and, in fact, these samples tasted much closer to sucrose control.

### Cereal Coatings

### Example 25

### Clear Glazed Cereal Coating

A clear glazed cereal coating was prepared in which allulose was used to replace a significant portion of the sucrose in a control coating. The compositions of the coating slurries are shown in Table 62:

TABLE 62

| | Control | | | Example 25 | | |
|---|---|---|---|---|---|---|
| Ingredient | Parts | DS | Batch/g | Parts | DS | Batch/g |
| Sucrose | 70.00 | 70.00 | 350.00 | 40.00 | 40.00 | 200.00 |
| Allulose (78 DS) | 0.00 | 0.00 | 0.00 | 38.46 | 30.00 | 192.30 |
| STALEY 1300 | 30.00 | 24.09 | 150.00 | 30.00 | 24.09 | 150.00 |
| (RTM) Corn Syrup, | | | | | | |
| 43 DE | | | | | | |
| Water | 20.00 | 0.00 | 100.00 | 11.54 | 0.00 | 57.70 |
| TOTAL: | 120.00 | 94.09 | 600.00 | 120.00 | 94.09 | 600.00 |

The slurries were cooked to 80 Brix and used to coat a cereal base (of the Cheerios® type) according to Table 63:

TABLE 63

| | % | Batch/g |
|---|---|---|
| Cereal base | 75 | 225 |
| Coating slurry | 25 | 75 |
| TOTAL | 100 | 300 |

The coating was carried out by spray-coating the slurry over the base cereal with continuous tumbling. The coated cereal was then spread on a perforated pan and then dried at 250° F. (121° C.) for 10 minutes in a forced air convection oven (high fan) to reach <4% moisture.

### Observations:

Both the control and allulose-coated cereals had a glazed appearance and crispy texture. The allulose-coated cereal had a more clear and shiny appearance than the control cereal. Sweetness perception was slightly less for the allulose-coated cereal.

### Nutritional Facts:

Selected nutrition facts (per 100 g) are provided in Table 64 for the control slurry and the slurry of Example 25:

TABLE 64

| | Control (slurry) | Example 25 (slurry) |
|---|---|---|
| Calories | 310 | 220 |
| Sugars | 67 g | 42 g |

The allulose-containing slurry thus provides a 29% calorie reduction and 37% sugar reduction compared to the control.

Selected nutrition facts (per 30 g) are provided in Table 65 for the control coated cereal and the coated cereal of Example 25:

TABLE 65

| | Control (cereal) | Example 25 (cereal) |
|---|---|---|
| Calories | 110 | 100 |
| Sugars | 8 g | 6 g |

The allulose-containing cereal thus provides a 9% calorie reduction and 25% sugar reduction compared to the control.

### Example 26

### Topically Sweet Seasoned Cereal

A dry, topical seasoning mix was prepared in which crystalline allulose was used to replace the crystalline fructose in the control. A further mix was prepared including sucralose powder to match the sweetness of the control.

The compositions of the seasoning mixes are shown in Table 66:

TABLE 66

| | Control | Example 26A | Example 26B |
|---|---|---|---|
| Granulated sucrose | 40.00 | 40.00 | 40.00 |
| Milled crystalline fructose | 40.00 | 0.00 | 0.00 |
| (Krystar 300 (RTM)) | | | |
| Allulose powder (milled) | 0.00 | 40.00 | 40.00 |
| Maltodextrin (STAR-DRI 100 | 18.00 | 18.00 | 18.00 |
| (RTM)) | | | |
| Salt (SodaLo (RTM) extra | 1.00 | 1.00 | 1.00 |
| fine) | | | |
| Cinnamon | 2.00 | 2.00 | 2.00 |
| Sucralose powder | 0.00 | 0.00 | 0.035 |
| TOTAL | 101.00 | 101.00 | 101.035 |

The seasoning mixes were used to prepare coated cereals in accordance with Table 67:

TABLE 67

| Component | % |
|---|---|
| Cereal base (toasted “cinnamon | 70.00 |
| crunch” type cereal) | |
| Seasoning mix | 22.00 |
| Canola oil | 8.00 |
| Total | 100.00 |

The coating was carried out by heating the cereal in a convection oven at 250° F. (121° C.), high fan, for 1 minute. Canola oil was then applied with constant tumbling, and the seasoning mix was then added with constant tumbling. The cereal was cooled and packaged.

### Observations:

Each of the seasoning mixes dispersed well over the cereal without lumping. Allulose-based mixes appeared to exhibit some fall off after application.

### Nutritional Facts:

Selected nutrition facts (per 100 g) are provided in Table 68 for the seasoning mixes:

TABLE 68

| | Control (mix) | Examples 26A and B (mix) |
|---|---|---|
| Calories | 380 | 210 |
| Sugars | 81 | 37 |

The allulose-containing mixes thus provide a 44% calorie reduction and 54% sugar reduction compared to the control.

Selected nutrition facts (per 30 g) are provided in Table 69 for the control coated cereal and the coated cereals of Examples 26A and B:

TABLE 69

| | Control (cereal) | Examples 26A and B (mix) |
|---|---|---|
| Calories | 120 | 110 |
| Sugars | 8 | 5 |

The allulose-containing cereal thus provides an 8.3% calorie reduction and 37% sugar reduction compared to the control.

1. A food or beverage product comprising allulose.

2. A food or beverage product according to claim 1, wherein the food or beverage product comprises allulose in an amount of from about 1% by weight to about 80% by weight relative to the total weight of the food or beverage product.

3. A food or beverage product according to claim 1 or 2, which is a carbonated beverage comprising allulose in an amount of from about 2% by weight to about 25% by weight relative to the total weight of the carbonated beverage.

4. A food or beverage product according to claim 3, wherein the carbonated beverage is a non-alcoholic carbonated beverage.

5. A food or beverage product according to claim 3 or 4, wherein the carbonated beverage comprises allulose in an amount of from about 2% by weight to about 7% by weight relative to the total weight of the carbonated beverage.

6. A food or beverage product according to claim 1 or 2, which is a non-carbonated beverage comprising allulose in an amount of from about 1% by weight to about 25% by weight relative to the total weight of the non-carbonated beverage.

7. A food or beverage product according to claim 6, wherein the non-carbonated beverage is a non-alcoholic non-carbonated beverage.

8. A food or beverage product according to claim 6, wherein the non-carbonated beverage is selected from the group consisting of flavored waters, fruit drinks, and sweet tea or coffee based beverages.

9. A food or beverage product according to any of claims 6 to 8, wherein the non-carbonated beverage comprises allulose in an amount of from about 2% by weight to about 7% by weight relative to the total weight of the non-carbonated beverage.

10. A food or beverage product according to claim 1 or 2, which is a frozen dessert comprising allulose in an amount of from about 1% by weight to about 25% by weight relative to the total weight of the frozen dessert.

11. A food or beverage product according to claim 10, wherein the frozen dessert is selected from the group consisting of frozen dairy desserts and frozen non-dairy desserts.

12. A food or beverage product according to claim 11, wherein the frozen dessert is selected from the group consisting of dairy ice cream, non-dairy ice cream and sorbet.

13. A food or beverage product according to any of claims 10 to 12, wherein the frozen dessert comprises allulose in an amount of from about 5% by weight to about 9% by weight relative to the total weight of the frozen dessert.

14. A food or beverage product according to claim 1 or 2, which is a yogurt comprising allulose in an amount of from about 2% by weight to about 15% by weight relative to the total weight of the yogurt.

15. A food or beverage product according to claim 14, wherein the yogurt is selected from the group consisting of full fat, reduced fat and fat-free dairy yogurts, non-dairy and lactose-free yogurts, and frozen equivalents of all of these.

16. A food or beverage product according to claim 14 or 15, wherein the yogurt comprises allulose in an amount of from about 4% by weight to about 9% by weight relative to the total weight of the yogurt.

17. A food or beverage product according to claim 1 or 2, which is a snack bar comprising allulose in an amount of from about 5% by weight to about 25% by weight relative to the total weight of the snack bar.

18. A food or beverage product according to claim 17, wherein the snack bar is a cereal, nut, seed and/or fruit bar.

19. A food or beverage product according to claim 18, wherein the snack bar is a cereal bar.

20. A food or beverage product according to any of claims 17 to 19, wherein the snack bar comprises allulose in an amount of from about 12% by weight to about 20% by weight relative to the total weight of the snack bar.

21. A food or beverage product according to claim 1 or 2, which is a sweet bakery product comprising allulose in an amount of from about 8% by weight to about 45% by weight relative to the total weight of the uncooked product.

22. A food or beverage product according to claim 21, wherein the sweet bakery product is selected from the group consisting of rolls, cakes, pies, pastries, and cookies.

23. A food or beverage product according to claim 21 or 22, wherein the sweet bakery product comprises allulose in an amount of from about 15% by weight to about 35% by weight relative to the total weight of the uncooked product.

24. A food or beverage product according to claim 1 or 2, which is a confectionary product comprising allulose in an amount of from about 1% by weight to about 70% by weight relative to the total weight of the uncooked confectionary product.

25. A food or beverage product according to claim 24, wherein the confectionary product is selected from the group consisting of jelly candies, soft candies, hard candies, chocolates and gums.

26. A food or beverage product according to claim 24 or 25, wherein the confectionary product comprises allulose in an amount of from about 10% by weight to about 50% by weight relative to the total weight of the uncooked confectionary product.

27. A food or beverage product according to any of claims 24 to 26, wherein the confectionary product further comprises at least one bulking agent.

28. A food or beverage product according to claim 27, wherein the bulking agent is selected from the group consisting of polydextrose, soluble corn fiber (SCF), maltodextrin, a polyol and mixtures thereof.

29. A food or beverage product according to claim 27 or 28, wherein the bulking agent is included in the confectionary product in a weight ratio to allulose of up to about 2:1 on a dry solids basis.

30. A food or beverage product according to claim 1 or 2, which is a sweet spread comprising allulose in an amount of from about 3% by weight to about 75% by weight relative to the total weight of the uncooked sweet spread.

31. A food or beverage product according to claim 30, wherein the sweet spread is selected from the group consisting of fruit-based jellies, jams, butters, preserves and conserves.

32. A food or beverage product according to claim 30 or 31, wherein the sweet spread comprises allulose in an amount of from about 3% by weight to about 50% by weight relative to the total weight of the uncooked sweet spread.

33. A food or beverage product according to claim 1 or 2, which is a pre-made baking mix for preparing a sweet bakery product, wherein the pre-made baking mix comprises allulose in an amount sufficient to provide from about 8% by weight to about 45% by weight of allulose in the uncooked sweet bakery product.

34. A food or beverage product according to claim 33, wherein the pre-made baking mix comprises from about 13% by weight of allulose to about 75% by weight of allulose relative to the total weight of the pre-made baking mix.

35. A food or beverage product according to claim 34, wherein the pre-made baking mix comprises from about 25% by weight of allulose to about 58% by weight of allulose relative to the total weight of the pre-made baking mix.

36. A food or beverage product according to claim 1 or 2, which is a cereal coating composition comprising allulose in an amount of from about 5% by weight to about 80% by weight of allulose based on the total weight of the cereal coating composition.

37. A food or beverage product according to claim 36, comprising water, allulose and a bulking agent.

38. A food or beverage product according to claim 37, wherein the bulking agent is selected from the group consisting of soluble corn fiber (SCF), maltodextrin, polydextrose, polyols, nutritive sweeteners and mixtures thereof.

39. A food or beverage product according to any of claims 36 to 38, comprising allulose in an amount of from about 20% by weight to about 40% by weight relative to the total weight of the cereal coating composition.

40. A food or beverage product according to claim 1 or 2, which is a sweet filling comprising allulose in an amount of from about 5% by weight to about 50% by weight relative to the total weight of the uncooked sweet filling.

41. A food or beverage product according to claim 40, wherein the sweet filling comprises allulose in an amount of from about 25% by weight to about 45% by weight relative to the total weight of the uncooked sweet filling.

42. A food or beverage product according to claim 40 or 41, wherein the sweet filling is a sweet pie filling.

43. A food or beverage product according to claim 1 or 2, which is a sweetened breakfast cereal comprising from about 1% by weight to about 50% by weight of allulose based on the total weight of the sweetened breakfast cereal.

44. A food or beverage product according to claim 43, wherein the sweetened breakfast cereal is selected from the group consisting of extruded breakfast cereals, flaked breakfast cereals and puffed breakfast cereals.

45. A food or beverage product according to claim 43 or 44, wherein the sweetened breakfast cereal is a coated breakfast cereal comprising a breakfast cereal coated with a cereal coating composition comprising allulose.

46. A food or beverage product according to claim 1 or 2, which is a bread product comprising allulose in an amount of from about 2% by weight to about 15% by weight relative to the total weight of the uncooked bread product.

47. A food or beverage product according to claim 46, wherein the bread product is selected from the group consisting of leavened and unleavened breads, yeasted and unyeasted breads, breads comprising any type of wheat flour, breads comprising any type of non-wheat flour and gluten-free breads.

48. A food or beverage product according to claim 47, wherein the bread product is a yeasted bread comprising wheat flour.

49. A food or beverage product according to any of claims 46 to 48, wherein the bread product comprises allulose in an amount of from about 8% by weight to about 11% by weight relative to the total weight of the bread product.

50. A food or beverage product according to claim 1 or 2, which is a pre-made bread mix for preparing a bread product, wherein the pre-made bread mix comprises allulose in an amount sufficient to provide from about 2% by weight to about 15% by weight of allulose in the uncooked bread product.

51. A food or beverage product according to claim 50, wherein the pre-made bread mix comprises allulose in an amount of from about 3% by weight to about 25% by weight relative to the total weight of the pre-made bread mix.

52. A food or beverage product according to claim 50 or 51, wherein the pre-made bread mix comprises allulose in an amount of from about 13% by weight to about 18% by weight relative to the total weight of the pre-made bread mix.

53. A food or beverage product according to claim 1 or 2, which is a sauce or dressing comprising allulose in an amount of from about 2% by weight to about 80% by weight relative to the total weight of the sauce or dressing.

54. A food or beverage product according to claim 53, comprising allulose in an amount of from about 5% by weight to about 40% by weight relative to the total weight of the sauce or dressing.

55. A food or beverage product according to any preceding claim, wherein the product does not contain any other sweetener other than allulose and, optionally, one or more nutritive sweetener.

56. A food or beverage product according to any preceding claim, wherein the product does not comprise a nutritive sweetener.

57. A food or beverage product according to any of claims 1 to 55, wherein the product comprises one or more nutritive sweetener.

58. A food or beverage product according to claim 57, wherein the nutritive sweetener is selected from the group consisting of sucrose, glucose, glucose syrup, isoglucose, fructose, glucose-fructose syrup, maltose, lactose, corn syrup, high fructose corn syrup, invert sugar, molasses, honey, agave and mixtures thereof.

59. A food or beverage product according to any of claims 1 to 26, 30 to 36 and 40 to 54, wherein the product does not comprise any bulking agents selected from the group consisting of maltodextrin, polydextrose, xanthan gum, guar gum, soluble corn fiber (SCF) and polyols.

60. A food or beverage product according to any preceding claim, wherein the product does not contain any high intensity sweetener.

61. A food or beverage product according to any preceding claim, wherein the product does not contain any sugar alcohol.

62. A food or beverage product according to any of claims 1 to 54, wherein the product comprises at least one co-sweetener.

63. A food or beverage product according to claim 62, wherein the at least one co-sweetener is selected from the group consisting of high intensity sweeteners and sugar alcohols.

64. A food or beverage product according to claim 63, wherein the at least one co-sweetener is selected from the group consisting of monk fruit extracts and stevia extracts.

65. A food or beverage product according to claim 63, wherein the at least one co-sweetener is selected from the group consisting of sucralose, aspartame and acesulfame potassium.

66. A food or beverage product according to claim 63, wherein the at least one co-sweetener is selected from the group consisting of maltitol, xylitol and erythritol.

67. Use of a sweetener comprising allulose and optionally at least one other sweetener in a food or beverage product.

68. A sweetener comprising allulose and optionally at least one other sweetener for use in a food or beverage product.

69. A scoop-for-scoop sweetener comprising allulose, wherein the scoop-for-scoop sweetener has substantially the same sweetness per unit volume as sucrose.

70. A scoop-for-scoop sweetener according to claim 69, wherein the scoop-for-scoop sweetener comprises allulose, at least one bulking agent, and at least one high intensity sweetener.

71. A scoop-for-scoop sweetener according to claim 69 or 70, wherein the scoop-for-scoop sweetener comprises allulose in an amount of from about 5% by weight to about 95% by weight relative to the total weight of the scoop-for-scoop sweetener.

72. A scoop-for-scoop sweetener according to claim 71, wherein the scoop-for-scoop sweetener comprises allulose in an amount of from about 25% to about 90% by weight relative to the total weight of the scoop-for-scoop sweetener.

73. A scoop-for-scoop sweetener according to any of claims 70 to 72, wherein the at least one high intensity sweetener is selected from the group consisting of monk fruit extracts, sucralose, aspartame, and mixtures thereof.

74. A scoop-for-scoop sweetener according to any of claims 70 to 73, wherein the at least one bulking agent is selected from the group consisting of maltodextrin, polydextrose, gums, soluble corn fiber (SCF), starches, polyols, and mixtures thereof.

75. A scoop-for-scoop sweetener according to any of claims 70 to 74, wherein the at least one bulking agent comprises a nutritive sweetener.

76. A scoop-for-scoop sweetener according to claim 74, wherein the nutritive sweetener comprises at least one of sucrose, fructose or dextrose.

77. Use of a scoop-for-scoop sweetener according to any of claims 69 to 76 to replace sucrose on a 1:1 volume basis.

78. A table-top sweetener comprising allulose and at least one other natural or synthetic sweetener.

79. A table-top sweetener according to claim 78, wherein the table-top sweetener is a dry table-top sweetener.

80. A table-top sweetener according to claim 79, wherein the dry table-top sweetener takes the form of tablets, granules or a powder.

81. A table-top sweetener according to claim 79 or 80, wherein the at least one other natural or synthetic sweetener includes at least one natural and/or synthetic high intensity sweetener.

82. A table-top sweetener according to claim 81, wherein the at least one natural and/or synthetic high intensity sweetener comprises sucralose.

83. A table-top sweetener according to any of claims 79 to 82, wherein the table-top sweetener comprises allulose in an amount of from about 97.5% to about 99.8% by weight relative to the total weight of allulose and at least one other natural or synthetic sweetener in the table-top sweetener.

84. A table-top sweetener according to claim 83, wherein the table-top sweetener comprises allulose in an amount of from about 99.25% to about 99.75% and sucralose in an amount of from about 0.25% to about 0.75% by weight based on the total weight of allulose and sucralose in the table-top sweetener.

85. A table-top sweetener according to any of claims 79 to 84, wherein the table-top sweetener comprises at least one nutritive sweetener.

86. A table-top sweetener according to claim 85, wherein the nutritive sweetener is selected from the group consisting of sucrose, glucose, glucose syrup, isoglucose, fructose, glucose-fructose syrup, maltose, lactose, corn syrup, high fructose corn syrup, invert sugar, molasses, honey, agave, and mixtures thereof.

87. A table-top sweetener according to claim 85, wherein the nutritive sweetener comprises sucrose.

88. A table-top sweetener according to claim 78, wherein the table-top sweetener is a liquid table-top sweetener.

89. A table-top sweetener according to claim 88, wherein the table-top sweetener is an aqueous solution.

90. A table-top sweetener according to claim 88 or 89, wherein the table-top sweetener further comprises a preservative.

91. A table-top sweetener according to claim 90, wherein the preservative is potassium sorbate.

92. A table-top sweetener according to any of claims 88 to 91, wherein the at least one other natural or synthetic sweetener is at least one natural or synthetic high intensity sweetener.

93. A table-top sweetener according to claim 92, wherein the at least one natural or synthetic high intensity sweetener comprises sucralose.

94. A table-top sweetener according to claim 88, comprising allulose in an amount of from about 2.5% to about 5% by weight, high intensity sweetener in an amount of from about 9% to about 10% by weight, preservative in an amount of from about 0.05% to about 0.15% by weight, and water in an amount of from about 84.85% to about 88.45% by weight, relative to the total weight of the table-top sweetener.

95. A table-top sweetener according to claim 88, comprising allulose in an amount of from about 45% to about 50% by weight, high intensity sweetener in an amount of from about 9% to about 10% by weight, preservative in an amount of from about 0.05% to about 0.15% by weight, and water in an amount of from about 39.85% to about 45.95% by weight, relative to the total weight of the table-top sweetener.

96. A table-top sweetener according to claim 88, comprising allulose in an amount of from about 2.5% to about 5% by weight, high intensity sweetener in an amount of from about 0.1% to about 0.15% by weight, preservative in an amount of from about 0.05% to about 0.15% by weight, and water in an amount of from about 94.7% to about 97.35% by weight, relative to the total weight of the table-top sweetener.

97. A table-top sweetener according to claim 88, comprising allulose in an amount of from about 70% to about 80% by weight, high intensity sweetener in an amount of from about 0.04% to about 0.07% by weight, preservative in an amount of from about 0.05% to about 0.15% by weight, and water in an amount of from about 19.78% to about 29.91% by weight, relative to the total weight of the table-top sweetener.

98. A table-top sweetener according to any of claims 94 to 97, wherein the high intensity sweetener is sucralose.

99. A table-top sweetener according to any of claims 94 to 98, wherein the preservative is potassium sorbate.

100. A sweetener system comprising allulose, at least one bulking agent, and optionally at least one high intensity sweetener.

101. A sweetener system according to claim 100, comprising allulose in an amount of from about 5% by weight to about 95% by weight relative to the total weight of the sweetener system.

102. A sweetener system according to claim 101, comprising allulose in an amount of from about 20% to about 50% by weight relative to the total weight of the sweetener system.

103. A sweetener system according to any of claims 100 to 102, wherein the sweetener system includes at least one high intensity sweetener and the at least one high intensity sweetener is selected from the group consisting of stevia extracts, monk fruit extracts, a combination of stevia and monk fruit extracts, and sucralose.

104. A sweetener system according to any of claims 100 to 103, wherein the at least one bulking agent of the sweetener system is selected from the group consisting of maltodextrin, polydextrose, gums (such as xanthan gum or guar gum), soluble corn fiber (SCF), starches, polyols, and mixtures thereof.

105. A sweetener system according to claim 104, wherein the at least one bulking agent is selected from the group consisting of maltodextrin, polydextrose, SCF, and mixtures thereof.

106. A sweetener system according to claim 105, wherein the at least one bulking agent comprises SCF.

107. A sweetener system according to any of claims 100 to 106, comprising the at least one bulking agent in an amount of from about 5% by weight to about 95% by weight relative to the total weight of the sweetener system.

108. A sweetener system according to claim 107, comprising the at least one bulking agent in an amount of from about 50% to about 80% by weight relative to the total weight of the sweetener system.

109. A sweetener system according to any of claims 100 to 108, wherein the sweetener system further comprises at least one nutritive sweetener.

110. A sweetener system according to any of claims 100 to 109, wherein the sweetener system is provided in solid form.

111. A sweetener system according to any of claims 100 to 109, wherein the sweetener system is provided in liquid form, preferably as a syrup.

112. A sweetener system according to any of claims 100 to 111 for use in frozen desserts, wherein the sweetener system comprises allulose in an amount of from about 20% to about 50% by weight relative to the total weight of the sweetener system; SCF in an amount of from about 50% to about 80% by weight relative to the total weight of the sweetener system; stevia extract in an amount of from about 0.10% to about 0.20% by weight relative to the total weight of the sweetener system; and monk fruit extract in an amount of from about 0.02% to about 0.09% by weight relative to the total weight of the sweetener system.

113. A sweetener system according to claim 112, wherein the sweetener system further comprises fructose in an amount of from about 1% to about 2% by weight relative to the total weight of the sweetener system.

114. A sweetener system according to claim 112 or 113, wherein the sweetener system is provided as a syrup.

115. A food or beverage product according to any of claims 10 to 13, wherein the frozen dessert comprises a sweetener system according to any of claims 100 to 114.

116. A food or beverage product according to claim 115, wherein the food or beverage product is an ice cream.

117. A food or beverage product according to claim 115 or 116, wherein the frozen dessert comprises the bulking agent in an amount of from about 9% to about 13% by weight relative to the total weight of the frozen dessert.

118. A food or beverage product according to claim 115 or 116, wherein the sweetener system is a sweetener system according to claim 112.

119. A food or beverage product according to claim 115 or 116, wherein the frozen dessert comprises allulose in an amount of from about 3% to about 8% by weight relative to the total weight of the frozen dessert; at least one bulking agent in a total amount of from about 9% to about 13% by weight relative to the total weight of the frozen dessert; and at least one high intensity sweetener.

120. A food or beverage product according to claim 119, wherein the at least one high intensity sweetener is a combination of a stevia extract and a monk fruit extract, and wherein the stevia extract is present in an amount of from about 0.018% to about 0.035% by weight relative to the total weight of the frozen dessert and the monk fruit extract is present in an amount of from about 0.009% to about 0.017% by weight relative to the total weight of the frozen dessert.
